(19) United States
(12) Patent Application Publication
(10) Pub. No.: US 2010/0164836 A1
(43) Pub. Date: Jul. 1, 2010

(54) DIGITAL PHOTO ALBUM, DIGITAL BOOK, DIGITAL READER

(75) Inventor: Raymond A. Liberatore, Bentonville, AR (US)

Correspondence Address: MYERS WOLIN, LLC, 100 HEADQUARTERS PLAZA, North Tower, 6th Floor, MORRISTOWN, NJ, 07960-6834, US

(73) Assignee: TRUVIEW DIGITAL, INC., Bentonville, AR (US)

(21) Appl. No.: 12/722,045

(22) Filed: Mar. 11, 2010

Related U.S. Application Data
(63) Continuation-in-part of application No. 12/402,042, filed on Mar. 11, 2009.
(60) Provisional application No. 61/142,160, filed on Dec. 31, 2008.
(60) Provisional application No. 61/035,483, filed on Mar. 11, 2008.
(60) Provisional application No. 61/292,594, filed on Jan. 6, 2010.
(60) Provisional application No. 61/227,593, filed on Jul. 22, 2009.
(60) Provisional application No. 61/159,253, filed on Mar. 11, 2009.

(51) Int. Cl. G09G 5/00; G09F 1/00

(52) U.S. Cl. 345/1.1; 40/124.01

(57) ABSTRACT

A digital photo album includes, in one embodiment, a digital viewing unit for viewing digital media and a storage location for housing digital media viewable on the digital viewing unit.

### CROSS-REFERENCE TO RELATED APPLICATIONS

This application is a continuation-in-part of U.S. application Ser. No. 12/402,042, filed Mar. 11, 2009, which claims the benefit of U.S. Application 61/035,483, filed Mar. 11, 2008, and U.S. Application 61/142,160, filed Dec. 31, 2008. This application also claims the benefit of each of U.S. Application 61/159,253, filed Mar. 11, 2009, and U.S. Application 61/227,593, filed Aug. 3, 2009, and U.S. Application 61/292,594, filed Jan. 19, 2010. The content of each of the above applications is incorporated herein by reference.

### FIELD OF THE INVENTION

This invention generally relates to viewing digital media and photos, as for example viewing photos in a portable digital photo album, and more particularly in one embodiment to viewing photos with one or two display (such as LCD) screens or displays that is enclosed like a photo album book. Digital photos have been replacing film and printed photos for some time and the present disclosure allows the user to view all their digital photos and store them with convenience. This invention also generally relates to a digital book or digital reader, where the digital structure is also used for displaying digital books and the like, and where the structure has an outward appearance of a traditional book. This invention also relates to a digital menu, card, cookbook, scrapbook and the like.

### BACKGROUND

When people take photos they view them on their computer, camera, laptop and cell phone etc. To capture these photos for safe keeping, the user has them printed, and/or saves the digital images to a disk or memory card. The user also saves the images on their electronic device, where they can edit the photos. To free memory on their memory card, the user backs-up the photos to CD's or other ways, and then takes more photos. The user has to find a place to put the digital print photos and where to keep their backup images for future use. There is need to overcome this digital viewing and storing method, in a simple, effective and efficient manner.

### SUMMARY OF THE INVENTION

A portable digital photo album/book/reader is provided that allows a user to view and store photos, videos, and other digital media (books and the like) with convenience and in an environmentally friendly manner, anywhere and anytime. More preferably, the digital photo album disclosed herein is intended to replace the typical photo album/typical book, which has pages of printed photos or text that deteriorate and degrade in quality and are susceptible to tampering and removal over time. This album/book/reader helps preserve, secure and organize photos, books, any text and videos. Over the years, a user could collect many albums that weigh a lot and are subject to loss or destruction in the event of a fire, etc. The digital album of the present disclosure preferably includes at least one display unit for displaying digital media, and at least one storage location for storing digital media to be displayed on the at least one display unit.

It is intended that the digital photo album/book/reader change the way digital photos or text and other digital media are viewed. Typically, digital photos, for example, are viewed on a camera or cell phone, or immediately thereafter when offloaded to a computer or a backup device, or when printed. Over time, a user can generate many backup storage devices or memory cards containing hundreds or thousands of pictures. Using the digital album of the present disclosure, a user can safely and efficiently store all of these backup devices and memory cards and view collections of photos at a moment's notice and in a single portable location. Thus, a user avoids the problem of storing all photos in a single location, such as his/her computer, and risking the possibility of having the computer crash and losing all of the photos.

The digital photo album/book/reader, in addition to storing and displaying of digital media, has other capabilities including graphics capabilities, memory card ports or memory expansion ports, a variety of input/output ports, the ability to make custom size photos, videos, etc., the ability to wirelessly interact with other devices, storage locations, etc., and other features and benefits as contemplated herein. The digital/book/reader can change the way we read any kind of books or anything with text and pictures. It's like having several to any number of books in one digital book/reader. This invention helps preserve, secure and organize all your photos, albums, books, text, movies, home videos and other digital media known today or developed in the future. It can be like hundreds of books, text books, magazines, home videos, movies, photos albums, archives, law case books, encyclopedias etc., all in one digital album/book/reader to read and view any time or place. There are so many albums, books, magazines, and scrap books in the market and now they can become digital and be combined into one unit with this invention.

### BRIEF DESCRIPTION OF THE DRAWINGS

FIG. 1 shows one embodiment of a digital photo album/book/reader in accordance with the present invention.

FIG. 2A is an embodiment of a dual-screen digital photo album/book/reader.

FIG. 2B is an embodiment of a single screen digital photo album/book/reader.

FIG. 3 is a partial view of the side of the digital photo album/book/reader showing a port cover closed.

FIG. 4 is a close-up view of the side of FIG. 3 showing the port cover opened.

FIG. 4A is a magnified view of navigation buttons on the inside of a display screen.

FIG. 5 shows one embodiment of a possible arrangement of photos on a display screen.

FIG. 6 shows one embodiment of photos on one display screen and a video on another display screen.

FIG. 7 illustrates the use of a remote unit for controlling the viewing of photos.

FIG. 8 shows one embodiment of an edge view of a digital photo album/book/reader.

FIG. 9 shows one embodiment of a digital photo album/book/reader with storage.

FIG. 10 shows one embodiment of storage pages for various types of media.

FIG. 11 shows one embodiment of a digital photo album/book/reader with a permanent memory board.

FIG. 12 shows one embodiment of a digital photo album/book/reader with a removable memory board.

FIG. 13 shows one embodiment of a type of memory board usable with a digital photo album/book/reader.

FIG. 14 shows various types of connection cables.

FIG. 15 shows one embodiment of a digital photo album/book/reader connected to a digital camera via a cable.

FIG. 16 shows one embodiment of a memory board.

FIG. 17 shows one embodiment of a memory board.

FIG. 18 shows one embodiment of a CD or DVD drive and other ports that can connect to a digital photo album/book/reader.

FIG. 19 shows one embodiment of a digital photo album/book/reader.

FIG. 20 shows one embodiment of a digital photo album/book/reader with a memory board is detached and further illustrates where the memory board slides into the digital photo album/book/reader.

FIG. 21 shows one embodiment of a memory card used with a digital photo album/book/reader.

FIG. 22 shows an alternative embodiment of a digital photo album/book/reader with a storage tray.

FIG. 23 shows an alternative embodiment of a digital photo album/book/reader with a storage cartridge.

FIG. 24 shows an alternative embodiment of a digital photo album/book/reader with a removable cover.

FIG. 25 is a close-up view of one portion of FIG. 24 showing two memory cards or memory expansion cards that are connected to the photo album for memory or additional memory purposes.

FIGS. 26-30 illustrate various non-limiting embodiments, of a control scheme, screen menu options and operations, and various functionalities relating to use, storage, and input and output operations related to the digital album of the present invention.

FIG. 31 shows one embodiment of a digital photo viewing unit being inserted into a cover with storage to create a digital photo album/book/reader.

FIG. 32 shows one embodiment of a digital photo album/book/reader, with the digital photo viewing unit in the cover with storage.

FIG. 33 shows one embodiment of part of a digital photo album/book/reader cover with a picture, art card insert area with a storage area with flap and/or cover.

FIG. 34 shows one embodiment of a digital photo album/book/reader with storage on the left and a digital photo viewing unit in the digital photo album/book/reader cover.

FIG. 35 shows one embodiment of a digital photo album/book/reader being attached to a digital photo album/book/reader cover.

FIG. 36 shows one embodiment of a digital photo album/book/reader cover attached to the digital photo album/book/reader.

FIG. 37 shows one embodiment of a digital photo album/book/reader having one display screen on the right and a storage door and storage area on the left.

FIG. 38A shows one embodiment of a one display digital photo viewing unit inserted into a digital photo album/book/reader cover with storage to create a digital photo album/book/reader.

FIG. 38B shows FIG. 38A with the digital photo viewing unit inserted into the cover.

FIG. 39A shows one embodiment of a two display digital photo viewing unit inserted into a digital photo album/book/reader cover with storage to create a digital photo album/book/reader.

FIG. 39B shows FIG. 39A with the digital photo viewing units inserted into the cover.

FIG. 40 shows one embodiment of a digital photo album/book/reader closed and the top layers show the digital photo album/book/reader unit, while the bottom layer shows a zipper storage compartment.

FIG. 41 shows one embodiment of a two display digital photo viewing unit inserted onto a digital photo album/book/reader cover to create a digital photo album/book/reader.

FIG. 42 shows one embodiment of a two display digital photo viewing unit connected together and placed in a digital photo album/book/reader cover to create a digital photo album/book/reader.

FIG. 43A shows one embodiment of a two display digital photo viewing units that have mating hinge assembly built-in the inside part of the units connected together to make a digital photo album/book/reader.

FIG. 43B shows one embodiment of a digital photo album/book/reader with two display digital photo viewing units connected together.

FIG. 44A shows one embodiment of a dual-display digital photo viewing units frames that have mating hinge assembly built-in the inside part of the units that connect together to a hinge to make a digital photo album/book/reader.

FIG. 44B shows the assembled display digital photo viewing units of FIG. 44A.

FIG. 45 shows one embodiment of a digital photo album/book/reader and how a cover can be connected.

FIG. 46 shows one embodiment of a universal storage compartment or pocket for memory cards and similar devices.

FIG. 47 shows one embodiment of a universal storage compartment or pocket with a name tab or label.

FIG. 48 shows a top view of the universal storage compartment/pocket of FIG. 47.

FIG. 49 shows a side view of a universal storage compartment/pocket of FIG. 47.

FIG. 50 shows another view of a universal storage compartment/pocket of FIG. 47.

FIG. 51 shows another embodiment of the universal storage compartment/pocket.

FIG. 52 shows one embodiment of another version of a storage area with an individual universal storage compartment/pocket or a row of compartments/pockets with a storage door.

FIG. 53 shows one embodiment of a front view of a digital photo album/book/reader and the many directions that a picture, art card or other document can be inserted in and out of the digital photo album/book/reader.

FIG. 54 shows one embodiment of a digital photo album/book/reader.

FIG. 55 shows one embodiment of a dual-display digital photo album/book/reader.

FIG. 56 shows one embodiment of a single-display digital photo album/book/reader.

FIG. 57 shows an exploded view of one embodiment of a digital photo album/book/reader.

FIG. 58 shows one embodiment of a picture, etc., inserted in a digital photo album/book/reader.

FIG. 59A shows one embodiment of a digital photo organizer with storage area for memory devices.

FIG. 59B shows one embodiment of a digital photo organizer with inserted picture.

FIG. 60 shows one embodiment of a digital photo album/book/reader with built-in printer.

FIG. 61A shows one embodiment of a digital photo frame back with a storage area.

FIG. 61B shows one embodiment of a digital photo frame with a storage area on the side.

FIG. 62 shows a digital photo managing and storing unit.

FIG. 63 shows a wireless flow chart for a digital photo album/book/reader and digital photo managing and storing unit.

FIG. 64 shows a wireless digital photo scanner that can send digital photos wirelessly to any location.

FIG. 65 shows one embodiment of a digital photo album/book/reader having port openings and a memory compartment door open with access to an internal and removable memory card.

FIG. 66 shows one embodiment of a digital photo album/book/reader with storage.

FIG. 67 shows one embodiment of a single screen digital photo album/book/reader.

FIG. 68 shows one embodiment of a dual-screen digital photo album/book/reader.

FIG. 69 shows one embodiment of a dual-screen digital photo album/book/reader.

FIGS. 70A-70C show various methods for attaching a book cover to a digital photo album/book/reader.

FIG. 71 shows one embodiment of a PCB with a removable memory slot that the memory card or similar device is accessible from outside of the unit.

FIG. 72 shows one embodiment of a parts view of a dual-screen digital photo album/book/reader.

FIG. 73 shows one embodiment of a parts view of a single-screen digital photo album/book/reader.

FIG. 74 shows one embodiment of a digital photo album/book/reader holder for holding a digital photo album/book/reader.

FIG. 75 shows one embodiment of a digital photo album/book/reader with a leather cover with binding in the closed position.

FIG. 76 shows one embodiment of a digital photo album/book/reader in the open position.

FIGS. 77A-77E show the progression of one embodiment of a digital photo album/book/reader from the closed position to the fully open position.

FIGS. 78A and 78B show one embodiment of a digital photo album/book/reader from the closed position to the fully open position.

FIG. 79 shows one embodiment of a digital photo album/book/reader without a picture holder on the front cover.

FIG. 80 shows one embodiment of a digital photo album/book/reader in the fully open position with multiple ports.

FIG. 81 shows one embodiment of a digital photo album/book/reader in the fully open position with one port.

FIG. 82 shows one embodiment of a media and remote control storage area of a digital photo album/book/reader.

FIG. 83 shows one embodiment of an edge view of a digital photo album/book/reader including a remote control storage pouch.

FIG. 84 shows one embodiment of a digital photo managing unit and server or server bank.

FIG. 85 shows a front view of one embodiment of a digital media organizer.

FIG. 86 shows an edge view of the organizer of FIG. 85.

FIG. 87 shows one embodiment of a page from a digital media organizer of the invention.

FIG. 88 is a cross-section taken along line 88-88 of FIG. 87.

FIG. 89 is a cross-section taken along line 89-89 of FIG. 87.

FIG. 90 shows one embodiment of a page from a digital media organizer of the invention.

FIG. 91 is a cross-section taken along line 91-91 of FIG. 90.

FIG. 92 is a cross-section taken along line 92-92 of FIG. 90.

FIG. 93 shows one embodiment of a page from a digital media organizer of the invention.

FIG. 94 is a cross-section taken along line 94-94 of FIG. 93.

FIG. 95 is a cross-section taken along line 95-95 of FIG. 93.

FIG. 96 shows one embodiment of a page from a digital media organizer of the invention.

FIG. 97 is a cross-section taken along line 97-97 of FIG. 96.

FIG. 98 is a cross-section taken along line 98-98 of FIG. 96.

FIG. 99 shows one embodiment of a page from a digital media organizer of the invention.

FIG. 100 is a cross-section taken along line 100-100 of FIG. 99.

FIG. 101 is a cross-section taken along line 101-101 of FIG. 99.

FIG. 102 shows one embodiment of a page from a digital media organizer of the invention.

FIG. 103 is a cross-section taken along line 103-103 of FIG. 102.

FIG. 104 is a cross-section taken along line 104-104 of FIG. 102.

FIG. 105 shows one embodiment of a page from a digital media organizer of the invention.

FIG. 106 shows one embodiment of a digital photo album, e-book, and digital book in closed position with a scrapbook type binding with a display on the front cover.

FIG. 107 shows one embodiment of a digital photo album, e-book, and digital book in a closed position with a scrapbook type binding.

FIG. 108 shows one embodiment of a digital photo album, e-book, and digital book in a closed position without a gap in the hinge area, the gap being hidden by a cover in the housing structure.

FIG. 109 shows one embodiment of an alternative design of a single screen e-book, and digital book in a closed position.

FIG. 110 shows one embodiment of an alternative design of a single screen e-book, digital photo album digital book design in an open position.

FIG. 111 shows one embodiment of an alternative design of a single screen e-book, digital photo album digital book design in an open position without a hinge gap.

FIG. 112 shows one embodiment of a dual screen e-book, digital photo album digital book design in an open position.

FIG. 113 shows one embodiment of a dual screen e-book, digital photo album digital book design in an open position without a visible hinge gap and will enhanced control functionality.

FIG. 114 shows one embodiment of an E-book, digital book, and digital photo album charging port or charging station, which can optionally have, for example, an enclosed router.

FIG. 115 shows one embodiment of an E-book, digital book, and digital photo album charging port or charging station with a plurality of interfaces.

FIG. 116 shows one embodiment of a binding design for an e-book, digital photo album or digital book.

FIG. 117 shows one embodiment of an alternative hinge and structure design for an album, e book, digital book, an electronic or no electronic structure.

FIG. 118 shows one embodiment of a management system in accordance with aspects of the present invention.

FIG. 119 shows one embodiment of an E-Book, digital book, digital photo album or digital book in an open position.

FIG. 120 shows one embodiment of an E-Book, digital book, digital photo album or digital book in a closed position.

FIG. 121 shows one embodiment of a computer book, laptop, digital/electronic book, digital book, digital photo album or digital book in a landscape, or horizontal position.

FIG. 122 shows one embodiment of a computer book, laptop, digital/electronic book, digital book, digital photo album or digital book in a portrait, or vertical position.

FIG. 123 shows one embodiment of a digital or electronic menu.

FIG. 124 shows one embodiment of an E-Book, digital book, digital photo album or digital book with a slide out feature.

FIG. 125 shows one embodiment of a digital, electronic greeting card/greeting video book/journal/album with a single screen and a dual screen.

FIG. 126A, FIG. 126B, and FIG. 126C are embodiments showing a portable digital greeting, or digital media USB flash drive with a clip feature and connected to a greeting card.

FIG. 127 shows decorative embodiments of a portable digital greeting, USB flash drive with a clip feature.

FIG. 128A and FIG. 128B show embodiments of a portable digital greeting USB Flash Drive.

FIG. 129 shows one embodiment of a digital, electronic greeting card/greeting video book in the closed position.

FIG. 130 shows one embodiment of a digital, electronic greeting card/greeting video book in the opened position.

FIG. 131A and FIG. 131B show embodiments of a digital, electronic greeting card/greeting video book with a flash drive in the retracted and extended positions.

FIG. 132 shows one embodiment of a digital, electronic greeting card/greeting video book.

FIG. 133 shows one embodiment of a digital cookbook in a closed position.

FIG. 134 shows one embodiment of a single-screen digital cookbook in an open position.

FIG. 135 shows one embodiment of a dual-screen digital cookbook in an open position.

FIG. 136 shows one embodiment of a digital cookbook held in an easel.

FIG. 137A shows one embodiment of a digital cookbook in an open position.

FIG. 137B shows one embodiment of menu options used in a digital cookbook of the invention.

FIG. 138 shows one embodiment of a digital scrapbook.

### DETAILED DESCRIPTION

The various embodiments of the digital photo album/book/reader/card, etc. described herein are a convenient means to view digital media, pictures, text, etc. any time, any place with the convenience of looking at the media, pictures, and text alone, with family or friends in a typical photo album book concept. It can be any size or shape, can be formed from any material, have a variety of storage capacities of various media devices, and can associate with a variety of wireless devices. The digital photo album/book/reader allows a user to view and store thousands of pictures, text, etc. in a built-in memory and the storage area all in one unit. It's like having hundreds of typical albums all in one digital photo album/book/reader. For purposes of discussion, while the device described and disclosed herein can be utilized to view any type of digital media, such a photos, videos, text, books and/or combinations of the same, for purposes of convenience the device will be described at times as a digital photo album, although it will be understood that not just photos may be displayed as discussed herein in more detail.

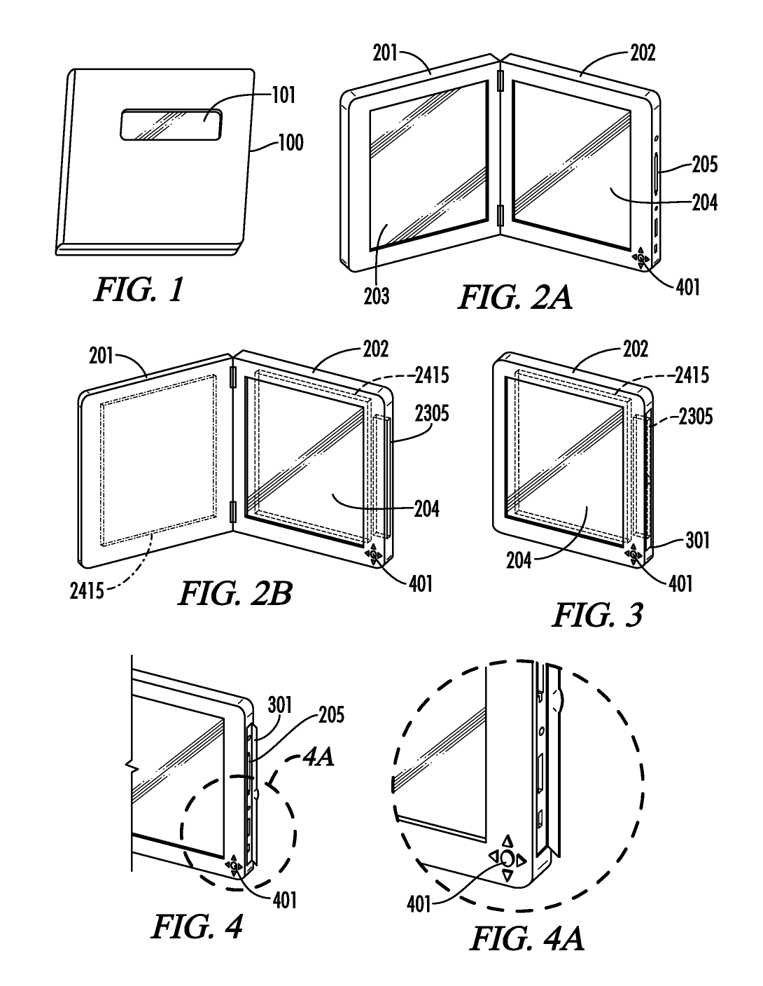

FIG. 1 illustrates one embodiment of a digital photo album 100 that can look like a typical paper photo album of any size when closed, but look like a laptop or notebook when open. FIG. 2 shows one embodiment of a digital photo album 200 comprising two display (such as LCD) screens, one to the left 203 and one to the right 204. While LCD screens will be used for purposes of explanation, it will be understood that other display technologies could be used quite satisfactorily. The digital photo album 200 can be any size or shape. It could look like a paper photo album with grooves around the middle section appearing to be pages. As shown in FIG. 1, the front cover could have a small screen 101, which the user could personalize or show what's inside, like a list of all disks, CDs, DVDs, flash drives, memory cards, and photos sent via wireless, Bluetooth or other means. The digital photo album can have locks or passwords to open the device or the storage area.

While one screen per side is shown in FIG. 2, it will be understood that more than one screen per side is possible. For example, one embodiment (not shown) could include more than one LCD screen per side, such as two or more per side. Each side could have multiple 4″×6″ LCD screens (preferably 2-6 screens per side), for example, 3″×5″ LCD screens, or others. It is preferably in the embodiment shown to have LCD screen sizes that are typical frame sizes 3×5, 4×6, and 8×10, wherein horizontally-aligned and vertically-aligned images can fit in these screen sizes. Of course, while an LCD in particular is described herein, it will be appreciated that other types of screens, such as CRT, plasma, TFT, Laservue™, projector display, (LED) light emitting diode display, OLED, BluRay, high definition and other display visual item whether now known or developed in the future and others, are contemplated, although obviously certain types of screens are more suitable to the type of application described herein.

In one embodiment, there is provided a set picture, for example, on the left screen 203 there can be a “set” or startup picture you see once you turn it on. This can be changed at anytime. These can be background images for the left and right sides of the unit and there should be background images included to put as the background. This can be found in a “Control Panel,” (described below) for example, and under Appearance and Personalization just as in a typical computer (Other non-limiting examples of user-accessible menus include Options, Slideshow, Arrange Photos, Caption Editing, Move/Delete Photos, Upload or Download, Export photos, Multi-Transitional Effects, Zoom-In Detail and Zoom-Out Detail, and any other term used for photos, and the like). In this area a user can change colors of the windows and the screen, for example. Also a theme area where a user can change the view of the certain areas of the photo album. Also contemplated is a screensaver mode whenever the digital photo album is not in use, and it can also be in low power mode when the screen saver is on. With a power saving mode, if there's no activity for, for example, five minutes, then, in one embodiment, the digital photo album would go to a 50% lighted screen, or other reduced power feature, for example. Then if there's no activity for five more minutes, for example, then the unit shuts off. If the user notices it's in power saving mode, the user can touch any button and it will return to 100% lighted screen, or any intensity set by the user. If the unit shuts off, then in one embodiment the user would have to turn the unit back on.

The digital photo album is preferably personalizable for arranging, organizing and/or positioning all photo images to the liking of the user. This can be done, for example, on the digital photo album itself or on a computer attached to the digital photo album. If done on a computer, for example, software could be provided to the user for designing and personalizing their own photo album. After downloading or using memory cards or picture cards, there can be an area where the user can select which size photos should appear and how many on each side of both screens (FIG. 2). After the user has decided, the user can click next with the middle “select” button (401; FIG. 4) and it will go straight to the “Arrange, Organize or Position” Photo area as will be described below. Using this the user can use the up and down arrows or curser pad, right and left click buttons like a laptop to navigate the photos, click them and it would move just that photo to drag them and click again to arrange them in the order desired for viewing. At any time the user can go back to these areas and change whichever album the user wants to view, one picture at a time or however many pictures at a time, and the sizes and number of pictures per view. The digital photo album as described herein can have an area for different photo albums with different pictures, such as, for example, “The Wedding album” or “Summer”. This can make it easy for people to view different albums all in one without just the choice of one album only.

One embodiment of the digital photo album is preferably provided with software that has scrapbook images, albums, kids' software, kids' games or libraries and can be used to create scrap book pages, photo albums or book libraries. Software can also be provided via removable media that is given or sold along with the unit. The software can be installed in the user's computer and the user can create photo albums, scrapbook pages, libraries or more. The book libraries, photo albums or scrapbook pages can be custom made to the size of the screen in the unit for single or dual screens. If the size of the unit is 8″ 4×3 viewing ratio, for example, then the pages in the software can allow the user to choose the size screen and make custom pages according to that screen size. If the user is making the custom albums, scrapbook or libraries on the computer, then the user can transfer onto memory cards, CDs, or transfer via USB or other digital media to the unit or any other way known now or developed in the future. Any type of software known today for digital printing, viewing, scrapbooking or known today any developed in the future can work with this unit.

One embodiment of the digital photo album is to have a digital cookbook that can contain one to any number of cookbooks or recipe books in the album memory. In such embodiment, special software is provided for cooking, recipe organizing, pictures and video instructions and color pictures as well. It can also be wireless and have a router and have Internet capabilities to get recipes on line. Such software can organize all of the family recipes and the recipes accumulated over the years. The recipes can be organized by category, like desserts, appetizers, main courses, soups, salads, seafood, and any known now or developed in the future. The software can search and get the information you are searching for can be like searching on the interne, computer or any software known now or developed in the future. The software can be internal in the unit or have software on a removable media provided and then the user can organize on their computer, and then install it on the digital cookbook. The digital cookbook can be a great way for people to see a video, pictures and the recipes while cooking all in one unit. The user can download recipes on the Internet into the digital cookbook and file it away in a certain category. The user can have place in the software and in the unit to create their own recipes and file them away. The user can also add notes to the recipes, like what to do differently etc. The unit can have a timer or timed reminders built in the recipes or in the unit. The unit can have a custom cookbook holder to raise the unit up to a convenient height, which can be adjustable, and have it angled or adjustable angle, so the unit can conveniently look at the cookbook. The unit can have a custom features like it will read the recipe directions to the cook and also have voice interaction, like repeat and then it will repeat what it said. The unit can have voice command and operate in this mode as well. The unit can have a light that helps reading and also zoom software. In a further embodiment, the unit can communicate with ovens, timer and appliances, with and without voice commands and help the user cook according to a specific recipe. The digital cookbook can have a feature where the user can make it compatible with any make and model appliances that have a feature to communicate with other appliances, digital cookbook or digital cook helper. Appliances can have voice commands built into the units, so all appliances can be turned on and off with voice commands and other voice command to operate the unit, like timer and speed control or any known now or developed in the future. Once a user starts a recipe the digital cookbook will automatically start all of the user's appliances and turn all of the user's appliances on etc. For example, famous chefs can have all their recipes in the cook book along with their famous name on the outside and brand. The design can have one screen or two screens and there can be a storage area for family recipes that you never want to lose. The unit can have no storage area as well. The outside would look like any cookbook known today or developed in the future.

The digital photo album as described herein could have a keyboard, touch screen keyboard or pad attached for photo album editing, positioning and operating the album.

Another embodiment as described herein is to have a typical digital photo frame converted to a digital photo album with cover and storage. A typical photo frame is placed on a wall or counter and viewed. A frame can be taken off the digital photo frame and it would not be called a digital photo frame it would be call a digital photo viewing unit. This unit can have any software, any operating functions, touch border interface, any touch screen technology, and converted to a digital photo album. A digital photo album cover with storage that is permanent or removable can be connected to the digital photo viewing unit or digital photo frame. This unit can have storage area for memory cards or similar devices on the cover or anywhere on the unit. A user can take off the frame of a digital photo frame and can be placed in a digital photo album cover with storage to make a convenient digital photo viewing and digital photo storing unit. This makes the digital photo frame portable, offers a convenient storing area for memory cards and similar devices and offers a cover for protection and a nice look to resemble a typical photo album.

In one embodiment, there is provided a printer port outlet so the digital album can be connected to a printer. If photos are in the built-in memory, the user can be able to download pictures to a memory card or any other electronic device that holds digital photos, so the user can take them to be printed, or put them on their laptop camera or other devices.

There is described herein a better way of viewing digital photos instead of using digital photo frames. Digital photo frames, sit on counters, tables or walls and you look thru the photo images in one LCD screen surrounded by a frame. It's not the same as looking thru pages in a typical photo album. In one embodiment, the present invention allows the user to look at several photos on a page in order, when they were taken on one, two or more LCD screens. The digital photo album can be set on a counter at an angle and viewed and it can also be placed straight across and have an easel built in the back to keep it from falling down. The user can use a remote (702; FIG. 7) to show his audience a slide show. The digital album can be used like a photo frame but can also be taken anywhere to be viewed like a typical photo album with much more convenience.

In one embodiment, the user would open the digital photo album like a laptop computer, for example, and it could have locks to open and close. There can be passwords, fingerprint or other biometrics, voice or other ways known now or known in the future to open the digital photo album and securely control access of the data enclosed. Once the user has the digital photo album opened, they can turn on the unit or it can automatically power up by virtue of the opening of the album if desired. FIGS. 4 and 4A show one embodiment of useful navigation buttons. With the unit on, the user can use the touch screen or buttons, or keys to move and choose up, down, select etc. 401. The user could see all photos listed and which number, letter, it is located in the storage area. If the digital album has internal memory, the user could choose the title of pictures, images, video, or text they wish to view. The user could also open up the storage area select the CD or memory card and insert the CD or memory card into a section where different XD, SD, memory card, USB, and other outlet ports are. The user could also hook up their camera, cell phone, computer etc. to get photos to view. The user could also send images via Bluetooth or other wireless technology known now or developed in the future.

In one embodiment, the two page LCD structure can be any size or shape and can be used to view books, magazines, manuals, home videos etc. The information can be sent via wireless means, downloaded or inserted CDs, flash drives or memory cards, etc. If there's a CD, memory card or wireless means of getting data to the album, then the data can be viewed page by page. It can be stored in storage area, for future use. It can play videos on one side and pictures or text on the other side or vice versa. This is a great way to view and store photos and home videos, data or text in one digital unit. The user could hook up their video camera and play home videos or via camera or cell phone, it can also be sent via Bluetooth technology or any wireless technology known now or developed in the future.

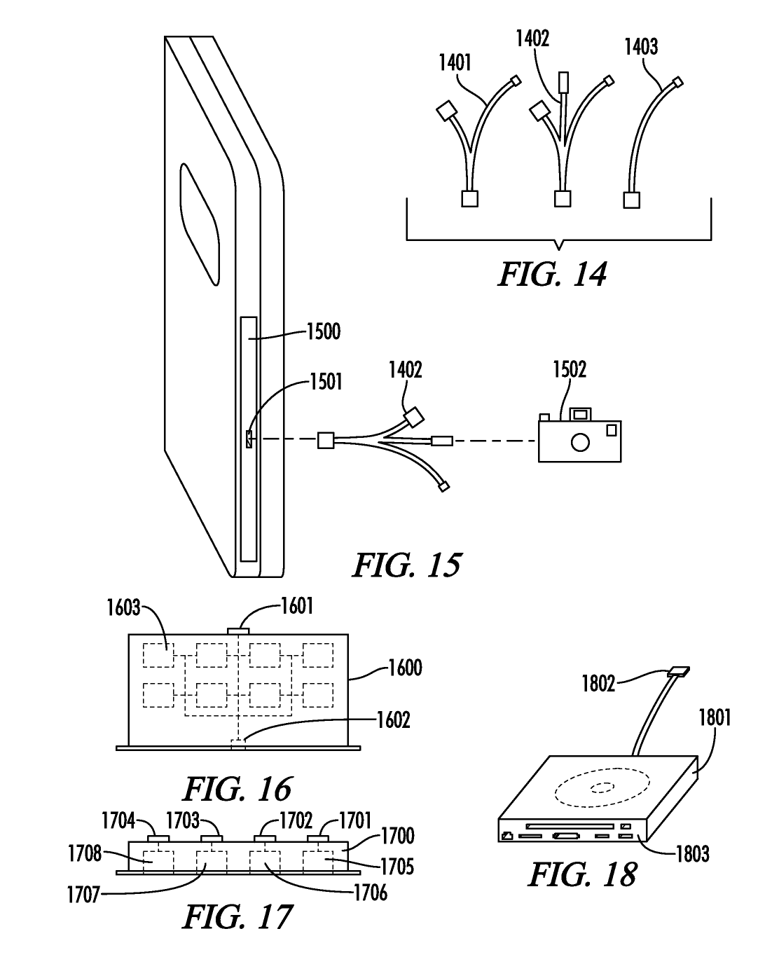

As shown in FIGS. 2 and 3, the digital photo album can have port openings 205 like SD/MMC, XD, CD, CF/MD, MS/MS duo, mini USB, USB Host, DC 9v, and any others known now or known in the future. This area where the ports are located could be hidden in the side, top or bottom or anywhere. It can be exposed or have a cover 301 that can be pushed and it opens up and then it's exposed and push again and it closes. If the user pushes it closed, then the port area is not exposed. As shown in FIG. 15, the user could hook up their camera 1502 or computer to a port 1501 of the digital photo album via a cable 1402 to show images or to transfer images. As shown in FIG. 14, the digital photo album can be connected to a number of different devices using appropriate cables 1401-1403. These cables can have multiple connections such as USB, SD, XD, etc., and can be male or female.

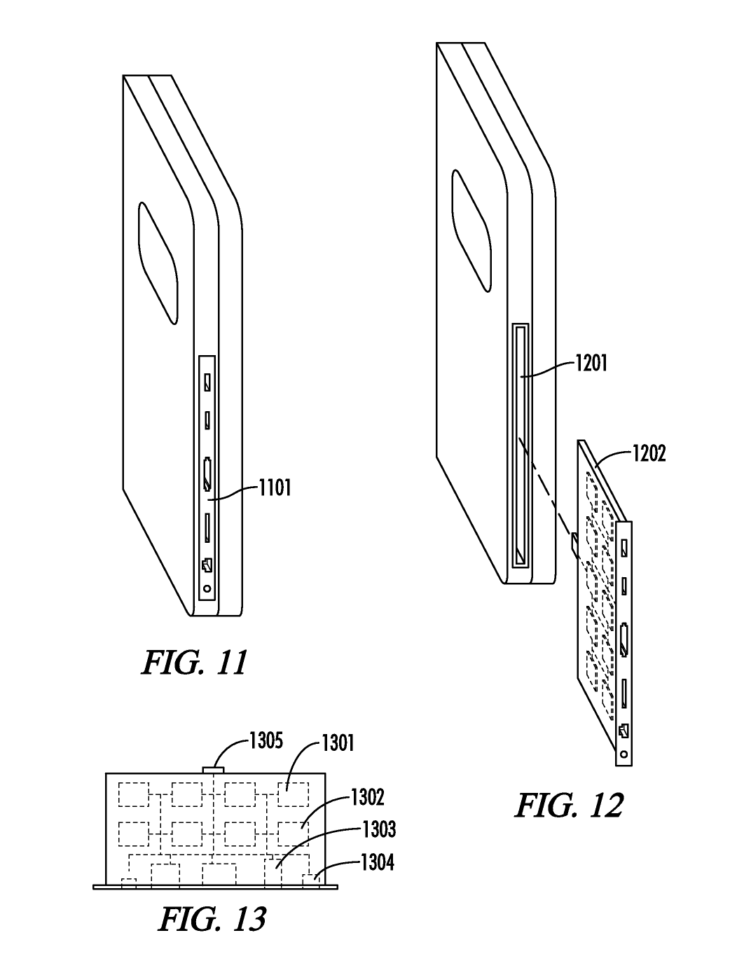

As shown in FIGS. 11-13, a photo memory board, having connection ports and media slots can be permanent 1101 or removable 1202. One can view the photos when the removable memory board 1202 is pushed into the slot 1201. The memory cards on the memory board can be permanent or removable. The memory card 1301 can be linked to any other types of memory cards 1302-1304, and the connector 1305 can be connected to a computer port or photo album. The memory board can be storage only or can be used to view photos and to provide storage. FIG. 16 shows memory board 1600 with an inlet slot 1602 and a connector 1601, with a number of memory cards 1603. FIG. 17 shows a single strip memory board, with a number of inlets 1705-1708 and a number of connectors 1701-1704.

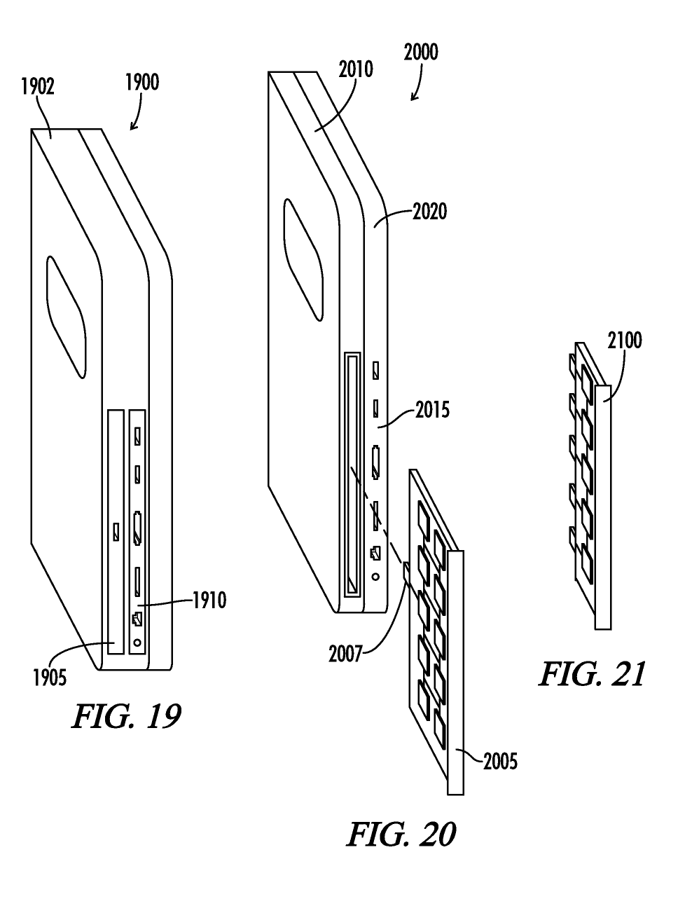

FIG. 18 shows that a CD/DVD drive 1801 can be connected to the album via the connector 1802. The CD drive will have an insert slot for CDs and can have other ports 1803 of media, such as USB, SD, XD, Flash Card, etc. FIG. 19 shows a CD/DVD/etc. drive 1905 adjacent a plurality of ports 1910 and associated on a front cover 1920 of a digital photo album 1900.

FIG. 20 shows a removable memory card board 2005 provided on a front cover 2010 of one embodiment of a digital photo album 2000, with a plurality of ports 2015 provided on a back cover 2020. The memory card board 2005 can have a master memory card 2007, or a memory card board 2100 (FIG. 21) could be utilized that just has a plurality of memory card locations. These memory cards or any type of photo capturing device known now or developed in the future can be removable or permanent. Once the tray is connected then the user can view photos and the tray provides a storage area. This tray can also be used for storage only.

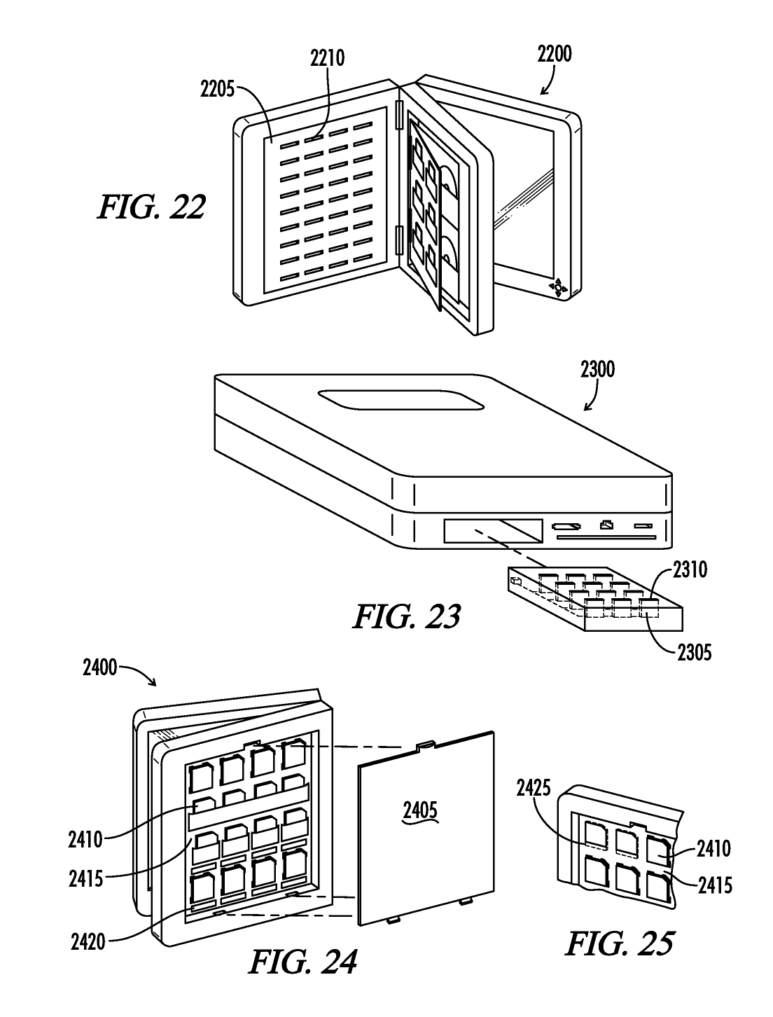

FIG. 22 illustrates one embodiment of a digital photo album 2200 comprising a tray 2205 of memory card slots 2210. FIG. 23 illustrates a digital photo album 2300 comprising a cartridge-type tray 2305 including a plurality of memory card locations 2310. In FIGS. 22 and 23, the tray 2205, 2305 either serves as a passive storage tray, whereby individual memory cards are removed and re-inserted into a card slot in another location on the digital photo album for individual card viewing, or the tray and each individual card location is electrically connected to the CPU for direct viewing of the contents of the individual cards while the cards are in the trays. In other words, the tray can function as a multi-card reader and processor for accessing information on multiple cards at the same time. The trays can provide storage only for memory cards or memory capturing devices known now or developed in the future. The trays 2205, 2305 may be removable for easy storage and transport, and the tray 2205 can be flush with the borders of the digital photo album page so that the tray does not interfere with other storage pages in the album. The tray 2305 can be further spring engaged with the photo album 2300 such that the user loads the tray 2305 with memory cards and then inserts the tray 2305 into the photo album 2300. Thereafter, in one embodiment, the user pushes the tray 2305 and it springs out of engagement with the album 2300 in preparation for loading, re-loading and removing memory cards therefrom.

FIG. 24 shows one embodiment of a digital photo album 2400 including a removable front or back cover 2405 that reveals a plurality of memory cards 2410 secured to a support 2415 positioned adjacent such removable cover 2405. FIG. 25 shows an upper left corner of FIG. 24. The two upper left memory cards 2425 show memory cards or other digital photo capturing devices connected to the digital photo album for additional memory or to provide memory. In an alternative embodiment to FIG. 24, there could be provided one display (LCD) screen without a protective cover, but with a memory card storage on the back (see, for example, FIG. 61A, 61B) or inside the front cover or a slide out storage rack or tray anywhere on the digital album.

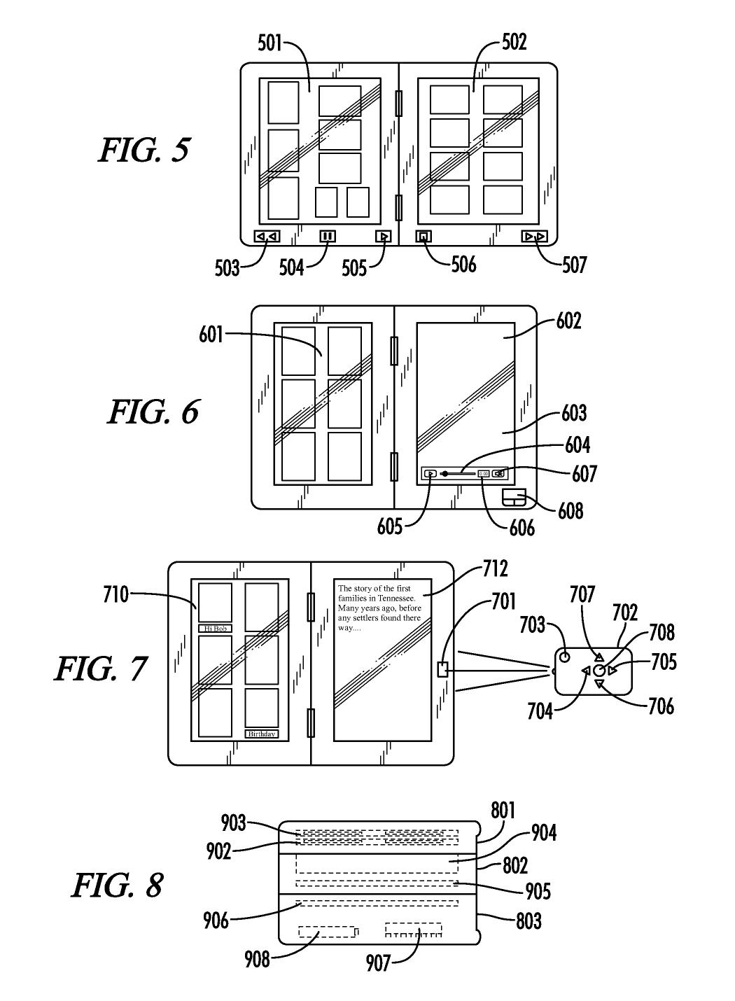

As shown in FIGS. 5 and 6, once the unit is on and the images are imported, then the digital photo album can show 3″×5″, 4″×6″, full size, any size, text, data, arrange, video 602 or a slide show of pictures, or the like on any size screen or multiple screens. Other variations and combinations are contemplated. The consumer can use touch screens, buttons or other ways to select the size (i.e., 3″×5″, 4″×6″, full size, etc.) or type (i.e., photo, home videos, text or slide shows) or the like. In one embodiment, the first page of the photos would appear to the left 501 and the second page of photos will appear to the right 502. A plurality of control buttons as shown in FIG. 5 such as back 503, pause 504, play 505, stop 506 and forward 507 could be provided to scroll through the pictures and pages of pictures as desired. Other control selectors in addition to those described above are contemplated. For example, the user could push the next page 507, and then the third page would appear on the left and the fourth page on the right, and so forth. The user could push previous page or back arrow 503 to scroll back. In another embodiment with a digital photo album with one LCD screen, the first page of the photos would appear on the screen. The user could push the next page and the second page would appear and so forth. The user could push previous page or back arrow to scroll back. The digital photo album can have capabilities where if the user touches the photo it can give you information about the photo or enlarge it to make the image bigger. This information can be entered prior to viewing through software or other ways on the digital photo album, computer, cell phone, camera or any device known now or developed in the future.

FIG. 6 illustrates one embodiment of a digital photo album including an LCD screen 601 for showing pictures and a screen 602 for showing video, with the screen 602 including a full size video screen 603 and a progress bar 604 including a play button 605, a counter 606 and a volume control 607. Other control functionality may be provided instead of or in addition to that which is described herein.

In one embodiment, if a digital photo album is not provided with a storage area for memory cards and the like, the album can be extra slim, and it can be shaped like a small book and the screens can oriented in the vertical or horizontal direction.

A CPU (Central Processing Unit) is provided that can, among other things, sort photos per page, horizontal or vertical photos. Depending on the size of the LCD screen or screens, the CPU can determine how many photos will fit per page. Once selected, then the CPU can put the photos in order via 3″×5″, 4″×6″, full size, etc., and/or as determined by the user. Of course, the CPU will also control the primary processing functions of the digital photo album. When the user is done enjoying the photos, they can put the CD or memory card away or disconnect the camera, or Bluetooth (any wireless way), then they can put in more CDs memory cards, flash drives etc., and start the process over. To select pages, turn pages or operate the album, there could be a remote 702 (FIG. 7), buttons or other ways to operate the unit. The remote 702 could have, for example, a power button 703, up 704, down 705, previous page or back 706, next page or forward 707 and select 708, which interact with the CPU to enhance the viewing experience.

It is preferable in the digital photo album embodiments described herein to have touch screen technology to operate the digital photo album. Aside from navigation and providing information about the photos, the user can manipulate photos using touch. For example, if the user touches the photo, in one embodiment, it enlarges the photo and to full screen for example. There are many ways to do this, if the user touches the photo once, it gives information about the photo, and if the user touches it again, it enlarges the photo, and if the user touches the photo a third time then it goes back to the original photo size. Of course, the manner in which photos are identified, viewed, manipulated, etc., can be established through the selection of preferences in a Control Menu. The display screens could have touch screen, touch border interface and or buttons and have icons all over the page. The icons can show folders like photo folders, albums, edit, import photos, export photos, music, video, and control panel, plus any more that can be related in viewing photos. If the user clicked photo folders, all the photo folders would appear, and then the user can click and open a photo folder. The photo folders can be labeled by the user, so they will know what photos are in a particular folder. The user could push it and all the photos will show up and you select page by page. Many more ways of sorting and accessing are available, but this is an example. Software can be provided, so the user can install it on the computer, edit, arrange, and classify, name all photos, then save it to a CD, or memory card, so it's ready for the digital photo album. Or it can be sent via Bluetooth or any wireless technology or any photo transfer method. Or software can be provided in the digital photo album or portfolio when you purchase it to accomplish the same.

In accordance with another aspect of the present invention, the digital photo album could have a hard drive, or RAM for built in memory. Consumers could store photos on this digital photo album and select the title of photo's you want to see, then they would be ready to view. Another embodiment is to have a storage area for automatically storing photos, so a user will not lose them in case the digital photo album crashes. This digital photo album can have a storage area for storing a back-up hard drives, or the storage area can be for storing memory cards, flash drives and CD's etc. In one embodiment, the digital photo album can be without a storage area as well.

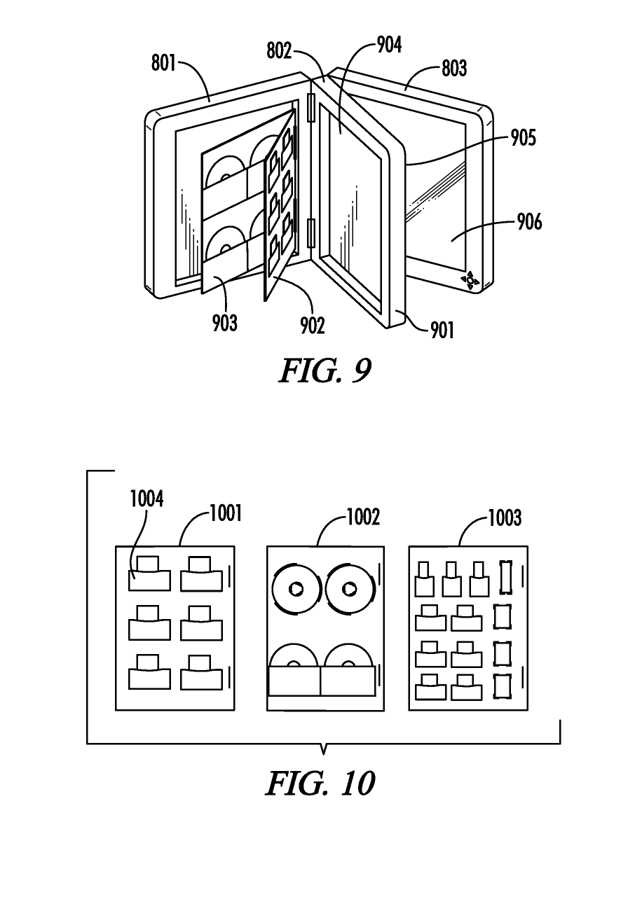

As shown in FIGS. 8-10, a built-in storage area (801) is provided for hard drives, CD's, flash drive, memory cards and other photo capturing devices known now or in the future. This allows the consumer to have thousands of photos ready to view at a moments notice. In one embodiment, there will be three sections 801-803, comprising a storage section 801 for storing various pages of media 902, 903, a central section 802 comprising open storage 904 and a screen 905, and another display section 803 including a screen 906 and internals including, but not limited to, a CPU 907, battery 908 and the like. The battery 908 can be replaced from the side, inside left panel or the bottom of the digital photo album, for example. The batteries can be AA, AA rechargeable, removable or permanent batteries. The batteries can be similar to laptop, notebook batteries or any type of battery known now or developed in the future. These can be built in or be removable and have a charging cord to plug into the digital album for charging the battery. The middle section 802 can have a lock that controls access to the first and/or third sections 801, 803 selectively and respectively. The storage area could have sheets (1001-1003) in a three-ring binder format, for example, with sections or inserts made for CD's, flash drive or memory cards and other memory devices. The storage area is a safer alternative than storing images on the computer for long periods of time or other ways which digital images can be lost or not found. It is also contemplated to have an external hard drive that is specifically designed for the digital photo album and for digital photos and videos.

The storage area sleeves, individual compartments, group compartments, pockets or inserts can have areas 1004 where a user can personalize the insert area or other ways describing the photos that are in CD, flash drive or memory card. Each sleeve is custom made to fit CD's, memory cards, flash drives, compact flash etc. All digital photo album drawings, specification or embodiments mentioned in this application can have any type of memory card, flash drive or any type known for digital photos now or developed in the future to be used with or can be stored in the storage area. It can be built into the storage area like a 3 ring binder or other ways. The user can add sleeves or remove them. The storage area can have memory expansion cards, back up hard drives for digital images where a user can add or remove them as well. There can be an area marked or labeled, “Back-Up,” for example, where the user can keep a back-up of the built-in memory in case there is any problems with the digital photo album memory. In one embodiment, the digital photo album could ask the user during use or changing any memory, if the user would like to back-up the built-in memory. The memory card or device can equal the built-in memory or it can use one more to equal the built-in memory. The digital photo album can identify the memory card or device and let the user know or the user can find out how much memory is left on the album or the memory card or device. This will help the user know how much memory is left on the digital photo album and if they want to add photos, then they might have to export and remove some photos or folders to make room.

In the storage area, there can be provided a back-up or auto back-up devices. In one embodiment, the storage area can be on the inside left panel, cover or anywhere. It can have a storage door with or without a place to insert a picture. The storage area can have individual or group pockets or individual or group compartments. It can also have rows of storage. These storage areas can have flaps or covers to hold the memory cards in place so they don't move around. These storage areas can have a form fit, which fits the exact size of the memory card, flash drive, compact flash or any known now or developed in the future. The storage areas can have universal pockets, sleeves or compartments that can fit any type memory card, flash drive, compact flash or any known now or developed in the future. The storage doors can be attached via magnets, for example, push in for open, and push in for lock, have guide arms and holes or any type of opening and closing method known now or developed in the future. On the inside of the storage door it can have padding and there can be areas of padding that stick out farther than other areas so it can hold the memory card or devices in place so they don't move around. The padding aids in protecting the memory card or devices.

In other embodiments as described below, a storage area can have a universal pocket or storage area that fits any size memory card, flash drive, compact flash or any known now or developed in the future. This area can have single or individual compartments that can fit one, two or more memory cards or devices and also have group or rows of compartments. The inside area can have rubber or foam type material, so it can fit all size memory card or devices and also protect them. The softer material expands and retracts and that's how it holds the devices in place, like a compression fit. The universal compartments can be attached by snap or any possible fastening method. The compartment area can have legs or extenders that go into the rubber or foam material to hold it in place or it can have adhesive. There can be label areas where the user can add and remove labels so the user can identify what memory card or device is in the storage area. The label area can have slots where it holds a paper or any material label in place. The label can be an adhesive label or not. In another embodiment, leather or any type of material cover can have storage areas. The storage area can be on the inside left or right side, front or back. The storage areas can be enclosed by a flap or zipper. If the flap is used, a hook and loop-type fastener (such as Velcro®) can be used to open and close the area or any type of opening and closing method. There can be a zipper compartment within the storage area and the zipper is used to open and close the compartment or any other way. Inside the storage areas can have individual, group pockets or compartments. The pockets or compartments can fit one or several memory card or devices known now or developed in the future. There can be stitching separating the pockets or compartments. There can be padding in or around these compartments and any where on the storage flaps or anywhere in the storage areas. The digital photo album cover can have padding or any type of material to protect and make it feel comfortable and soft to the touch. This storage area can be fire and water proof. The digital photo album as described herein allows consumers a safer way to save photos without the chance of computer crashes or losing their digital photos and not being able to find them.

Another embodiment of the present invention is to have a digital photo album storage unit only without display screens. This unit can hold hard drives of photos, back-up photo devices and can be sent by wireless or be downloaded and it can hold CD's, flash drives, memory cards and other memory devices. This could be any size or shape or could look like an album. This could also be fire and waterproof with locks. This will protect all your digital photo memories. This is another safe location to keep all your digital images in one location. This storage unit can have back up devices and wireless technology to send photos anywhere, any place and any time. It can be operated by cell phone, laptop, computer or any wireless or non wireless means known now or developed in the future.

As shown in FIG. 7, a remote (702) is provided to operate the digital photo album, to select pages, turn pages or operate the album, for example. There can be a convenient safe place to store the remote, such as in one of the photo album covers separate from or adjacent storage areas for storage medium such as disks, cards and the like. The remote can also have a LCD screen to view every operating function and contents of the digital photo album. The remote can also have link technology, wireless technology (701) and to operate all functions of the digital photo album. The LCD screen on the remote can have touch screen technology or any type known now or developed in the future. It also can have a password, fingerprint or the like, to operate and turn on. In a further embodiment, the digital photo album has an AV port to connect to the TV or similar screens or any similar type of TV connection known now or developed in the future. Instead of watching everything on the digital photo album itself, the user would be watching everything that can be viewed or heard on the digital photo album on the TV or similar type of screens.

FIG. 7 also illustrates a digital photo and text portfolio for businesses or others to show photos 710, videos, data and text 712 to customers etc. This portfolio can be used for boardrooms or presentations, everyone present can have the same type of portfolio linked together. This digital album can be used as a portfolio in a board room where everyone has one to view and the person giving the presentation can have a master remote to link all digital portfolio albums to have the same page viewed by everyone, instead of using paper. The user would continue to switch pages with text, photos and video etc.

Yet another embodiment of the present invention is to have Bluetooth technology, broadcasting, internet capabilities and other wireless, wireless router technology and capabilities known now and in the future. The user can send all their photos thru Bluetooth, internet and other wireless technology known now and developed in the future via computers, cell phones, cameras, and other electronic devices known now or developed in the future. The images could be stored in the storage area of digital photo album, so they would not get lost and can be viewed any time they want. The digital images can be viewed on the digital photo album only, for example, without storing the images on the digital photo album. Broadcasting can be used through the digital photo album. The user can send photos, albums, slideshows, videos etc to other digital photo albums anywhere in the world through wireless technology, internet and any other way known now or in the future. In one embodiment, the digital photo album has a computer, laptop, and notebook similarities except the digital photo album would be mainly for viewing, sending, copying, storing and editing digital photos. The digital photo album can have printer ports as well. Yet another embodiment is to send photos via the digital album to stores to have the images printed. As long as the digital photo album has connectivity with the internet, software can be implemented that will allow a user to select pictures directly on the digital photo album and have the same sent to an offsite facility for printing and delivery.

Yet another embodiment is to have an area to store music or attach to an iPod® or other digital media player, for example, so the user can listen to home videos or music. It can have speakers. The album can have a built in keyboard, or touch screen to edit, name photos, add text, etc. Furthermore, it can have built-in scanners or plug-in for scanners (FIG. 64), and have scanning technology so that old photos or photos that are in typical photo albums now can be scanned into the digital photo album or done via computer or ways known now or developed in the future and then be saved and inserted or sent to the digital photo album for viewing.

In a further embodiment, the digital album can have covers, skins, leather, colors, designs, fabrics and many more. These could be added on the outside to make it more special and personalized and could be sold separately. The covers can be removable and replaceable or interchangeable like face plates. The user can make it a baby album by putting a pink baby album cover on the digital viewing unit and then change it to their favorite color family album. A digital baby album can have a pink cover for girls and blue cover boys. A digital baby album, book or reader can be created by having any type of fabric or material on the cover. The cover of the digital album/book/reader can have any type of embroidery on it like, “Baby”, “Family”, “Friends”, “Treasured Moments” or other. It can have ribbons, bows, and trim pieces that go around the picture opening and other windows like a window that has the baby's name inside it. Any kind of decorative pieces can be placed anywhere on the cover or on any surface of the digital album/book/reader. A window where names pictures, wedding dates, anniversary dates, any important moments, important wording, sports etc. can be placed in the window to show through the front cover. This window can have a clear plastic or PVC material to protect the contents and so people can see clearly in the window. The window can have a trim or frame around it. The window can be created so the window trim and plastic are placed anywhere on the surface of the cover. The contents inside the window can be any type of material or any type of contents. The window can be designed where the window contains a name card that says, “Baby” for example and this would show thru the front window. This card can be made when the cover is built, so the user can't take it out. The window can be designed to have an opening on any side of the window to insert the card and take out the card. It could come with the card that says, “Baby”, then the user can take the card out from the right side for example and turn the card over and write or place a label with the baby's name on it and place it back inside the window, so the baby's name is showing thru the window. Any surface of the album can have designs, engravings, graphics, printed pictures or any type of decoration. The album or book cover can be designed as a wedding album with any color or any type of fabric. The wedding album can be white with ribbons and/or bows and be like any wedding album known today or developed in the future , but now it will be digital. The album or book cover can have licensed kids' designs like Barbie, Batman or any other character known now or developed the future. The designs can be professional sports teams, college sports teams, or any other sports team. Any surface of the digital photo album can be adorned with a sports, corporate or any logo of any type. The book or album can be designed with kids software, kids games, kids books, learning tools for adults or kids, and it can have a kids theme such as a Disney® album and it can be decorated like the Cinderella themes, or it can contain all the Disney stories and videos and be called a Disney® digital photo album.

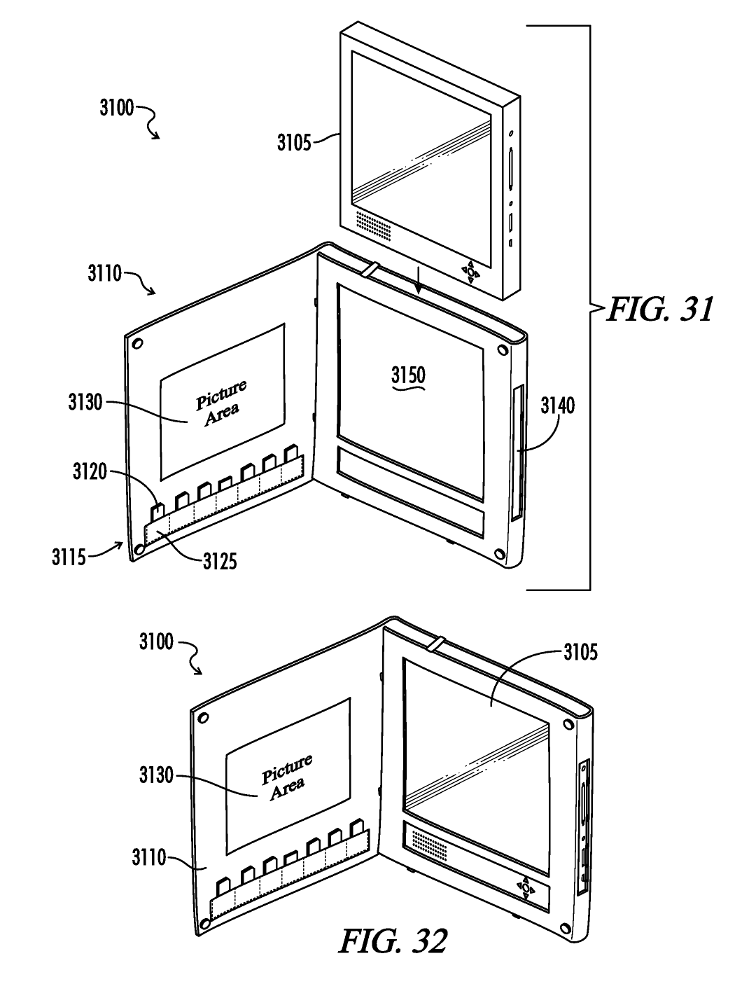

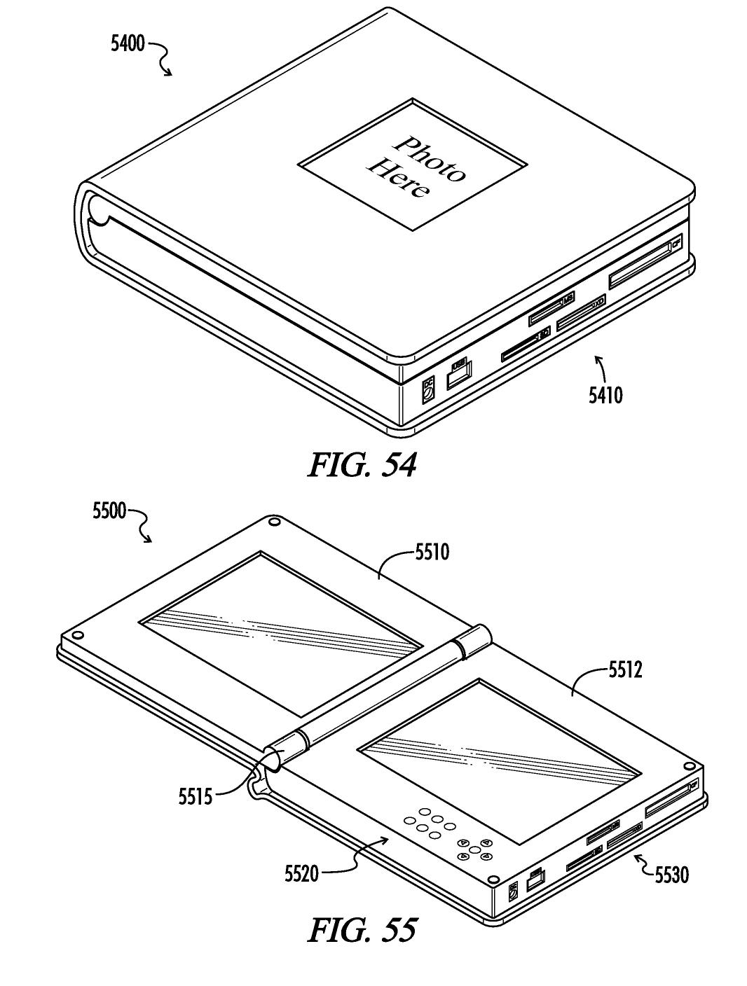

The cover can be put on via a hook and loop fastener or any type of fastening method known now or developed in the future. A cover can be made of any material and can be permanent or removable. The cover can have padding inside to give a softer feel. The cover can have a storage area anywhere on the cover. The cover can have place where the user can insert a picture that will show on the outside of the album or inside the cover. The picture can have plastic protecting the picture and have a plastic sleeve to protect and aid in taking in and out the picture from the album. The picture and sleeve can be placed in between the cover and the inside left body of the digital photo album. A portion of the sleeve can stick out so the user can easily pull the sleeve out from the album and interchange pictures or word art like “Memories” etc. One embodiment of a digital photo album and cover with storage is shown in FIGS. 31-34. Other non-limiting embodiments are shown in FIGS. 53, 54, 56, 58, and 59B, for example.

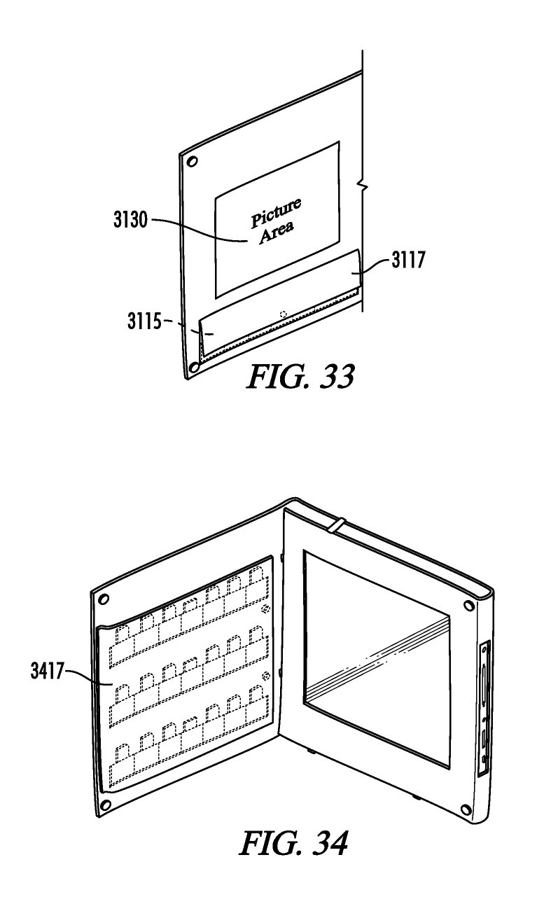

FIG. 31 illustrates one embodiment of a digital photo album 3100 comprising a digital photo viewing unit 3105, which can further comprise a digital photo frame for example, insertable into a cover 3110. In other words, any digital photo viewing unit 3105, which allows you to view digital photos etc., can slide into the cover 3110 from any side, or top to create a digital photo album 3100. The cover 3110 can be any type of material. The cover can have padding, so it protects and is soft to the touch. A storage area 3115 for memory cards 3120, memory sticks, flash drives, etc. and any type known now or developed in the future, can be placed anywhere within the cover 3110. There can be a storage area 3115, compartments or pouches 3125 can be in the inside left cover as shown in FIG. 31-34. FIG. 32 shows the digital photo viewing unit 3105 assembled into the cover 3110. In FIG. 33, the storage area 3115 has a flap or cover 3117 which covers the memory cards and similar devices 3120. In the embodiment of FIG. 34, a flap 3417 or cover wraps from left to right. The flap or cover can be any direction, secured via any means such as snap, button, hook and loop or the like. The embodiment of FIGS. 31-33 further comprises a picture area 3130 where the user can slide a printed picture or any type of paper or even CDs for example. This area 3130 can have a plastic cover protecting the picture. The picture area 3130 can also be a LCD screen if desired. This picture area can have an opening to the front of the album, so the user can turn a picture around and insert the picture in the picture area 3130 and then the picture would be visible to the front of the digital photo album cover 3110. This pouch can have a border around it to resemble a photo frame. There can be magnets, or any type of closure to help keep the album closed when not in use and closed. FIGS. 31, 32 and 34 illustrate a cutout or opening 3140 provided in the cover 3110 to enable access to ports on the digital viewing unit 3105 while such unit 3105 is housed within the cover 3110. Also shown is a securing feature or strap 3150, which can be an elastic type of material to be stretched so the digital photo viewing unit 3105 can slide into the cover 3110, then the strap 3150 elastic will hold the unit 3105 in place. The strap 3150 may be elastic and simply stretches out of the way during insertion and removal of the viewing unit 3105, or it may be fastened using other means such as snap, button, hook and loop or the like.

The embodiment of FIGS. 31-34 illustrates one way to convert an existing digital viewing unit, such as a digital frame or a tablet-style computer, into a digital photo album with onsite storage of media. Thus, the cover 3110 with storage 3115 could be vended separately and specifically dimensioned to accommodate digital viewing units currently on the market for example. This could be provided at the point of purchase for the digital viewing unit, or it could be done through an online system where a user would input the dimensions of the digital viewing unit, or the brand and size of the same, in order to obtain an appropriately-sized cover with storage. In other words, the dimensions, model, brand, etc., may dictate the size of the screen opening 3150 (FIG. 31), the location of the port opening 3140, and the overall dimensions of the combination unit 3100. Of course, while a storage area 3115 is certainly desirable, the cover 3110 may be vended without the same if it is only desired to convert an existing digital viewing unit into a covered album style.

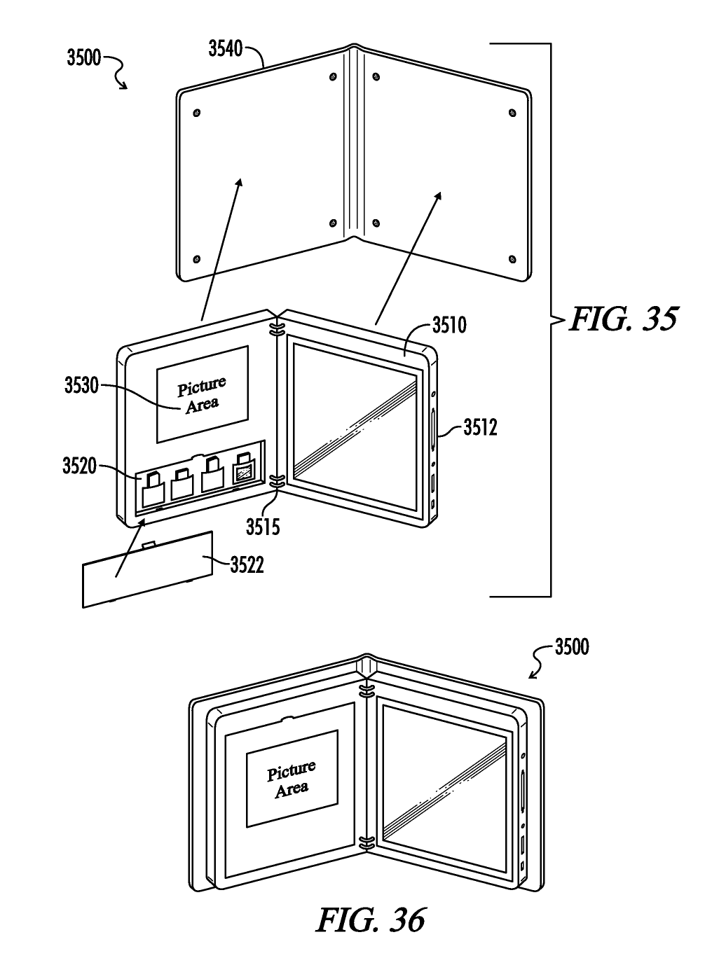

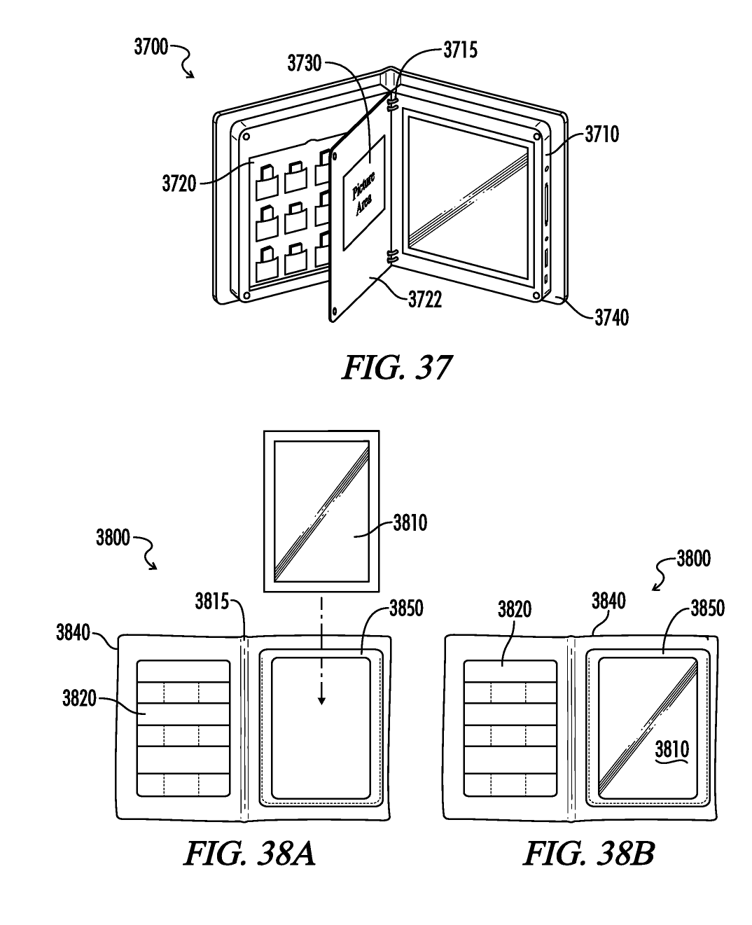

FIGS. 35-36 illustrates an alternative embodiment of a digital photo album 3500 comprising a digital photo viewing unit 3510 with ports 3512 connected to a storage area 3520 and picture area 3530, which is collectively connected to a cover 3540. The unit 3510 and storage area 3520 can be attached by hinge 3515 or any way known now or developed in the future. The storage area 3520, picture area 3530 or ports 3512 can be located anywhere. The unit 3510 and storage areas can be attached to the cover 3540 by hinge or any possible way known now or developed in the future. The cover can be made of any type of material and can have a picture area or a LCD area for the front of the cover as been described above. FIG. 36 illustrates the assembly of the elements shown in FIG. 35. In FIG. 35, there is shown a storage door 3522, which can be located anywhere. FIG. 37 illustrates a digital photo album 3700 similar to the album of FIGS. 35-36, but with a storage area 3720 hinged to a viewing unit 3710 and connected to a cover 3740, with a storage door 3722 for covering the storage area 3720 and that opens from the hinge 3715. The storage door 3722 can be attached or removable, and can be further provided with a picture area 3730, for example. The storage door or the area surrounding the storage door 3722 can also be covered with a felt type material to protect the viewing unit 3710 and also for looks. The surfaces of the storage door or surrounding the storage door any part of the album can have designs on it, engravings or printed pictures. Other ways of attaching the storage door 3722, such as magnets, catches, buttons, snaps, etc., are contemplated.

FIG. 38A shows one embodiment of a digital photo album 3800 comprised of a digital viewing unit 3810 and storage area 3820 where the unit 3810 can attach to the cover 3840 by sliding it into a sleeve or pouch 3850 in the cover 3840. It can be placed into this cover by any direction, can be permanent or removable and can be attached anyway possible known now or developed in the future. FIG. 38B shows the assembled album 3800, with a storage area 3820 on the left and the viewing unit 3810 on the right, but of course these items can be arranged in any order and in any location. FIGS. 38A and 38B both show a touch screen or touch border interface, however it can comprise buttons or other functioning methods. A loose material, curved area or flexible area is shown in the binding area 3815 to aid in the opening and closing of the album 3800 and to make it appear like an album book. All binding areas in this application can look like a book, photo album, scrap books etc.

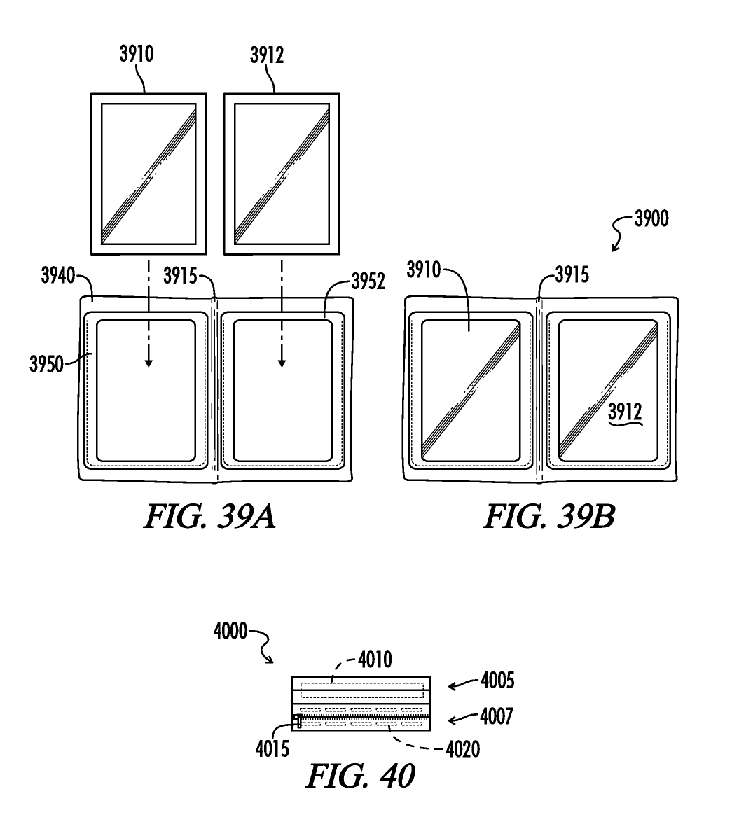

FIGS. 39A and 39B show a digital photo album 3900 comprised of two digital viewing units 3910, 3912 inserted into sleeves or pockets 3950, 3952 and housed in a cover 3940. Even though the units 3910, 3912 appear to be separate, the units can be attached via wire or any electronic means to connect the two units together so they can work together in unison. A storage area 3920 can be located on the back of the digital photo album 3900 or there can be side trays or side, top, or bottom insert storage areas as desired. The binding area 3915 is shown between the units and it can have a cover to hide the wire connections between the two units 3910, 3912.

FIG. 40 shows a bottom edge view of an alternative embodiment of a digital photo album 4000 in a closed orientation. The top section 4005 is where the digital viewing unit 4010 is located. The bottom section 4007 shows the storage area 4020 with a zipper 4015 for opening and closing the storage area. Anywhere the storage area is located, there can be a zipper storage compartment for opening and closing the storage area. The top section and bottom section can be hinged together as discussed herein, or attached using other means.

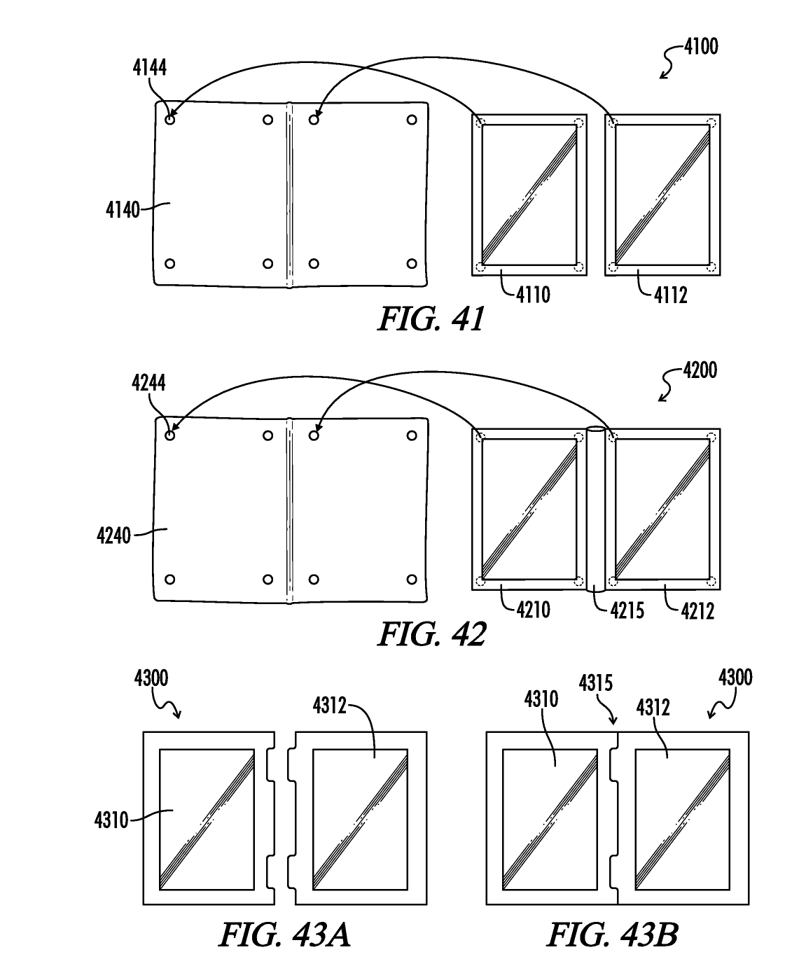

FIG. 41 shows an alternative embodiment of a digital photo album 4100 comprised of two separate digital viewing units 4110, 4112, attached to a cover 4140 via removable fastener connections 4144 such as hook and loop, adhesive, snap or screw or other known ways. The units 4110, 4112 can be connected together via wire or other electronic means as previously described, and storage areas (not shown) can be provided on the back of the cover in a manner as previously described.

FIG. 42 shows an alternative embodiment of a digital photo album 4200 comprised of two digital viewing units 4210, 4212 connected to a hinge 4215 and then the hinged unit is attached to the cover 4240 via removable fastener connections 4244 such as hook and loop, adhesive, snap or screw or other known ways. The units 4210, 4212 can be connected together via wire or other electronic means hidden with the hinge 4215 as previously described, and storage areas (not shown) can be provided on the back of the cover in a manner as previously described.

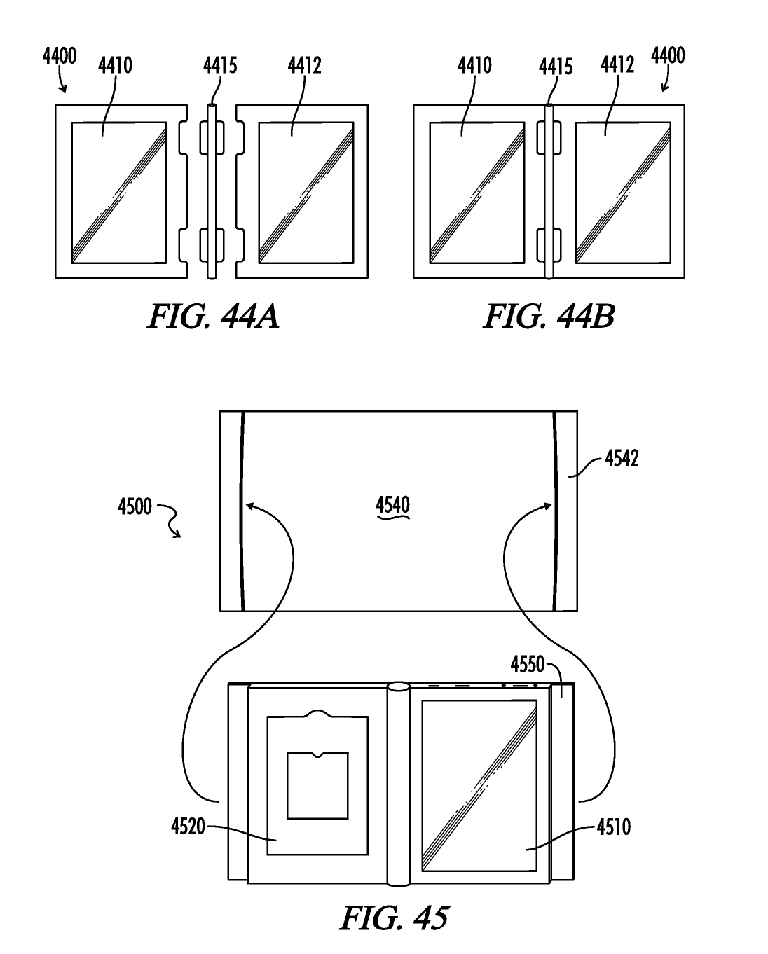

FIGS. 43A and 43B show an alternative embodiment of a digital photo album 4300 comprised of two digital viewing units 4310, 4312, where the inside right side of the first display unit 4310 and the inside left side of the second display unit 4312 mate to form a built-in hinge 4315, so when the units are connected with a hinge pin, it can open and close like a book. While two viewing units are shown, it will be appreciated that either viewing unit can be substituted with a media storage area, and/or additional storage areas can be provided on the back of each unit or anywhere else desired. Also while not shown, this embodiment can have a permanent or removable cover (not shown). It will be appreciated that all covers mentioned in this disclosure can be permanent or removable. FIGS. 44A and 44B show an alternative embodiment of a digital photo album 4400 comprised of two digital viewing units 4410, 4412 connected to a separate hinge 4415.

FIG. 45 shows an alternative embodiment of a digital photo album 4500 having a cover 4540 with sleeves or pockets 4542 and a support 4550 for a storage area 4520 and viewing unit 4510 that is insertable into the sleeves 4542. Of course, while the viewing unit 4510 is shown on the right and the storage area 4520 is shown on the left, it will be appreciated that there can be multiple viewing units, and/or with storage areas positioned in any location on the front or back of the album. The sleeves or pockets 4542 on the cover are placed or slide over the ends the digital photo album support 4550. FIG. 45 shows an old style book cover that is made of any type of material and it can have one layer or multiple layers of material. A zipper or any type of storage compartment is contemplated.

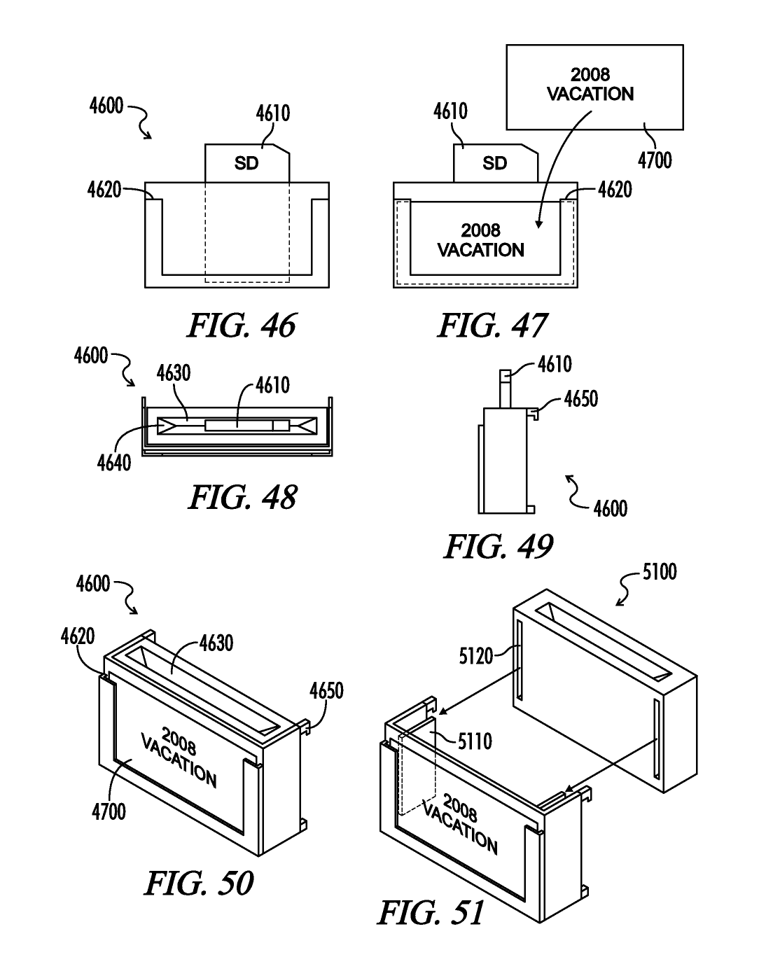

FIGS. 46-51 illustrate one embodiment of a universal storage pocket or compartment 4600 for holding digital media as described herein for use with the various digital photo album embodiments described herein. FIG. 46 shows a front view of the compartment or pocket 4600 with a SD memory card 4610 inside that is shown for purposes of illustration. The universal pocket or compartment can fit any size memory card, memory stick, flash drive or any similar device known now or developed in the future. Depending on the size, one to multiple devices can fit inside the pocket or compartment 4600. FIG. 47 illustrates a label or name tab 4700 that can be placed or slid into slots 4620 on the front of the pocket or compartment 4600. The name label or tab 4700 can also be glued or otherwise removably or permanently affixed using a variety of means. The name tabs or labels 4700 are a great way for the user to identify what's inside the memory card or like device 4610. FIG. 48 illustrates a top view of the pocket or compartment 4600 containing a memory device 4610. The area 4630 inside and around the memory card or device 4610 can be tapered 4640 for easy entry. The material can be soft material like rubber or foam, harder-type material or any type that helps protect and hold the memory card or device in place. With a flexible, resilient material inside area 4630, it makes it possible to hold thick and thin memory cards or similar devices in place, which allows the storage area to be more universal, so the user can place any type of memory card or any similar device in the universal storage compartment or pocket.

FIG. 49 illustrates a side view and FIG. 50 illustrates a perspective view of a universal pocket/compartment 4600 with memory card or similar device sticking out of the top 4610 and with connectors 4650 for attachment to a digital photo album storage area as will be described below.

FIG. 51 illustrates one embodiment of a compartment 5100 having legs or extenders 5110 that extend into the device area 5120, which may be comprised of rubber, foam or other resilient material to hold it in place or it can have adhesive to secure it. The assembly, design or attachment of the universal storage compartment/pocket can be any type known now or developed in the future. The material can be any type of material known now or in the future. There can be label areas where the user can add and remove labels so the user can identify what memory card or device is in the storage area. The label area can have grooves or slots where it holds a paper or any material label in place. The label can be an adhesive label or not.

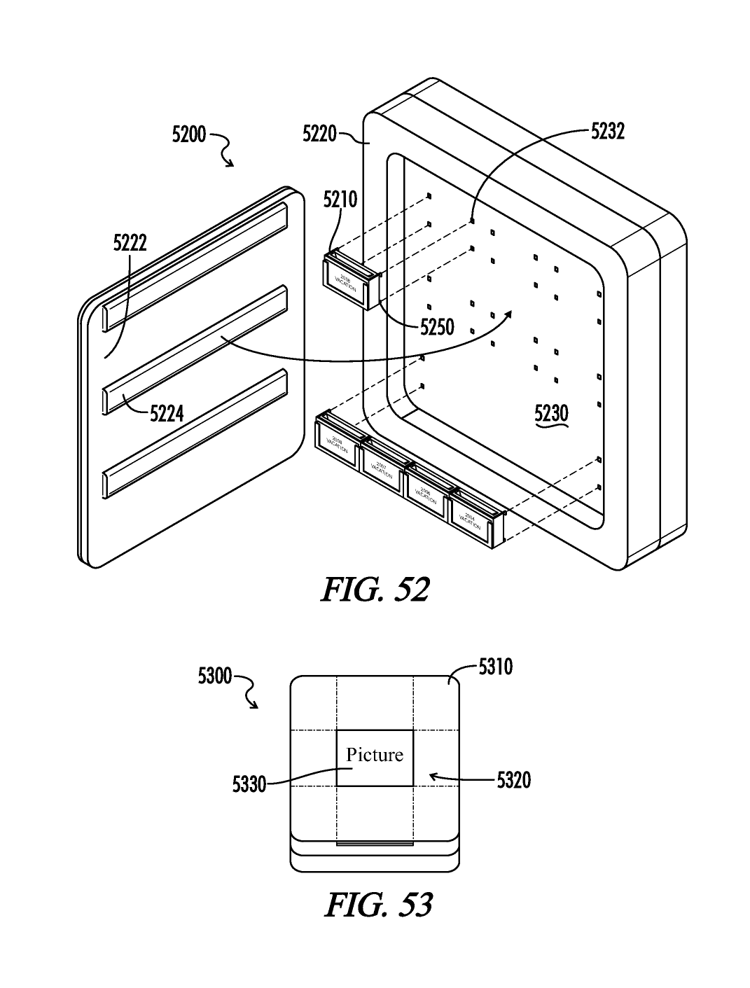

FIG. 52 illustrates a partial view of one embodiment of a digital photo album 5200 including a storage area 5220 with an individual storage compartment/pocket 5210 being attached to a storage support structure 5230. The bottom section shows a row of connected universal storage compartments or pockets 5210 that are then connected to the support structure 5230 of the storage area 5220 through the engagement of connectors 5250 with openings 5232 in the support structure 5230. The storage area 5220 can have any amount, any combination of compartments or pockets. In the illustrated embodiment, a storage door or cover 5222 is provided, which can be attached using a variety of means. The inside of the storage door 5222 can further comprise areas of padding 5224 that stick out farther than other areas of the inside of the storage door 5222 so they can hold the memory card or devices in place and so they don't move around. The padding 5224 also aids in protecting the memory card or devices. In the storage area 5220 or door, there can be also other material that is heat barrier to protect the memory card and like devices. The storage area can be fire proof and water proof.

FIG. 53 illustrates one embodiment of a digital photo album 5300 having a front cover 5310 with a picture area 5320 and a variety of potential placement locations for insertion of a picture 5330 into the picture area 5320.

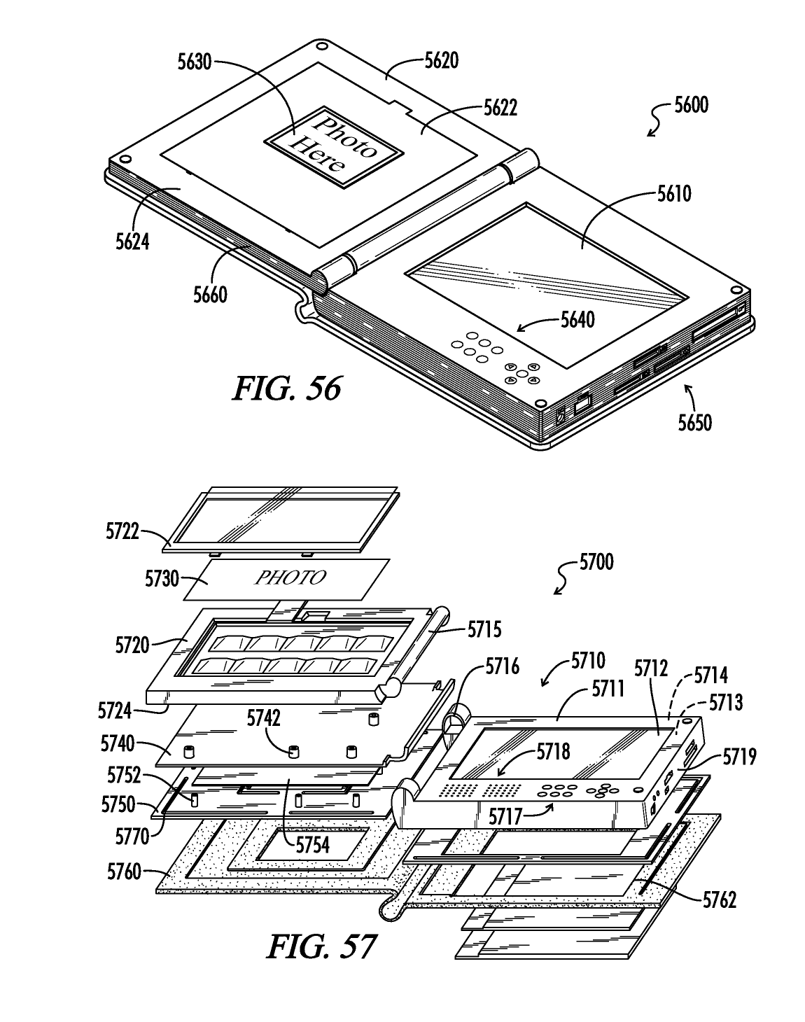

FIG. 54 illustrates one embodiment of a digital photo album 5400 in the closed orientation that looks like a typical photo album or book. The digital photo album can be designed in many different ways, however this application may show many versions, but many more are possible. Also shown are examples of port openings 5410 with the name or abbreviation of the port, next to the opening. There can be grooved lines (FIG. 56) or any type on the side of the album to make it look like actual paper pages. FIG. 55 illustrates one embodiment of a digital photo album 5500 having two display screens 5510, 5512, a control panel 5520 and port openings 5530. The rounded hinge 5515 shown is constructed partially from each display screen, which provides a clean, attractive appearance. Control buttons can be used or touch screen technology or touch border interface. In other words, with a touch key interface there will be icons like arrows and menu icons to operate, but with no tactile buttons. A thick plastic screen protector, for example, can be placed over the screen 5512 to be flush with the unit, and has smooth surface icons, like arrows and a menu icon printed on it, so the consumer can easily operate the unit in a touch fashion. In one embodiment, the screen protector might be a piece of plastic 2 mm thick, the icons are printed on the inside panel first, and then a white painted border is painted around the border and a screen area is left clear in the middle, so when the cover is placed over the display screen, the display screen will show through the cover.

FIG. 56 illustrates one embodiment of a digital photo album 5600 having a display unit 5610, a storage area 5620 with a picture area 5630 on the door 5622 of the storage area 5620, a control panel 5640, ports 5650 and the appearance of lines 5660 along the sides to simulate pages of a book. The storage door 5622 has a place 5630 to insert a picture or art card or any document. Thus, instead of presenting a plain storage door, it can also offer the user more by allowing them to place a picture of a friend, loved one, animal, art card or any kind of document. The surrounding area 5624 around the door 5622 can have plastic or other material raised or other designs to resemble a frame around the picture area 5630.

In the embodiments of FIGS. 54-56, it is preferred that the appearance of the digital photo album resembles a real book or album as discussed above. In addition to the outward appearance, it is also preferable to have a screen that looks like an actual page of a book. With a single screen model (see FIG. 56, for example), when the user switches the page via touch key, touch panel, border, remote or any other way known now or developed in the future, the page actually looks like it's turning when the page is being switched or turned. Instead of flipping pages, it's done electronically with an image of a page folding, turning over, flipping over, or switching to the next page. Any kind of image or way of showing this is possible. With a dual (two)screen model (see FIG. 55, for example), when the user switches the page via touch key, touch panel, border, remote or any other way known now or developed in the future, the page actually looks like it's turning when the page is being switched or turned. Instead of flipping pages, it's done electronically with an image of a page folding, turning over, flipping over, or switching to the next page. The image of the page flipping, turning or switching over can start with the right side 5512 and end up on the left side 5510, just like a regular page being turned. Each screen would look just like this feature but the page turning would appear electronically. The image of the page can be from the left side 5510 to the right side 5512 as well, just like Japan readers read from right to left and switch the page differently. Any kind of image or way showing this can be done. The image can be a corner of a page being turned over or any known now or developed in the future. The image of switching or turning can be any design or from any angle or direction. It is also preferred to have pictures or images and text on the page as well. The digital album can be a full line of encyclopedias with text and pictures, or a book with pictures and text or any kind of book, magazine, school books, or any kind known now or developed in the future. The pictures can active movements in them, as the pictures are moving. Like a live picture or video. Any way to do this that is known today or developed in the future can be done.

FIG. 57 illustrates an exploded view of another embodiment of a digital photo album 5700. The number of layers shown is illustrative for purposes of example only, as variations in this embodiment can have more layers or fewer layers as desired. Each layer can have a purpose and is not limited to the number of layered parts shown. While FIG. 57 illustrates a single display screen 5710, the invention is not limited as such and can have multiple display screens as desired and as illustrated in various embodiments disclosed herein. Furthermore, while a single storage area 5720 is shown, variations in location and placement are possible. In addition, left and right side placement in the digital album 5700 is variable, such that the parts can be located on any place and any side. On the top left side one part shows a storage door 5722 and picture 5730 for sliding into or placed in the storage door 5722. Another part below shows a storage area 5720 and the right side has a hinge assembly 5715. Another part is under the storage area 5720 and is a back plate 5740 with connectors 5742 that attaches to the back 5724 of the storage area 5720. Below the back plate 5740 is part of the cover 5750, that is stiff or flexible or any type of material that the outside cover 5760 is attached to. This part 5750 also has connectors 5752 to connect to the back plate 5740 and if there was no back plate, then it would attach to the back 5724 of the storage area 5720. This part can also have an area used for sliding or placing a picture or art card 5754 between the cover and the body of that particular side of the album 5700. The openings 5770 around the perimeter are used to sew the leather or any type of outside cover 5760 that is shown below to a firmer part of the cover, and then this part is attached to the back plate 5740 or the storage area 5720. The cover 5760 can also be glued or attached in any way known now or developed in the future to the digital photo album. The right side of FIG. 57 shows the digital viewing unit 5710 with a hinge assembly 5716 on the left side. This part can have several parts to make this but not limited to a face plate 5711, screen 5712, CPU 5713, battery 5714, buttons 5717, speaker 5718, port parts 5719 and openings, electrical components and all hardware to make the unit function. The back, side or anywhere of this unit can have a battery compartment or storage compartment and there can be a door or cover for each or together. The cover 5760 is shown to be one piece; however there can be one or several pieces. The cover can have an opening 5762 for the picture, LCD screen or art card showing through the front. It can also have openings for compartments like battery, or storage areas and the cover or door can have leather or any type of material on it as shown on the bottom right side.

FIG. 58 illustrates another embodiment of a digital photo album 5800 in the closed orientation and showing how a picture 5810, art card or other can be inserted in and out between the cover and the body of the album. The picture, art card or other can have a plastic sleeve 5820 protecting the picture, art card or other. The plastic or type material sleeve can stick out past the body, but not past the cover and the user can grab the sleeve and be able to pull the sleeve and picture, art card or other in and out of the digital photo album. Inside the storage area can have an area where the user can insert a picture, art card or other in and out and it will show through the front of the album

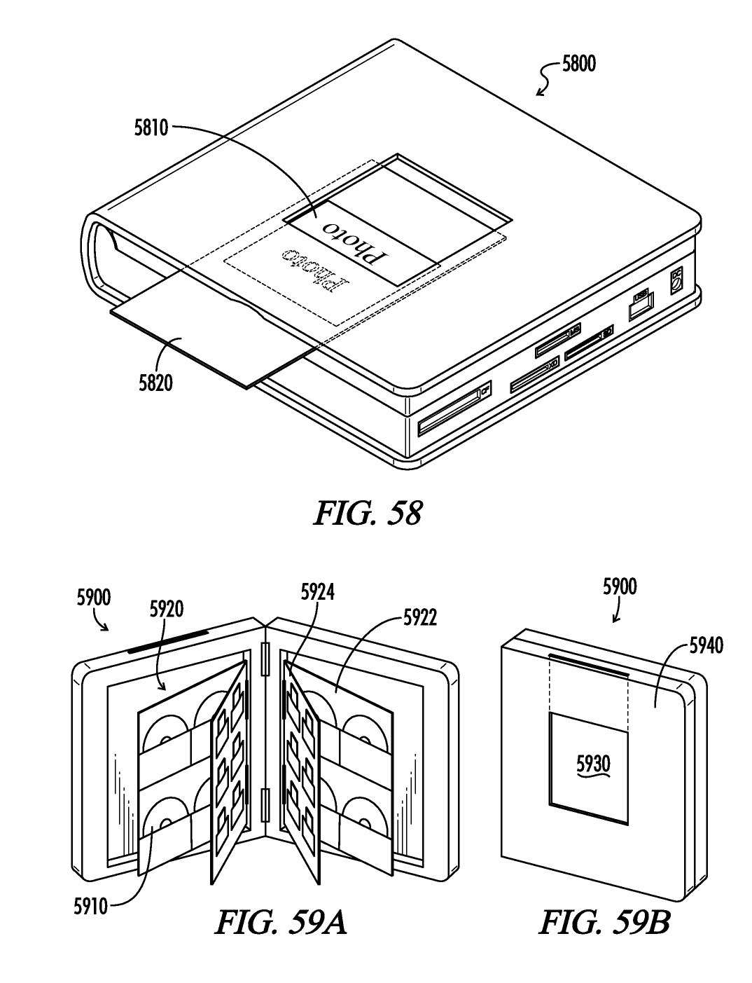

FIG. 59A illustrates another embodiment of a digital photo album 5900 in the open orientation showing a digital photo organizer that holds and stores digital photo storage devices 5910 like CD's, memory cards, memory sticks, flash drives or any other devices known now or developed in the future. It looks like a photo album book. There can be pages 5920 like shown, that the user can add or take out pages as needed. Some pages 5922 may be custom fit for CD's, while some pages 5924 may be custom fit for memory cards and similar devices. The pockets and pouches would be custom fit to fit all types of digital photo capturing cards or devices known now or developed in the future. FIG. 59B illustrates a closed orientation of the digital album 5900 that shows where a picture or art card 5930 can be placed, so it will show through the front cover 5940. The insert area can be from the top, anywhere or from the inside of the storage area.

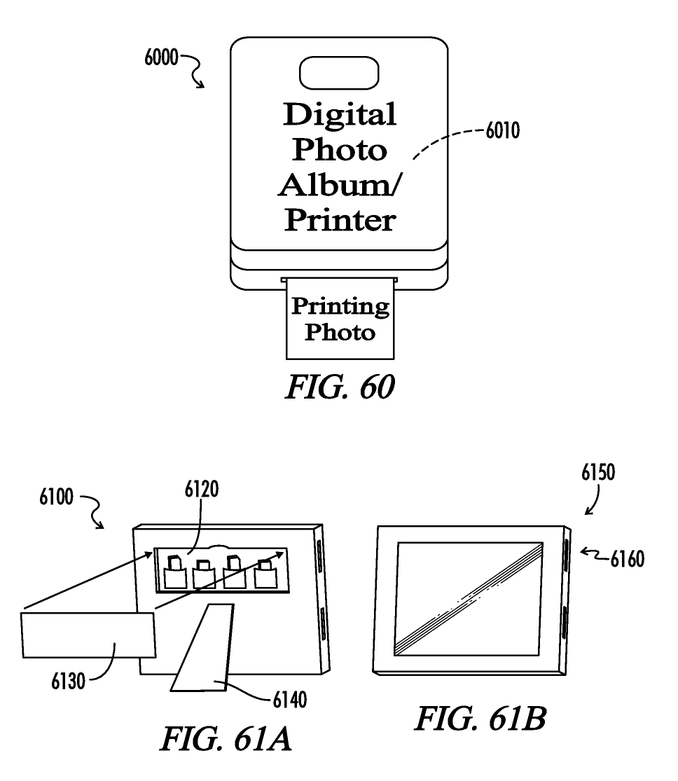

FIG. 60 illustrates another embodiment of a digital photo album 6000 that includes a built-in printer 6010. The printer can be any type size or shape and be locate anywhere within the digital photo album. The digital photo album can also have printer ports to connect to an external printer.

FIG. 61A illustrates a rear view of another embodiment of a digital photo album 6100 showing a storage area/compartment 6120 and cover 6130 on the back. Also shown is a support 6140 to enable the album 6100 to be propped on a desk or other support surface. FIG. 61B shows an album embodiment 6150 with a storage/compartment 6160 on the right side. The storage area/compartment in the digital photo albums as described herein can be anywhere, any size, type, in or on the frame or any way mentioned in this application or known now or developed in the future.

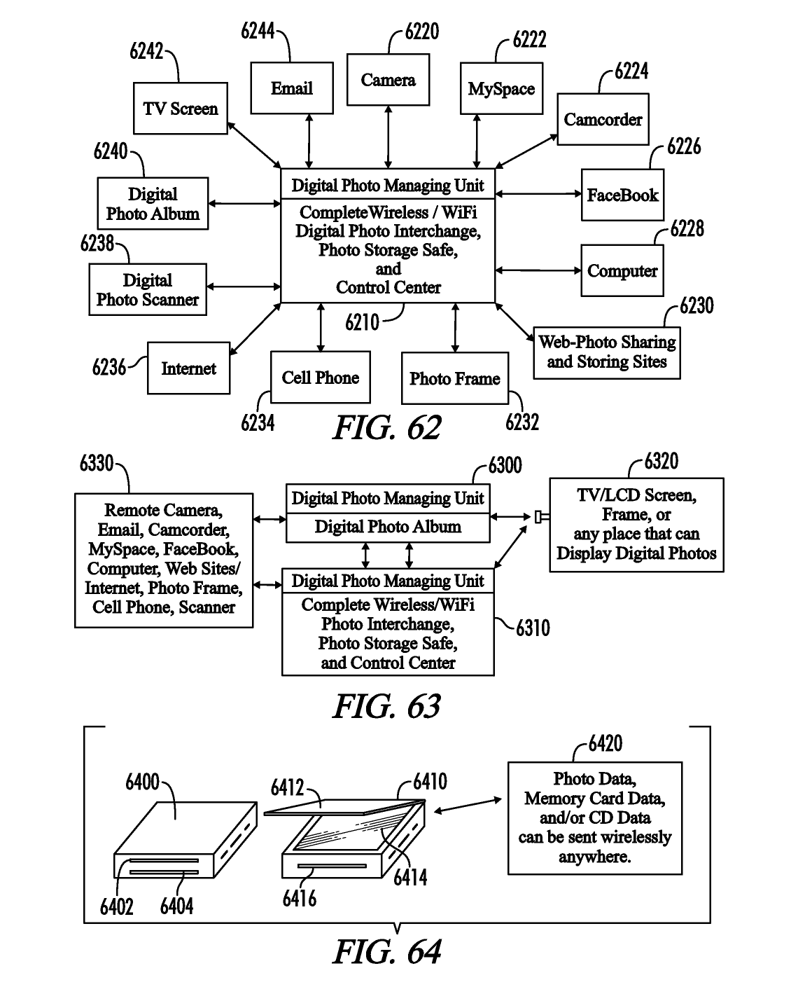

FIG. 62 shows a wireless digital photo managing and storing unit 6200, which can be contained inside any type of digital photo album discussed herein or developed in the future. It also illustrates a flow chart for sending, managing, receiving and storing digital photos in a Complete Wireless/WiFi, Digital Photo Interchange, Photo Storage Safe, and Control Center 6210. One preferred way to send, receive and store digital photos is wirelessly. In FIG. 62, the managing and storing unit 6200 can be the main storing medium for digital photos, where the user can safely store digital photos without worrying about losing any of their valuable photos. This unit can be shaped any way possible; can have a hard drive, built-in memory and also have an external hard drive to store all the photos. This unit can be plugged in; it can have batteries, battery backup or any possible energy to operate. In one embodiment, an internal memory can consist of all memory cards or memory expansion cards, where there is no hard drive or moving parts. This will ensure no loss of photos. The unit can have a LCD-type screen to view any sending, receiving and storing information. In FIG. 62, there are illustrated double arrows coming to and from the Digital Photo Managing and Storing Unit 6200 and the Control Center 6210. Photos and videos are displayed, viewed, shared, and used in cameras 6220, MySpace® 6222, camcorders 6224, Facebook® 6226, computers 6228, web-photo sharing and storing sites 6230, photo frames 6232, cell phones 6234, via the Internet 6236, digital photo scanner 6238, digital photo albums 6240, TV screens 6242, emails 6244 and other places known where digital photos can be located. This flow chart shows how digital photos and videos can be sent wirelessly to and from the digital photo managing unit 6200 and digital photo storage safe and control center 6210 or within the digital photo album. The unit 6200 can have a wireless router, WiFi (not shown) and built-in software to manage digital photos, send, store, locate, and/or receive digital photos. The unit 6200 can have a server (not shown), and/or a personal web site (not shown) where a user can communicate with the unit 6200 to find photos send and receive photos and videos anywhere. The photos can be located in separate memory card areas. The unit 6200 can hold thirty memory cards, for example, of any size and the user can communicate and send or receive photos and videos from any storage compartment. The photos and videos can be organized and labeled for quick access by the consumer. For example; a camera 6220 if it had wireless capabilities, can send photos to the unit for safe storage. For example, the user can take a picture with a cell phone 6234 and send photos to the digital photo managing unit 6200 and place the photos or videos in a safe location. The user can access the stored photos at any time and send, receive, share and store photos without the worry of losing photos. By sending digital photos and videos wirelessly, it makes it convenient for everyone especially when all your photos and videos can be located easily in one safe location.

FIG. 63 illustrates a digital photo album 6300 which can contain a digital photo managing unit 6310 or can be separate. It also shows a flow chart for sending, receiving, managing and storing digital photos to TV screens 6320, or any type of screen, frame or any place that can display digital photos known now or developed in the future. FIG. 63 illustrates the concept that a consumer can send and receive photos and videos wirelessly to the TV, or any place that digital photos are displayed from a digital photo album, digital photo managing unit, remote camera, email, etc. 6330, or any type known now or developed in the future.

FIG. 64 illustrates two embodiments of a wireless digital photo scanner 6400, 6410 that can send digital photos wirelessly to any location. Either scanner can be any shape or size. With one embodiment of a scanner 6400, a user slides a photo of any size into the front slot 6402 and the unit scans the photo to a memory card, CD, etc., 6420 and the user can send the photo or wirelessly to any location. The scanner 6400 can have CD port 6404, for example, for copying photos or videos to memory and can send the photos or videos wirelessly anywhere. Another scanner embodiment 6410 has a flip top 6412, where a user can place a photo on top of the screen 6414 and scan the photo to a memory card, CD, etc., 6420, and the user can send the photo or wirelessly to any location. The scanner 6410 can also have CD port 6416, for copying photos or videos to memory and for sending the photos or videos wirelessly anywhere.

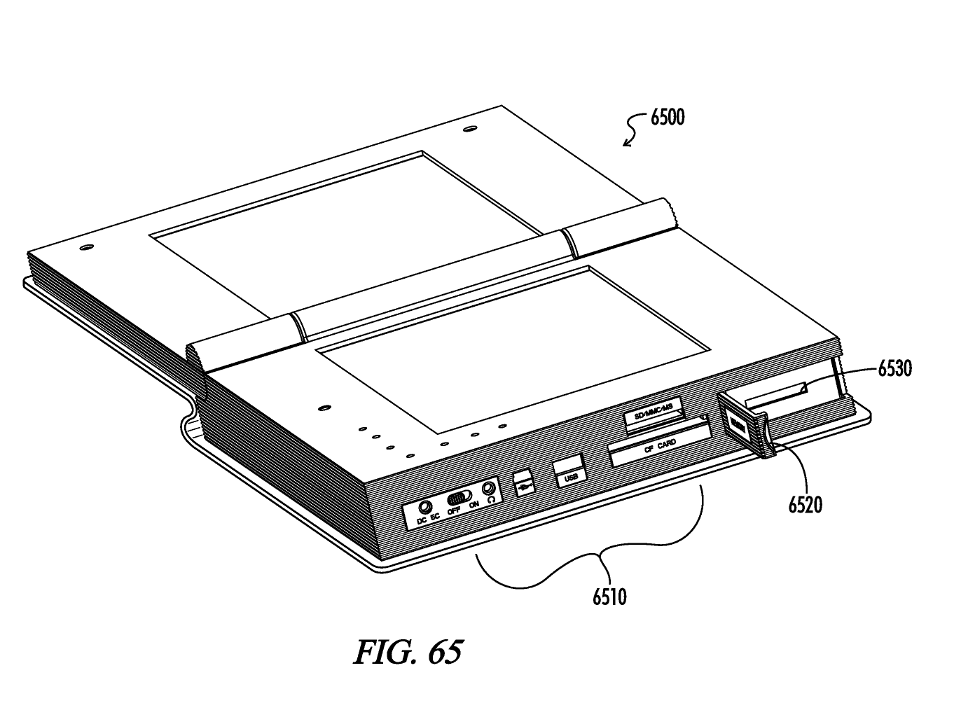

FIG. 65 illustrates one embodiment of a digital photo album 6500 having port openings 6510 and an external memory compartment door 6520 open with access to a removable memory 6530 like a memory card for example. The port openings 6510 can be any size, shape and can have any type connection to any cable, any electronic device, camera, cell phone, computer, any photo capturing device, video, music ports, memory card ports, etc., a power switch, AV out, speaker port or any port/slot known now or developed in the future. Other ports are contemplated. FIG. 65 also shows a memory compartment for access to the album's built-in memory. Most digital photo frames of today come with built-in memory, so the consumer can store photos inside the unit and view them at any time. The problem with this is if the digital photo frame goes bad, then the consumer cannot retrieve those photos. To solve this problem, the embodiment of the digital photo album 6500 would have built-in memory for photos, videos and music, but the built-in memory would be stored in a memory card or a like device and can be removable. If the digital photo album 6500 has a defect and does not work, the consumer would never lose their photos because they can access the external storage compartment and pull out their removable memory card for example. Another important benefit relating to the embodiment of FIG. 65 is easy access to the removable memory, which allows consumers to increase the memory of the digital photo album 6500 at any time with no effort. If a consumer had a one gigabyte memory card in the unit, the consumer can increase the memory of the unit by replacing the existing memory card with a higher capacity memory card.

FIG. 66 shows one embodiment of a digital photo album 6600 with a digital viewing unit 6610 on one side and a storage area 6620 on the other side memory card and similar devices can be stored. In one embodiment, the back wall 6622 of the memory card storage area 6620 can have rubber, plastic, or foam type material 6624 that is attached by glue, snap, screwed or any way known. Then, an individual, or multiple compartments 6630 with dividing walls 6632 can be snapped, screwed or any way known to the back wall 6622 and enclose the rubber, foam type material 6624. While there can be any number of rows or individual compartments 6630, the embodiment of FIG. 66 illustrates for purposes of example two rows of individual compartments with three sections in each compartment. For example, two SD or XD cards and one compact flash card can fit into each individual compartment. The compartments can fit any number of memory card and similar devices and can be any shape or size. In front of the compartment area 6630, there can be, for example, PVC plastic heat sealed and glued to the front of the compartment to create a sleeve or pocket 6634 for inserting name tabs to identify what's inside the memory card or similar device. This way it allows the consumer for easy identification of the photos, videos stored in the storage compartment. The inside of the storage area 6620 can have padding, rubber, or foam type material to hold the memory card and similar devices in place, so they will not move around when the digital photo album 6600 is carried or is upside down for example. Vent holes 6640 are provided on the top of the storage area 6620 and above the display panel 6612 of the viewing unit 6610 to allow heat to escape. In addition, speakers can be located behind this area. The vent holes 6640 located above the storage area 6620 are generally for cosmetic purposes to match the vent holes 6640 located above the display panel 6612, such that when the album 6600 is closed the two sides 6610, 6620 would be together and the vent holes 6640 would match. FIG. 66 further illustrates a slot 6650 above the storage area 6620 where the plastic cover and picture or art card (printed “Memories” for example), slides in and out and appears in the front of the album 6600. A groove 6660 is located in the middle of the slot 6650 to allow the user to insert their finger in this area to get a hold of the plastic cover with picture in and out. This can be located anywhere or be any size and shape.

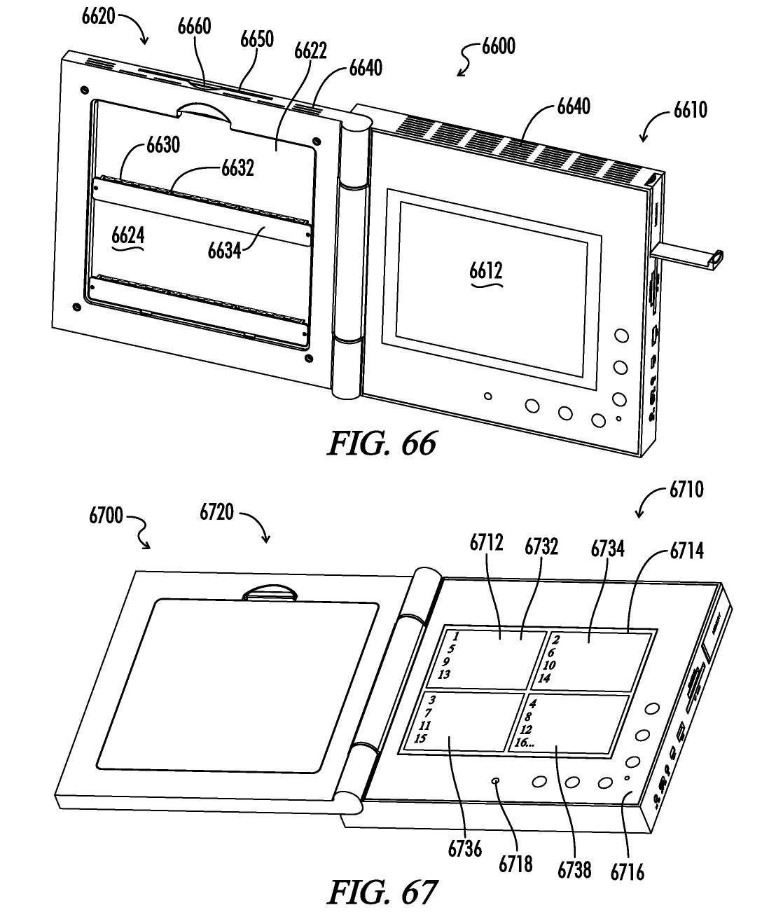

FIG. 67 illustrates one embodiment of a digital photo album 6700 in the open position with a digital viewing unit 6710 to the right and a storage area 6720 to the left. The storage area 6720 can be blank or have a place to insert a printed photo or the like. In such embodiment, a touch key function with touch key sensor technology is shown. The digital display 6712 has an outer surface that is flat with no raised surface and it also can comprise a touch border interface, where the user touches a border 6714 around a displayed photo to operate the device. Silk screen or printing can be placed on the touch key areas, so the user can know where to touch and operate the unit quickly and easily. In one embodiment, the touch key areas can be placed in the lower right corner 6716, so when the user is holding the unit, they can comfortably and easily locate and touch the touch key areas easily without effort of moving their entire hand around; they would only move their fingers, or thumb for example. A remote sensor 6718 can be located anywhere on the unit, but FIG. 67 shows it in the middle below the display 6712.

FIG. 67 illustrates one embodiment of a digital display 6712 that is selectable from a full-screen mode or a four-photo mode. In a full-screen mode, a user can choose to watch full screen photos, videos, and if they want to view full screen photos, photo #1 would appear and when they click next, photo #2 would appear and if they click next again, photo #3 would appear and if they choose previous, then it would take them back to the previous photo and so forth. In four-photo mode with display areas 6732, 6734, 6736 and 6738 as shown specifically in FIG. 67, the numbers in the photo areas indicate picture order and can go on for as many photos that are in the memory or the number of photos in the card port or USB ports, etc. The photos can appear in any order or any time, or any number of photos or size. If the user decides to view four photos, then four photos could appear at the same time, but for example shown in FIG. 67, photo #1 could appear in display area 6732, then photo #2 could appear in display area 6734, then photo #3 could appear in display area 6736, then photo #4 could appear in display area 6738. When a user clicks the next key or button, photo #5 could appear in display area 6732, then photo #6 could appear in display area 6734, then photo #7 could appear in display area 6736 and photo #8 could appear in the display area 6738. If the user clicks previous, then it would take the user back to the previous four photos and so forth. The photos can be delayed when appearing or be at the same time. The user can select slide show or transitional effects at any time. By using four photos appearing or any number, it gives the effect of viewing photos like a typical photo album but without physically flipping pages.

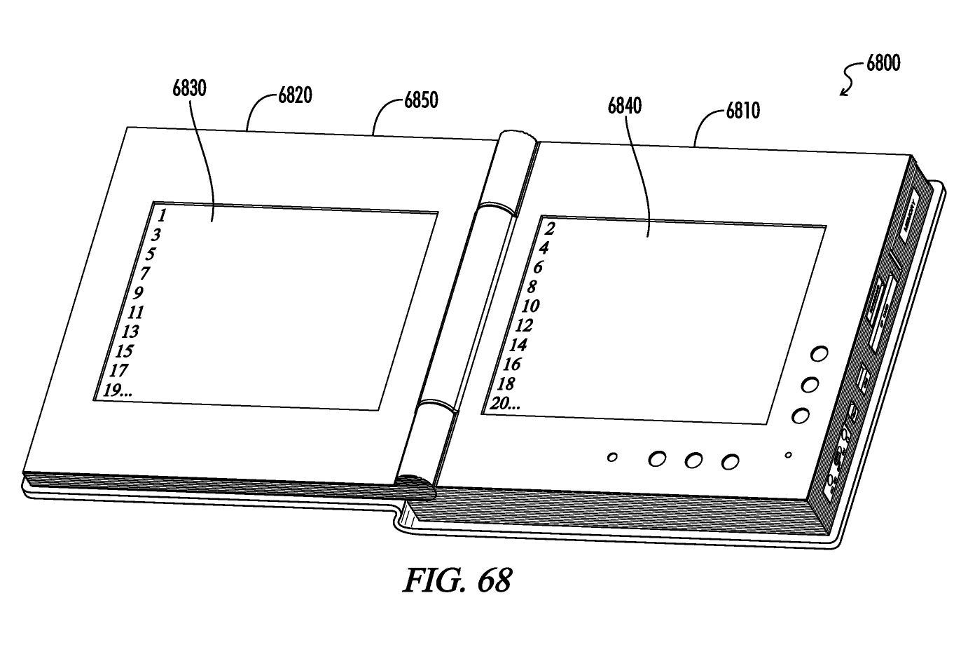

FIG. 68 illustrates one embodiment of a digital photo album 6800 open with two full-screen digital display units 6810, 6820, having display areas 6830, 6840, with a storage area 6850 on the back of one of the display units 6810, 6820 or not being present in such embodiment 6800. A user can choose to watch full screen photos, videos, etc., and if they want to view full screen photos, photo #1 would appear in display area 6830 and photo #2 would appear in display area 6840, and if the user clicks next again photo#3 would appear in display area 6830 and photo #4 would appear in display area 6840 and so forth. If the user chooses previous, then it would take them back to the previous photos and so forth. The photos can be delayed when appearing or appear at the same time. The user can select slide show or transitional effects at any time.

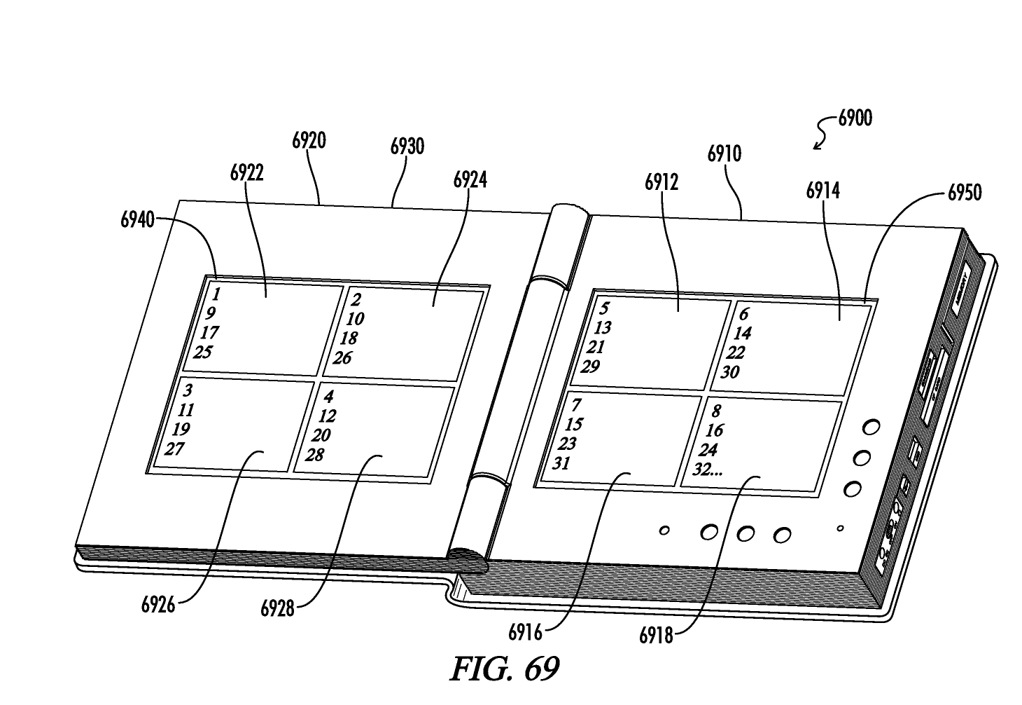

FIG. 69 illustrates one embodiment of a digital photo album 6900 open with two full-screen digital display units 6910, 6920, having display areas 6912, 6914, 6916 and 6918 on display unit 6910, and display areas 6922, 6924, 6926 and 6928 on display unit 6920, with a storage area 6930 on the back of one of the display units 6910, 6920 or not being present in such embodiment 6900. As shown in connection with other embodiments described herein, the numbers in the display areas can indicate photo order and can go on for as many photos that are in the memory or the number of photos in the card port or USB ports, etc. The photos can appear in any order or any time, or any number of photos or size.

In a dual-display, four-picture mode as shown in FIG. 69, one embodiment of a navigation solution would designate display area 6922 as a navigation display, all other display areas 6924-6928 and 6912-6918 being dependent on the first display area 6922. So, for example, if a user advances to photos #25 through #32 in display areas 6922-6918, but the user desires to see photo #9 again, the user can select “previous” until photo #9 is in display area 6922, with the remaining display areas showing photo #26 through photo #32. If the user then selects “next,” then photo #10 will replace photo #26 in display area 6924, and then hitting “next” will result in photo #11 replacing photo #27 in display area 6926, and so on. In other words, in this example, hitting “previous,” will trigger only a navigation of the photo in the display area 6922, all other display areas remaining unchanged. Of course, other navigation options employing all illustrated display areas are contemplated, such as a user being able to flip through four or eight pictures at a time, or one at a time, or two at a time, as the case may be. If the user clicks previous, then it would take the user back to the previous four photos per screen which is eight photos and so forth. The photos can be delayed when appearing or be at the same time. The user can select slide show or transitional effects at any time. In addition, in one embodiment there can be a border 6940, 6950 around each photo or collection of photos or display area or areas, which border can be any color, shape, size, etc., and can look like frames. In the menu, a user could have the option to choose frame styles, border styles or colors of any kind, etc.

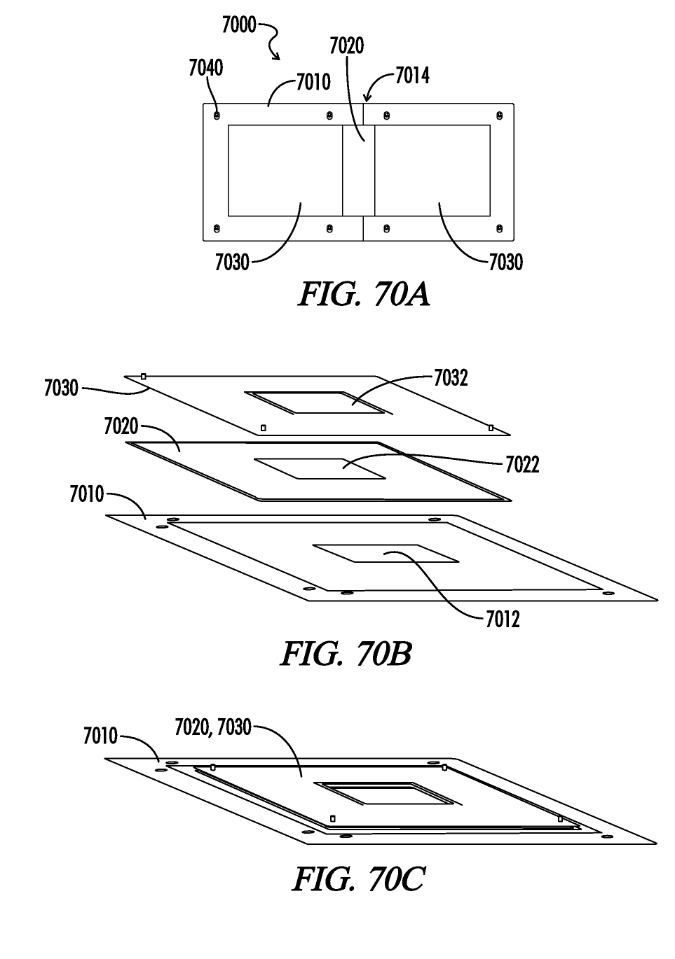

FIGS. 70A-70C illustrate one embodiment of a method of creating a digital photo album cover 7000 to encase or cover a digital photo album as described herein, and generally further comprises a support cover 7010, a binding material 7020, and an encasing cover 7030, each of which can have a window 7012, 7022, 7032 for displaying a picture (not shown) therethrough. The support cover 7010 can be leather, leatherette, or any other material. The binding material 7020 is preferably a cardboard or other paper stock, although other materials are contemplated. The encasing cover 7030 is preferably a harder plastic material to add some rigidity to the cover 7000 and to provide a support for attachment to a digital photo album, although a variety of materials are contemplated. FIG. 70A illustrates two support covers 7010 connected by the binding material 7020 with encasing covers 7030 attached through the binding material 7020 and to the support covers 7010 as shown in FIG. 70B. FIG. 70C illustrates the attachment of all layers 7010, 7020, 7030 of one side of an album cover 7000.

FIGS. 70A-70C illustrate one way of attaching a leather cover to a digital photo album, but is not limited to this and can be done any way know now or developed in the future. FIGS. 70A-70C show a leather cover with openings 7012, 7022, 7032 for a picture or pictures for the front of the digital photo album, and can also have a hole (not shown) for a rear storage area for a dual screen digital photo album as described herein. A picture for the front the album can optionally be included. A variety of holes 7040 are positioned in strategic locations around the cover 7000 for attachment of the cover 7000 to a digital photo album housing. Binding material 7020 is a cardboard, paper, book cover type of material to create a book cover appearance, so it will make the digital photo album feel comfortable when holding and appear like a conventional book-type photo album. The binding area 7014 is preferably formed from thinner cardboard, paper type material, and is glued or otherwise attached to the support cover 7010, with stitching being made around the perimeter, any style or shape to give a nice appearance, There can also be stitching around the picture area that appear in the front of the album. The binding material in the binding area 7014 is preferably sewn a specific distance away from the inner edge of the cover 7010 and digital photo album housing. In this area between the binding and the inner edge of the cover and housing, the inner part of the housing with leather and hinge (top part) goes inside the other part of bottom housing and hinge assembly, when its completely open. If you reverse the hinges, the other side would go inside the other part, so the bottom would go inside the top, which is a useful feature to make this leather look nice and open and close nicely.

FIG. 70A also shows two plastic covers 7030 that are glued to the support cover 7010, with binding material 7020 being glued and stitched to the support cover 7010. This can be attached any way known now or developed in the future. The holes 7040 in the support cover 7010 (any number) are placed over plastic round areas, where a screw can be screwed into the opening 7040 and the cover 7010 is glued to the perimeter of the cover 7030. The cover 7030 can be raised like shown or not. Now a digital photo album housing can be screwed or any type of fastening method known now or developed in the future, to the covers 7030, which can be one or two pieces as shown. The covers 7030 are separated so that the binding area 7014 will be loose and flexible when fastening it to a digital photo album housing and so that a user can open and close the album easily. In one embodiment, a digital photo album housing would be tightened through the covers 7010, 7020 and 7030 for a strong connection.

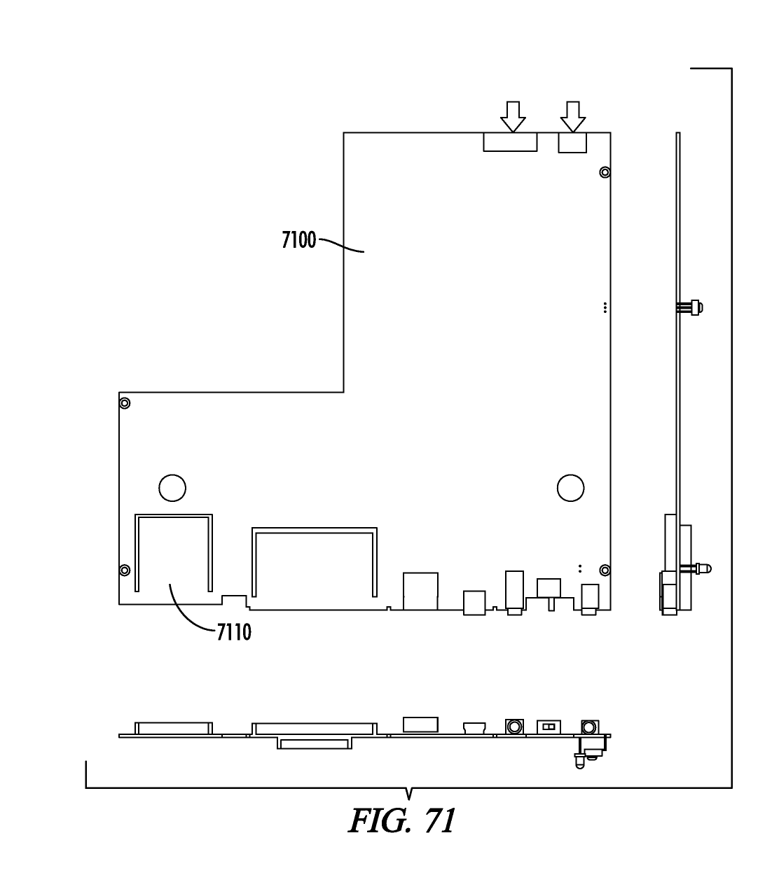

FIG. 71 illustrates a Program Computer Board (PSB) and chip 7100 having a removable memory slot 7110 that is built in the PCB and allows the user to remove and replace memory at any time from an external memory compartment as described herein elsewhere. The user would open a memory compartment and insert or replace a memory card in the slot 7110. This will allow the user to have safe photos without the chance of losing their photos from the digital photo album if it goes bad or is defective. The user can also increase or decrease the memory at any time. It is preferable that the PCB 7100 and memory card or similar device slot that can be removable from the outside of the digital photo album. The PCB 7100 can be any size shape, type, any computer chip or software that's known now or developed in the future, and can be used for any electronic device, any photo frame, etc., known now or developed in the future. For a dual-screen unit, it is preferable that the PCB 7100 communicates with a transistor in the other screen for dual-screen functionality.

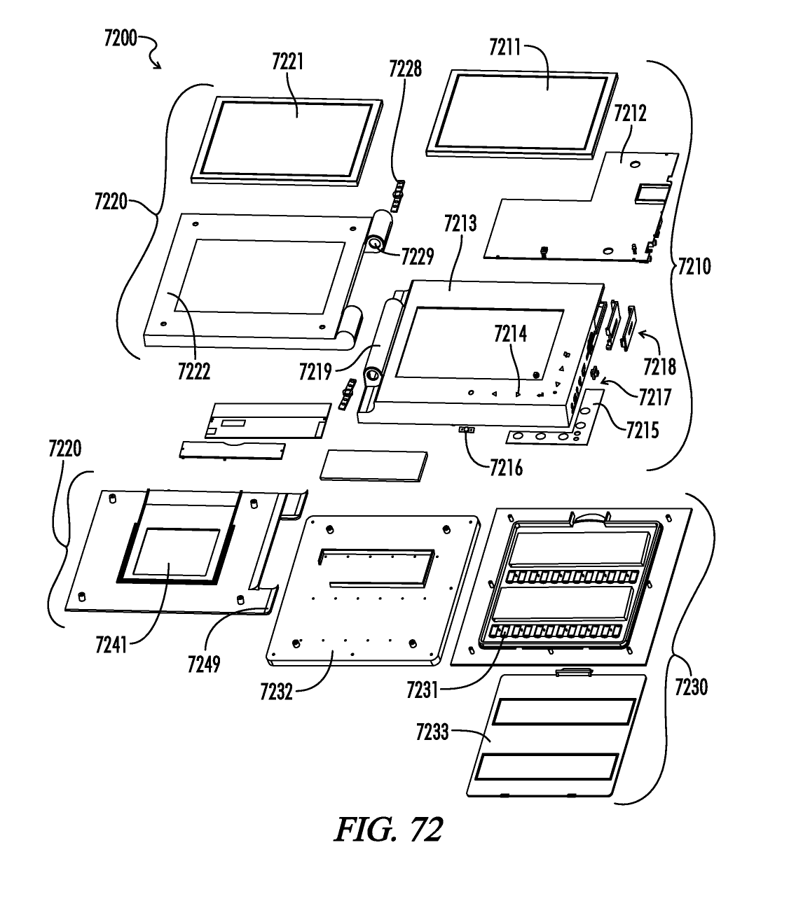

FIG. 72 illustrates one embodiment of a parts view of a dual-screen digital photo album 7200 with two digital viewing units 7210, 7220 generally and a storage area 7230 generally on the back of one of the viewing units 7210, 7220, and with a leather (or the like) cover removed for ease of illustration. The details of each of these units 7210-7230 are described above, and it is understood that the size, shape, etc., can be varied as desired by the user. Unit 7210 generally comprises a screen 7211 and PCB 7212 contained within a cover 7213, the cover 7213 having navigation buttons 7214 under a touch pad 7215, a remote port 7216, various input/output ports 7217 and a removable memory area 7218. A hinge area 7219 on the unit 7210 engages with hinge 7229 on unit 7220 via hinge fasteners 7228. In this embodiment, the plastic housing or cover 7240 that attaches to a leather cover, for example, as described in FIGS. 70A-70C, can have part of the hinge assembly 7249 molded or attached to it for engagement with the hinge assemblies 7219 and 7229 of units 7210, 7220. Unit 7220 further comprises a display 7221 contained within a cover 7222 that engages with cover 7240, which cover 7240 has a window 7241 for displaying an inserted photo or the like. Storage area 7230 further comprises storage locations 7231 situated on a backing 7232 for holding memory cards or the like, and a cover 7233 for access to the storage locations 7231. A battery or other power source can be built into the digital photo album or be removable therefrom, or both as desired. Any type of power source known now or developed in the future, including direct plug-in, is contemplated.

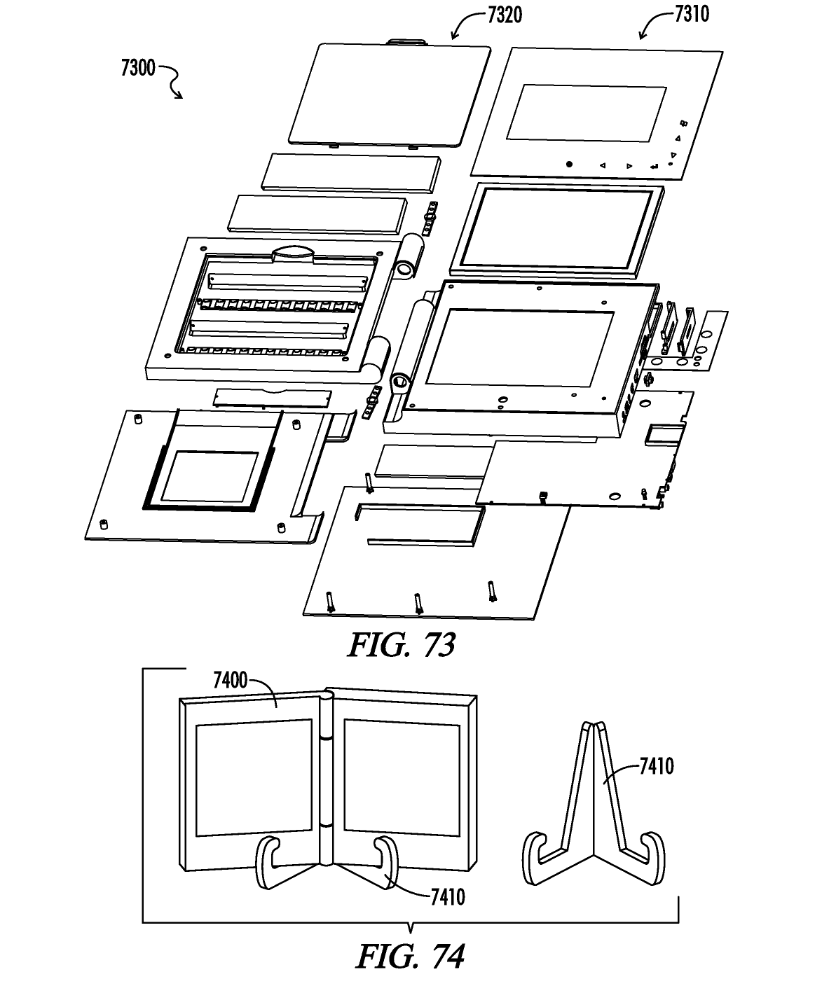

FIG. 73 illustrates one embodiment of a parts view of a digital photo album 7300 having a digital viewing unit 7310 on one side and a storage area 7320 on the other side, and with a leather (or the like) cover removed for ease of illustration. The details of each of these units 7310 and 7320 are described above, and it is understood that the size, shape, etc., can be varied as desired by the user.

FIG. 74 illustrates one embodiment of a digital photo album 7400 and holder 7410 for displaying the digital photo album 7400 in the vertical position, on a counter, coffee table or anywhere, similar to a digital photo frame. A remote control can be used in connection with a remote port provided on the digital photo album for navigating through pictures, videos, etc., while physically spaced from the album 7400. A user can open the digital album 7400 like a book and store it in the holder 7410 and view photos and video with a remote. The holder 7410 can be any size, shape, design or any type of material, and preferably has hinges for adjusting the amount of opening or it can be designed to fold flat for insertion into a digital photo album gift box, for example, and/or offered as a bonus or can be sold as an accessory. The holder or easel can have ways to adjust the angle, so the unit can be at the perfect desired angle for consumers to view. The easel or holder can have pads to help hold the unit in place and protect the unit from being scratched. The easel or holder can also be used to hold a digital cook book in place on counter or any location.

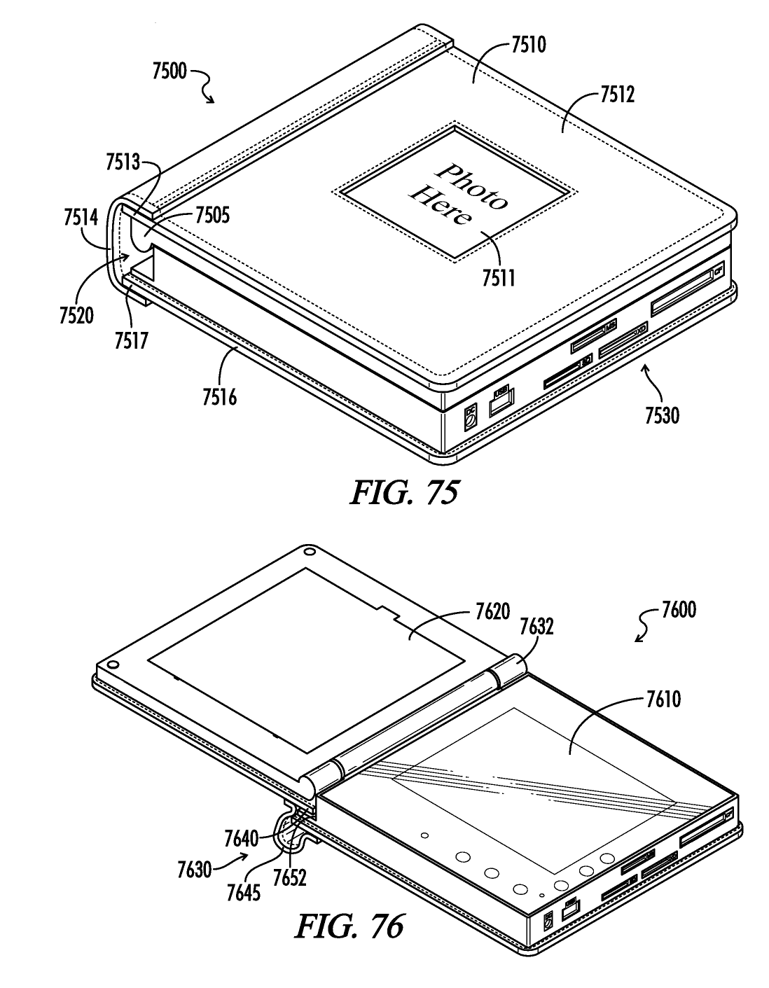

FIG. 75 illustrates one embodiment of a digital photo album/book/reader 7500 in the closed orientation with a leather cover 7510 with binding 7520. The cover 7510 can be any material known including, but not limited to leather, leatherette, and the like. The cover 7510 can be attached by any means known or developed in the future including by adhesive, glue, screw fasteners, hook and loop fasteners, a slidable connection, by flexible or non flexible straps or any attachment known now or developed in the future or described in this application. The leather cover 7510 as shown in the embodiment of FIG. 75 is preferably provided in three pieces, namely a top piece 7512 on the top of the digital photo album 7500, a bottom piece 7516 and a binding 7514 attached to the top and bottom pieces 7512, 7516. It is preferred that the binding 7514 is not attached to the inner end 7513, 7517 of the top and bottom pieces 7512, 7516, but is instead attached away from the edge. This allows the area between where the binding 7514 is attached away from the edge 7513, 7517 of the top and bottom pieces 7512, 7516 to be flexible. This flexible area helps the album 7500 to open and close easily. The binding area 7514 and the top and bottom pieces 7512, 7516 can be one piece, although it is not preferred because a binding area of a one piece construction will not have enough flexibility relative to a multi-piece construction and will likely not look good after a lot of use.

In one embodiment, the leather or other material would be fastened to a piece of plastic for the front of the album and then a piece of plastic for the back of the album. Then a binding would connect the two pieces of plastic to create the album or book cover. The plastic on the cover would have male or female fittings that could connect to the main body of the front and back of the digital album or digital book. The plastic fittings could either slide one way or the other to connect the cover and binding to the main body and can be released the same way. The fittings can also snap together or any other way known now or developed in the future.

The hinge area 7520 of the embodiment of the digital photo album 7500 is designed so that the hinge 7520 looks good when the album is open and so that the album 7500 can open all the way to assume a substantially flat orientation as shown, for example, in FIG. 76. In order for the album 7500 to open up all the way, a portion 7522 (FIG. 75) of the inner binding area of the body of the album 7500 must be removed to accommodate the end 7513 of the top cover 7512 in this embodiment to allow the album to open up all the way. This is why the top and bottom pieces 7512, 7516 of the cover 7510 are attached to the binding 7514 away of the ends of the covers and why there is a flexible area where the binding 7514 is attached away from the end. This allows a portion 7505 of the album 7500 and the attached end 7513 of the cover 7512 to go inside the inner body of the binding area of the hinge 7520. With the binding being flexible, it allows the binding to always look good because it is not affected by hitting the hinge area 7520. While the hinge area 7520 is illustrated and described in the current embodiment, it will be appreciated that any hinge design may be used, such as a typical hinge design found on laptops, door hinges, or any type of hinge available now or developed in the future. The embodiment of the album 7500 can have ports 7530 as described previously, or it can have no ports, and it can have all of the previously-described features and functionalities from previously-described embodiments as well. For example, the ports can be in the storage area where there can memory card storage slots or ports that connect to the unit for viewing photos, books, text, videos, music or any media or others known now or developed in the future. If the album does not have any ports, then it can be provided with a wireless feature like Bluetooth, router or any known now or developed in the future to receive everything from movies, books, photos, albums, music, videos and any other media, text, etc. The album 7500 can have touch key control, touch screen, buttons, remote, touch border interface or any known now or developed in the future to navigate and use. The front 7511 of the digital album/book/reader 7500 can have a LCD screen or a place to put a personal photo, art cards or the like, family, friends, memories, decorations, other windows that can have names, dates or name of the book, title, LCD screen that shows graphics and advertises the book, shows chapters, or it can be plain. If there is a photo or art card, name card, date card that shows through the front, it can have a place or slot to slide a photo with or without a plastic protector in the top body of the album or anywhere on the album as the case may be.

The cover material can be leather or any type material and can have any design shape material that looks like a book or album. The binding can be any shape or size and it can be embossed if desired, embroidered or have details or raised surfaces or the like. Some older bindings have raised surfaces with intricate designs that enhance the appearance and showmanship of the binding. This embodiment can be any size or shape and have any book or album appearance. It can have removable cover and binding like skins or it can be replaceable, so it can be removable or permanent as the case may be. The visible sides of digital album can have grooved, page like characteristics to appear like a book, or it can be smooth or have any design. There can be embossing, graphics or prints anywhere on the outside of the album. It is preferred if the digital album looks like a book, even though it's digital and the user doesn't actually flip any pages physically, but it is all done electronically. Pages, text, images, photos, anything stored can be shown via remote, touch key, touch screen or any known way or developed in the future.

The digital album/book/reader of this embodiment can have various storage areas and capabilities. It can have computer software like Windows®, Linux, MAC OS, or any know now or developed in the future. It can include a night light or any type of lighting to help read or view in any kind of environment. It can come with a book marker or page LCD marker. The LCD panels can be any kind known now or developed in the future for watching movies, videos, viewing books, viewing albums, viewing photos of any kind. The screen can be protected by screen protectors like clear Plexiglas® or any material. The digital album can have batteries that are rechargeable, permanent or removable and any type known now or developed in the future. It can incorporate an AC adapter for charging, and it can have a charging station where the user can place the digital album to be charged and ready to use at any time. There can be a charging light built in the unit, to let the user know its low on battery or needs to be charged. It can be any color light, it can be done on the screen or any way known now or developed in the future. The album can be a slim design or any design, and can be designed like portfolios, presentation books, magazines, or any other known now or developed in the future. The unit can have text for example, a complete line of law books, authors books, kids books, college books, K-12 books, special subject books, cooks books, encyclopedia books, complete line of books of generations, genealogy books, many years of history books or any known now or developed in the future. The screens on the digital book/album/reader can be vertical or horizontal and be any size or shape.

The digital album can save printing books for the future; It can be a space saver by not requiring as much space because one digital album/book/reader can for example; take the place of hundreds of albums or books. Hundreds or any number can be possible and it all depends on the storage area, memory card, built-in memory etc. The future will only bring more memory and memory capacity, the potential can be unknown, and it could have 1,000 books all in one. The digital album/book/reader can have a search mode to search for books chapters, albums, books etc., for easy locating. The way you can search and get the information you are searching for can be like searching on the internet, computer or any software known now or developed in the future. It can save the environment by not using as much ink and paper to make printed books. It can save college students or any student's money by not having to purchase and exchange books. There can be a complete line of books all in one. All subjects can be in one place to use at any time. It can contain sample tests, dictionary, thesaurus, or others and have a key pad via touch key, touch screen or remote. The unit can be designed so that the user can purchase downloads and download material and media via wireless router, the internet, from a book store, etc. for viewing at any time. The user can also send any information that goes into the digital album/book to another digital album/book or any electronic device or file it away a server as described in this application.

The digital album/book/scrapbook can have a keyboard, or touch screen keyboard, controls, or operation controls locate anywhere on the unit. It can slide out from the side top or anywhere. It can extend out or be on the unit in any location. It can have DLNA 1.5 or any type of system, or software similar to this known now or developed in the future. It can have any kind of system to communicate to TV's, servers, computers, laptops, notebooks, photo storing and viewing sites, any web site, digital photo albums, digital scrapbooks, digital ebooks, Digital books or any electronic device known now or developed in the future. For example, a consumer can have a digital photo album and be sitting on the sofa and send videos and photos to the TV for everyone to enjoy or to any electronic device to show, display, store or share. Even though certain drawings in the present application illustrate an AV out so consumers could connect the digital album to the TV, the digital album can also have a built-in server where they can save photos, videos, documents, digital media and send to any location. The unit can be portable unit where consumers view all their favorite video, photos, scrapbooks, text, media, books, newspapers, magazines, any media, or text or graphics, or documents thru the digital book or album. Newspapers and magazines may not have print versions in the future, and everything may be digital, the consumer can have one unit that has it all in one. Newspapers, magazines, etc. can be sent to the digital book daily to read, and feels like a real book or album. The digital photo album/book/reader/etc. can be a tool to view things stored in the cloud, can be the unit most used for reading books, magazines, newspapers, viewing photo, photo album, home videos, scrapbooks, to share, store, send and receive with the same or other electronic devices, or with servers, interne sites, web sites, operating systems and companies.

The digital unit described herein has the ability to receive, send and store digital media, text, documents, videos, photos, albums, scrapbooks, photo books. The disclosure provided herein can have DMR (Renderer) and DMS (server). The digital album/book/etc. can have an IP address inside the unit, have WiFi, built-in flash, and have links to Flickr, Photo Bucket, Snapfish, Kodak, HP, Sony, or any company or web site. It can be made with a slim design construction, so it's real slim. It can have no storage area for memory cards or it can have it. It can also have no lines on the side like a book. It can be designed to have an ultra thin look with any shape or design and have any hinge mentioned in this application.

FIG. 76 shows one embodiment of a digital photo album/book/reader 7600 in the open orientation with a LCD screen 7610 on the right and a storage area 7620 on the left. The hinge area 7630 illustrates how the top cover 7640 extends into a gap 7652 provided adjacent the screen area 7610 when the album 7600 is fully open. FIG. 76 also illustrates a flexible binding material 7645 that can have one or several layers of material along with the leather type material attached to the body of the album 7600. It also shows one embodiment of a rounded hinge component 7632. The hinge 7632 can be any shape or size, and the gap 7652 can be reversed such that the rounded hinge component 7632 can be on the top and the gap 7652 can be on the bottom, or vice versa. The gap 7652 that the body of the album goes into can be hidden by having a cap (not shown) hide it from the outside and the part of body and leather type material near the binding end 7645 can be inset so it can go inside the body of the album or book behind the cap hiding the gap 7652 from the outside. The binding 7645 would still be in the same position. This is just one way to hide the gap 7652, however many ways are possible that are known today or developed in the future to hide the gap to make it more appealing and less noticeable. The screen 7610 can be used for viewing text, book, photos, music, magazines, cook books any kind of book, videos like home movies or regular movies.

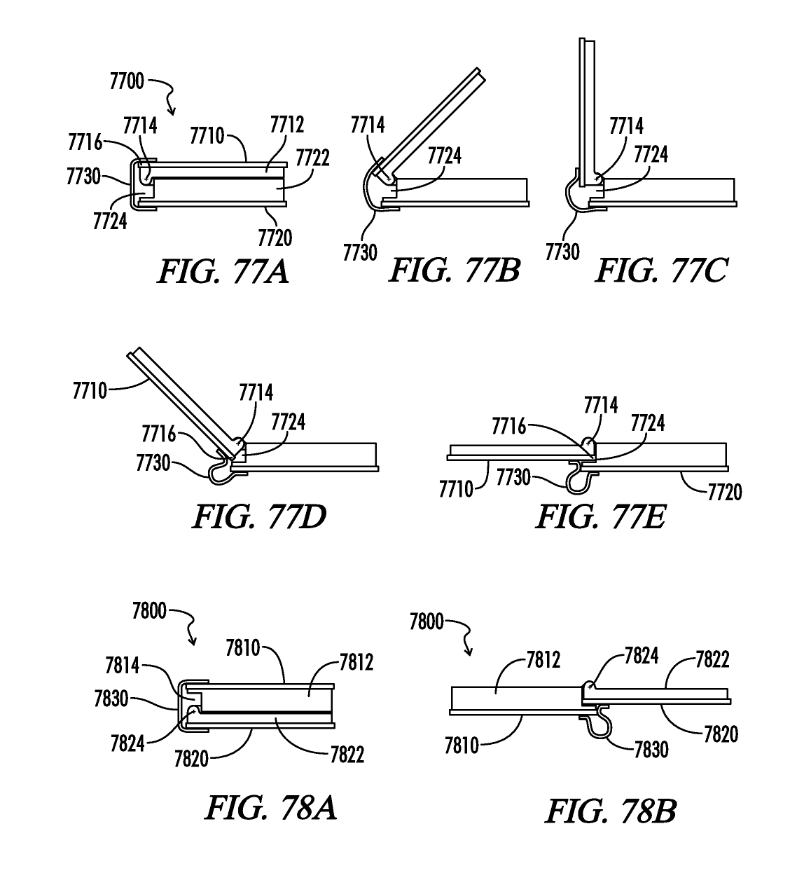

FIGS. 77A through 77E show one embodiment of a digital photo album/book/reader 7700 having a front cover 7710 attached to a front component 7712, a back cover 7720 attached to a back component 7722, and a binding 7730 attached to the front and back covers 7710, 7720. The front and back covers 7710, 7720 and binding 7730 can be leather or another other material. The front and back components 7712, 7722 can each comprise a display screen, a digital media storage area, or a combination of the same and be made of any type of material. For ease of explanation, the embodiment 7700 of FIGS. 77A through 77E will have the same structural components as shown in the album embodiment 7600 of FIG. 76, where the front component 7712 is a storage area or the second LCD screen, which can contain a transmitter board or any other way known now or developed in the future to communicate with the back component side and the back component 7722 is a display screen and processor. It will be appreciated that other combinations of components are possible. In the illustrated embodiment, front component 7712 has a rounded hinge feature 7714, while back component 7722 has a gap 7724, similar to the previously described hinge and gap of FIG. 76.

FIG. 77A shows the album 7700 in the fully closed position. Upon opening the album 7700 as shown in FIGS. 77B and 77C, the binding 7730 flexes to accommodate the relative position of the front and back covers 7710, 7720 and respective components 7712, 7722. Upon opening the album even further as shown in FIG. 77D, a portion 7716 of the front cover 7710 enters the gap 7724 in the back component 7722 until ultimately the front cover 7710 is seated within the gap 7724 of the back component 7722 as shown in FIG. 77E. This allows the front cover 7710 to be opened such that the front and back components 7712, 7722 assume a substantially horizontal orientation and can lay flat and can easily be viewed while sitting a user's lap, while the binding 7730 flexes out of the way of the engagement of the front and back covers 7710, 7720. The seating of the front cover 7710 within the gap 7724 also prevents a user from over-extending the front cover 7710 relative to the back cover 7720, and allows the front cover 7710 to come to rest in a flat orientation relative to the back cover 7720.

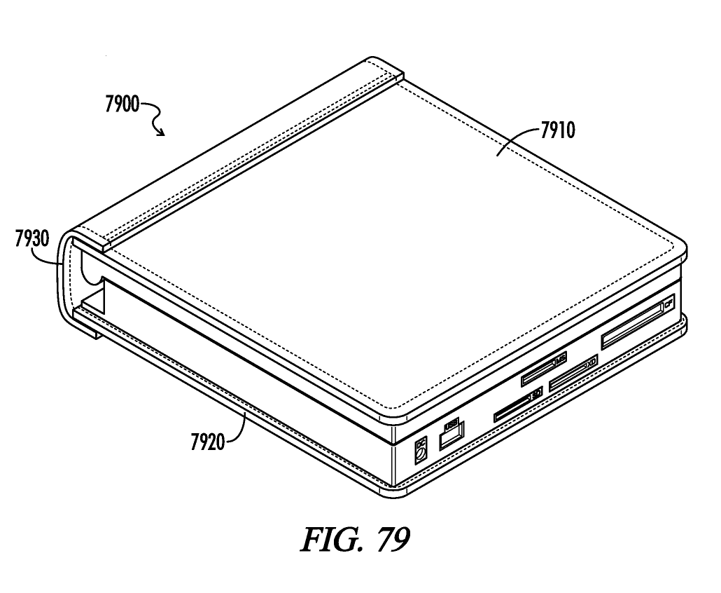

FIGS. 78A and 78B show one embodiment of a digital photo album/book/reader 7800 having a front cover 7810 attached to a front component 7812, a back cover 7820 attached to a back component 7822, and a binding 7830 attached to the front and back covers 7810, 7820. FIGS. 78A and 78B show a similar structure to that shown in FIGS. 77A through 77E, but where the front and back components are reversed. Namely, in the illustrated embodiment, front component 7812 has a gap 7814 while the back component 7822 has rounded hinge feature 7824, such that when the front component 7812 is opened relative to the back component 7822 and the binding 7830 flexes out of the way, the rounded hinge feature 7824 fits within the gap 7814 and allows the front and back components 7812, 7822 to lay flat. In the embodiments of 77A through 78B, the attachment of the binding 7730, 7830 to the covers away from the edges of the covers allows the edges of the covers to enter the respective gaps and remain seated within. If the binding were attached to the edges of the covers, then the binding would get in the way and prevent the horizontal alignment of the front and back components.

FIG. 79 shows one embodiment of a digital photo album, digital book or reader 7900 having a front cover 7910, a back cover 7920 and a binding 7930, where the front cover 7910 lacks a window or the like and described in earlier embodiments for holding a photo, LCD screen, art card or other memorabilia. In the illustrated embodiment, the album/book/reader 7900 could appear from the outside like a traditional book, having printed thereon, for example, the name of the book or title, author, publisher or the like (all not shown). The album/book/reader or cook book can be designed with slim design construction where the unit is slim as possible. This slim design construction can be any size or shape and can contain a memory card storage area or any kind of storage area or not.

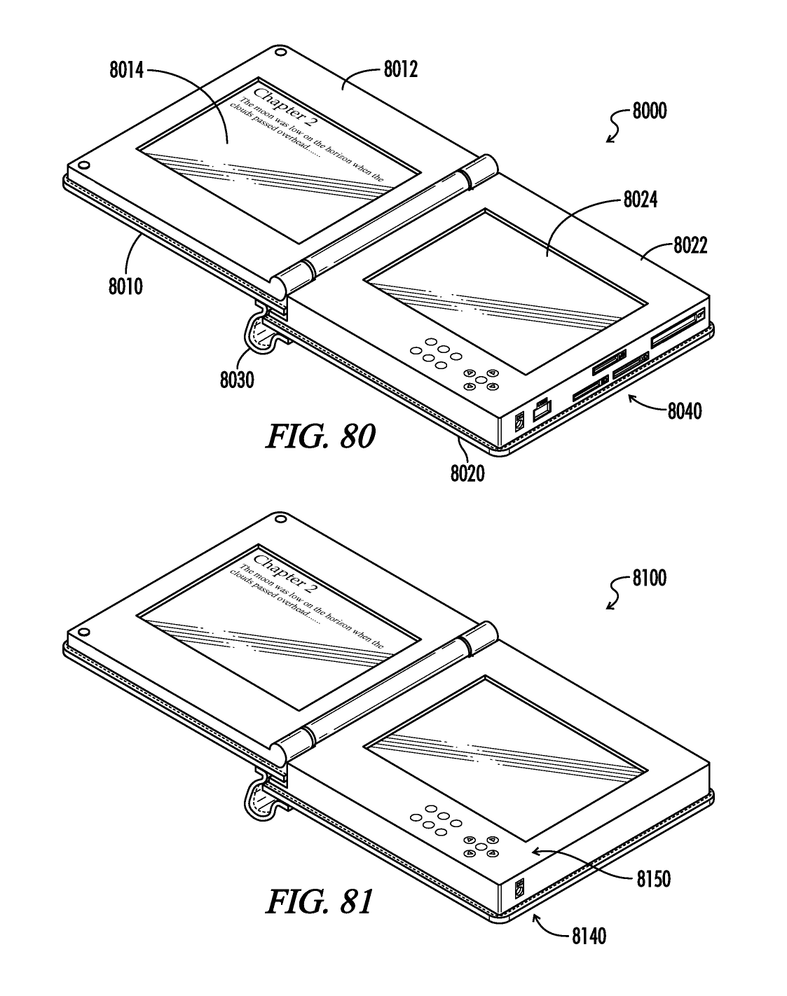

FIG. 80 shows one embodiment of a digital photo album/book/reader 8000 having a front cover 8010 attached to a front component 8012, a back cover 8020 attached to a back component 8022, and a binding 8030 attached to the front and back covers 8010, 8020. The front and back covers 8010, 8020 and binding 8030 can be leather or another material. In this embodiment, the front and back components 8012, 8022 further comprise LCD type screens 8014, 8024 respectively. Also shown are a series of ports 8040 on the side, which can be any type of port known now or developed in the future. The unit can also not have any ports and be totally wireless as shown, for example, in the embodiment 8100 of FIG. 81. While the embodiments of FIGS. 80 and 81 show dual screens, such screens can be any type or size known now or developed in the future. The screens can be used for viewing text, books, photos, music, and magazines, cook books, any kind of book, videos like home movies or regular movies, or the like. FIG. 81 shows a single port 8140 for power, although any number of ports can be employed as desired. In addition, an interface 8150 may be provided that includes touch key buttons, touch panel, touch border interface, buttons or any type known now or developed in the future.

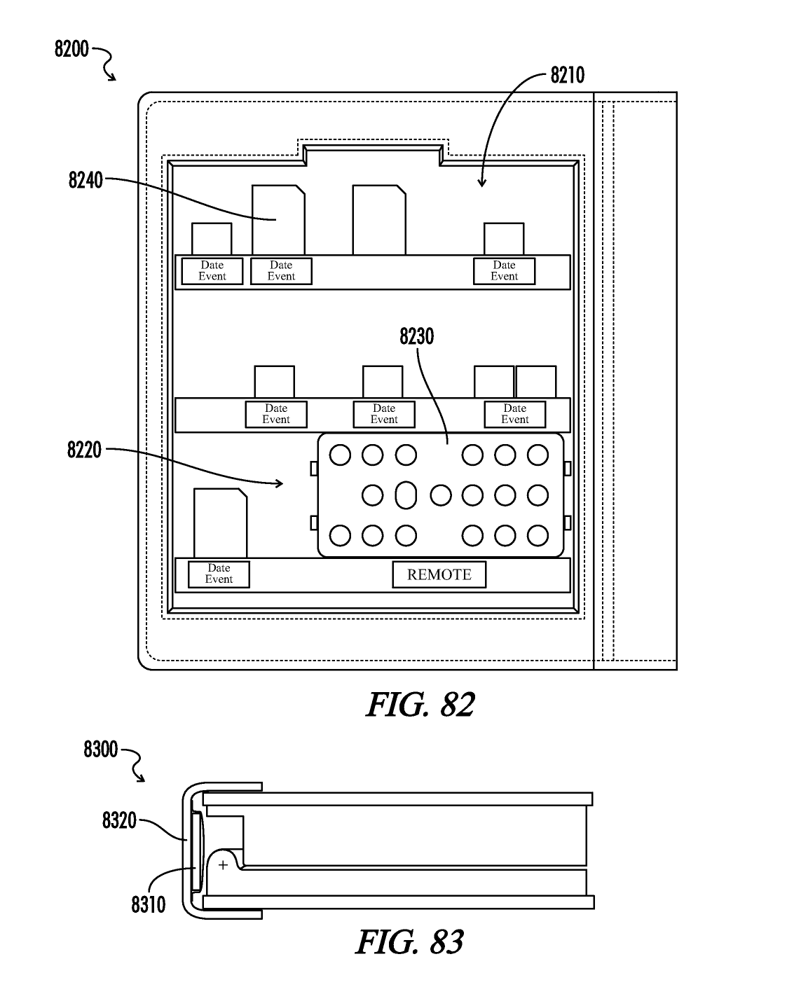

FIG. 82 shows one embodiment of a digital album/book/reader 8200 including a memory card and remote control storage area 8210. The storage area disclosed can be any described heretofore in this application or any known now or developed in the future. The storage area 8210 further comprises a remote control storage area 8220, which can accommodate a remote control 8230 for a digital album, electronic book or reader. The storage area 8220 can be located in any location in the storage area 8210 and can accommodate a remote control 8230 by a snap fit, hook and loop fasteners, form fit, or have a belt or strap (not shown) that comes over the 8220 area and secures the remote control 8230 in place. The remote 8230 can be secured to any part of the storage area 8210 known now or developed in the future. While the remote storage area 8220 is illustrated in FIG. 82 for storage of a remote control 8230, such area 8220 can be used for storing anything else that the user desires to put in this area 8220. Furthermore, the area 8210 can be an enclosed storage area for securing SD/XD/MMC/MS and USB flash drives or any media cards 8240 or any other media capturing devices known now or developed in the future. The storage area 8210 can also have memory card slots for storing memory cards or for connecting directly to the internal memory of the album 8200.

FIG. 83 shows one embodiment of a digital album/book/reader 8300 further comprising a remote control storage pouch or area 8310 in the bottom of the binding area 8320. The remote control storage area 8310 can also be located in the top or bottom of the binding area 8320 or anywhere for convenient access. This storage area can be sewn or otherwise attached or formed into the binding area 8320 and be made of any type of material, flexible or non flexible material. When a remote control is stored inside the pouch or area 8310, a flap (not shown) can secure the remote in place using hook and loop fasteners or other ways or a flexible material forming the pouch can hold the remote tight and secure.

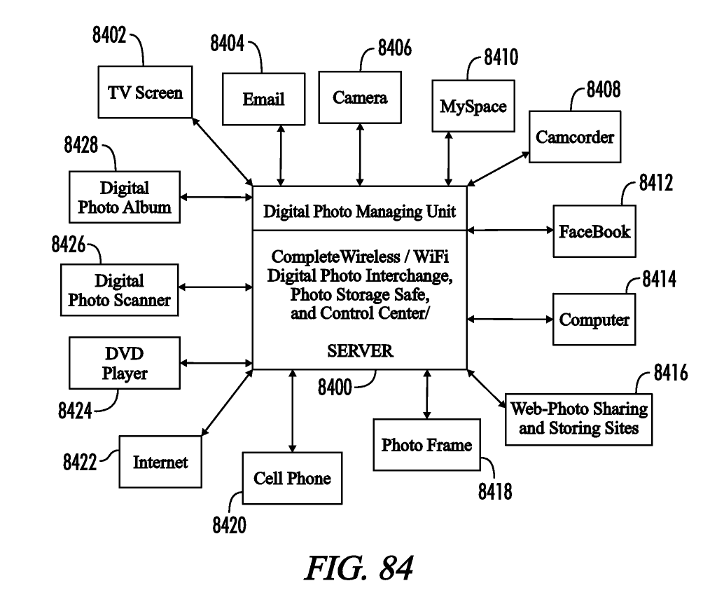

FIG. 84 shows one embodiment of a digital photo, book or media storage server or server/bank 8400. This server can be any size or shape and be located anywhere. The server can be any type known now or developed in the future. This server or bank is a place for everyone to store their photos, videos, movies, music, videos, etc. This device can also be wireless, Bluetooth, or any type of wireless system known now or developed in the future. This media device can be stored near a user's TV, computer or anywhere. For example, if a user wants to watch their favorite movie, the DVD or movie would be stored in the server 8400, and it can be accessed any time via remote and sent to a user's TV, computer, or any electronic device and a user can watch the movie and its always stored in a safe place and in one location. This can also be done with photos, music or any type of media, that is accessed anytime by using software that allows a user to view each type of media file and access it to identify it and access it, to view, send or retrieve any time, any place, or on any electronic device. While a user is on their cell phone, for example and the user wants a photo, video, music or movie to send to someone or they want to view, send or retrieve the same, they can access the server bank 8400 and access the software that allows the user to interface with the server bank 8400 and access the desired media. The server bank 8400 is capable of interfacing with a variety of devices including, but not limited to a television 8402, a user's email account 8404, a camera 8406 or camcorder 8408, a user's MySpace® 8410 or Facebook® 8412 account, a computer 8414, web-photo sharing and/or storing sites 8416, a photo frame 8418, a cell phone 8420, the Internet 8422, a DVD player 8424, a digital photo scanner 8426, a digital photo album 8428, or other devices now known or hereinafter developed.

One reason why the server bank 8400 of the present embodiment is needed is because movies, photos, music, and all types of media are scattered everywhere and in many type of electronic devices. It is very important to have a place where all your media can be accessed, viewed, stored, sent, and received all in one place. Because wireless is so prevalent, no wires are needed and it's more convenient and it very important to organize all your media. Consumers buy music and videos, and they have photos, home videos, etc., and there is no safe place to store, organize, and send and retrieve from a single location. All of a user's music can be accessed at any time and sent to any device and is stored in a safe place. The same goes for photos, videos, albums, home movies or any media known now or developed in the future. The server bank 8400 described herein can be a type of server known now or developed in the future. The bank organizer and server can have custom features, so the user can conveniently access any type of media any time or place and access it to view on their cell phone computer, laptop, as for everything can be sent wirelessly as well. It can have memory cards as memory or built in memory or any known today or developed in the future that can never lose the data, and there can be a hard drive or some other type of memory. It can have a router and have access to the interne and send and received movies, music, home videos and photos. The software can be any type of design that can search, back-up, name or delete files, store, file, organize, send, and retrieve and any other means known now or developed in the future.

The server bank 8400 can preferably employ user friendly software that can be divided into different categories, like photos, albums, movies, home videos, music, etc. The user can access the server bank and then chose a category they are looking for and then select an album, for example, open it up and send the album to a digital photo album and start viewing, or select a photo out of the album and send it to their cell phone or someone else's cell phone or anywhere. The user can be on any electronic device and access their personal server bank and select music, look for a song and send it to their iPod or anywhere else as desired. If the user is looking for a special photo, they would access their personal bank server; look in the category Photos or Albums, My Pictures, or other to find the photo to view and send. If the user wanted to save a photo or album, they can send and save it in the category of their choice. If the consumer wanted to view a home video or movie on their TV, they can access the bank server by remote control and send it to the TV or DVD player or wireless media receiver and send it to the TV for viewing. A DVD player or bank server box or player can be incorporated into the present embodiment to send and receive, access the bank server the movies of the user's choice. For example, if the user grabbed their remote for this special DVD player or a server, or a bank server player, and clicked on movies, it would show up on the TV screen, then comedy, drama, action, kids, and others would show up and the user then can scroll down and choose the movie, select, and play. The user can repeat the process etc. If the user wanted to download a new movie, it would be sent directly to their server or bank server. The software can have features like music, which can be divided in categories like country, rock, pop, oldies, etc. The albums and photos can be divided in categories, like family, friends, sports, vacation, wedding anniversary, or anyone they want. The user can create any category they choose.

In a preferred embodiment, all of a user's photos, albums, movies, home videos, music and other media could be stored and accessible at a user's fingertips, to send, receive, store in a safe location, organize all in one place and to access them at anytime. The server or server bank of the present disclosure would be desirable to a user because movies, music, etc., are mostly downloaded, and where are they stored, the devices they are stored on will not hold all these media or can have a chance of being lost or removed forever. With the server bank of the present invention, photos, albums, home videos, along with music and movies are preferably stored and organized in one safe location for viewing, sharing, sending and receiving at any time. A Facebook® or MySpace® page can have access to this information or an email account or any internet site of the user. An internet site like Facebook® or MySpace® can be created for this invention and the user can have their own page and access it to hold their personal information stored in the bank server 8400. The user can access their personal storage site page from the internet or any electronic device. The user can access and manage their account and their music, movies, home videos, photos, photo albums and any media known today or developed in the future. The internet site can charge a fee or be free. The internet site can have the software described herein to help the user store, organize and manage all their media. The user can access this site from cell phones, computers, laptops, TV any electronic device known today or developed in the future. The links to this site can be connected or work together with MySpace®, Facebook®, email accounts or any other known now or developed in the future. The bank or server 8400 can also be a server of the internet site and not a server that is resident in one location such as a user's home, office or anywhere. A TV can have a wireless connection that receives movies, home videos, photos, photo album, and music from the bank server 8400 that's located in the user's home or be a server of the internet site and to be played on their TV.

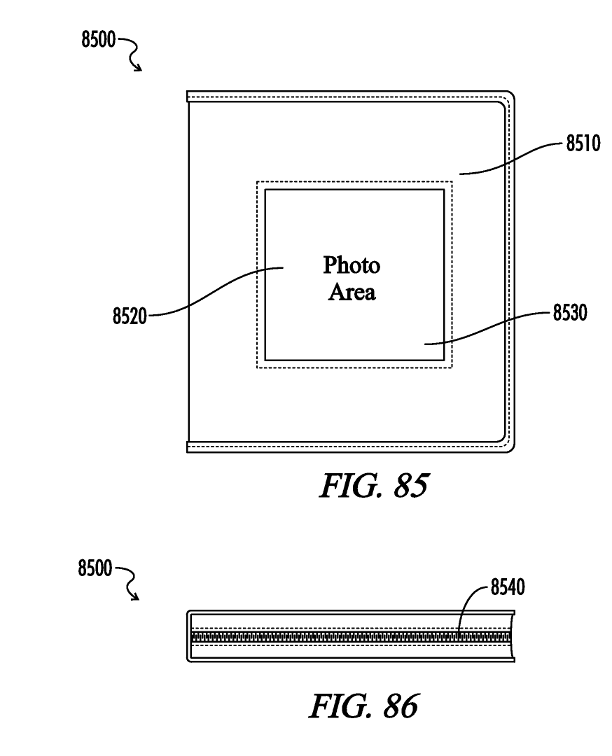

FIG. 85 is a front view and FIG. 86 is a side edge view of one embodiment of a digital media organizer 8500, similar to a typical CD wallet, that can contain a plurality of pages that can hold memory cards like CD/DVD/SD/XD/MMC/MS/CF/USB Flash Drives or any type of media or memory known now or developed in the future. The organizer 8500 can have any number of pages that are any shape or size, that are removable or permanent, with each page having at least one to any number of storage pouches for digital media. For example, it can have single CD-type pages or have double or any number of pages the size of CD pages. The digital media organizer 8500 can shaped like a album or book and can have a front cover 8510 including a picture area 8520 so that inside the front cover 8510 there would be a slot to slide a picture (not shown) that shows through the picture area 8520. A plastic cover 8530 could be provided over the picture area 8520 to cover and protect a picture contained within the picture area 8520. A picture can be secured within the picture area 8520 by a variety of means, including a hook and loop fastener flap or other means. The areas inside the front and back cover can also have additional storage areas for any type of memory cards or anything else the user would like to put inside the area. Such storage areas can have pouches or any type of storage area known now or developed in the future. The storage area on the front and back cover can any number have elastic pouches that hold any type of memory cards in securely in place. If the pages in the digital media organizer are removable, a two or three ringer binder can be used to hold the pages in the organizer 8500. A zipper 8540 (FIG. 86), for example, may be used to close the organizer 8500, and/or it can have a flap to secure the sides or any way known now or developed in the future.

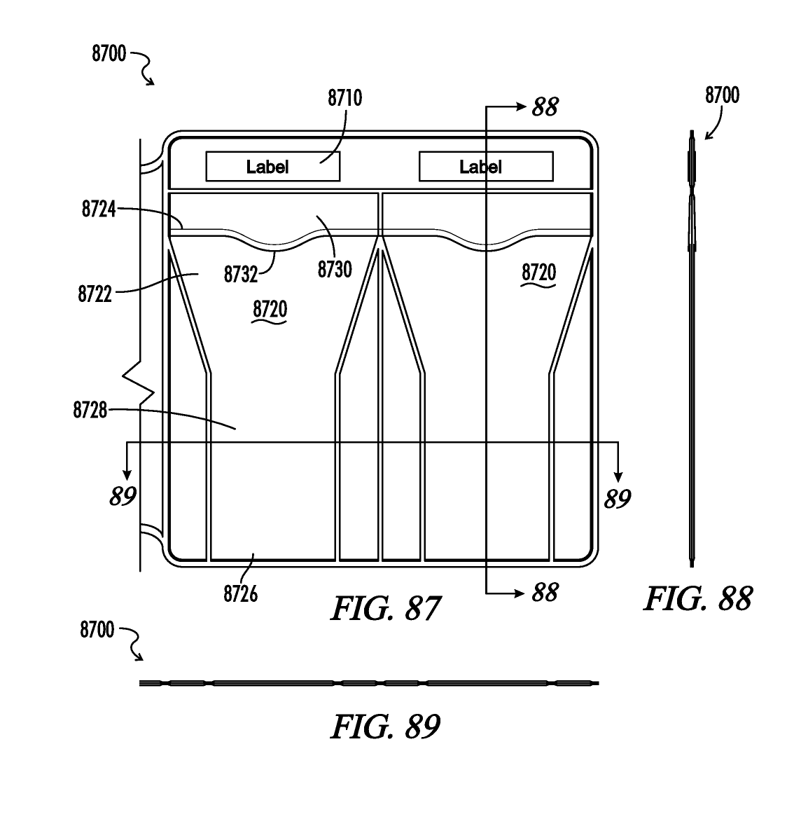

FIG. 87 is a front view of one embodiment of a digital media storage page 8700 for USB flash drives that can be used, for example, for SD/XD/MMC/MS media or any other media, with a place for identifying the media such as a label 8710 that can be located anywhere or any type to identify the contents in the pouch. FIG. 88 is a cross-section taken along line 88-88 of FIG. 87, while FIG. 89 is a cross-section taken along line 89-89 of FIG. 87. The page 8700 comprises a pair of Y-shaped pouches 8720 each having a top section 8722 that terminates in an opening 8724 and that is wider than the bottom section 8726. Overlapping the top section 8722 is a flap 8730 or the like that functions to cover the opening 8724 and prevent media stored within the pouch 8720 from falling out. The flap 8730 can have a round extended portion 8732 that sticks out further that the user can grab easily, or it may not have this feature. The body 8728 of the pouch 8720 is elongated to the bottom section 8726 to accommodate digital media that is elongate in design such as a USB flash drive. The storage page 8700 can be any size or shape and can be the size of a CD page or double, triple or any size. For example, if the pages where the size of CD pages, it might contain four pouches for USB Flash Drives, SD/XD/MMC/MS memory cards and the like, and the page would be divided into four sections and each section would have a Y-shaped pouch. The pouch 8720 is preferably made from a relatively thin, flexible material so that a user can push the memory card or other media device from the bottom upward to remove it from the pouch 8720. One reason the pouch 8720 is wider at the top 8722 and narrower at the bottom 8726 is that a memory card is usually not wide and if the pouch 8720 had a big bottom portion that was the size of the top portion, then the memory card would move around a lot and not stay secure within the pouch. But with the Y-shape design, the memory card will not move around as much. The top portion 8722 is wider than the bottom portion 8726 to make it easier to remove a memory card through the opening 8724. The pages 8700 can be made of plastic or other material and can have a fabric material, for example, in the back that helps hold the stored media in place. The pouches 8720 can be created by sewing or by heat sealing plastic or the like to create the pouches and the Y-shaped design. The pages 8700 can also have the same or different storage pouches on the back, so the pages can contain front and back pouches of various configurations to utilize double the storage. For example, if the front side of the page contained four sections for CD-type storage, then each page would contain eight storage pouches for CDs, four in the front and four in the back. The pages can also have a white plastic or PVC type material, or any other suitable material, located anywhere where the user could write on it to identify the contents of the pouch. The pages could also have name tab cards inserted in a pouch below the pouch above or the sides where the ring holes are that secure the pages to the digital media organizer, or it could be located anywhere. The user can also simply use a sticky label with writing on it to identify the contents of the pouch. The outside design, or the shape of the storage pouch can be any type known now or developed in the future.

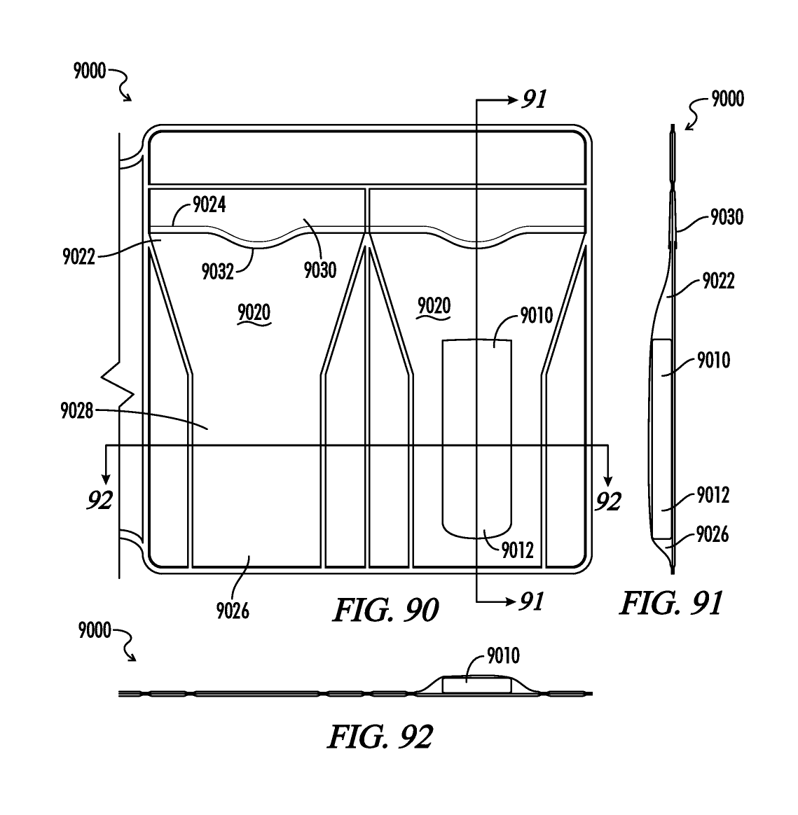

FIG. 90 is a front view of one embodiment of a digital media storage page 9000 for USB flash drives that can be used, for example, or for SD/XD/MMC/MS media or any other media. FIG. 91 is a cross-section taken along line 91-91 of FIG. 90, while FIG. 92 is a cross-section taken along line 92-92 of FIG. 90. The page 9000 comprises a pair of Y-shaped pouches 9020 each having a top section 9022 that terminates in an opening 9024 and that is wider than the bottom section 9026. Overlapping the top section 9022 and the opening 9024 is a flap 9030 or the like that functions to cover the opening 9024 and prevent media 9010 stored within the pouch 9020 from falling out. The flap 9030 can have a round extended portion 9032 that sticks out further that the user can grab easily, or it may not have this feature. The body 9028 of the pouch 9020 is elongated to the bottom section 9026 to accommodate a stick-like digital media 9010 that is elongate in design such as a USB flash drive. The pouch 9020 is preferably made from a relatively thin, flexible material so that a user can push the bottom 9012 of the memory card 9010 or other digital media device from the bottom upward to remove it from the pouch 9020. Inserting the media 9010 into the pouch 9020 is as simple as lifting the flap 9030 and sliding the media 9010 into the body 9028 of the pouch 9020 until the bottom 9012 of the media 9010 engages the bottom 9026 of the pouch 9020. The page 9000 can be made of plastic or other material and can have a fabric material, for example, in the back that helps hold the stored media 9010 in place.

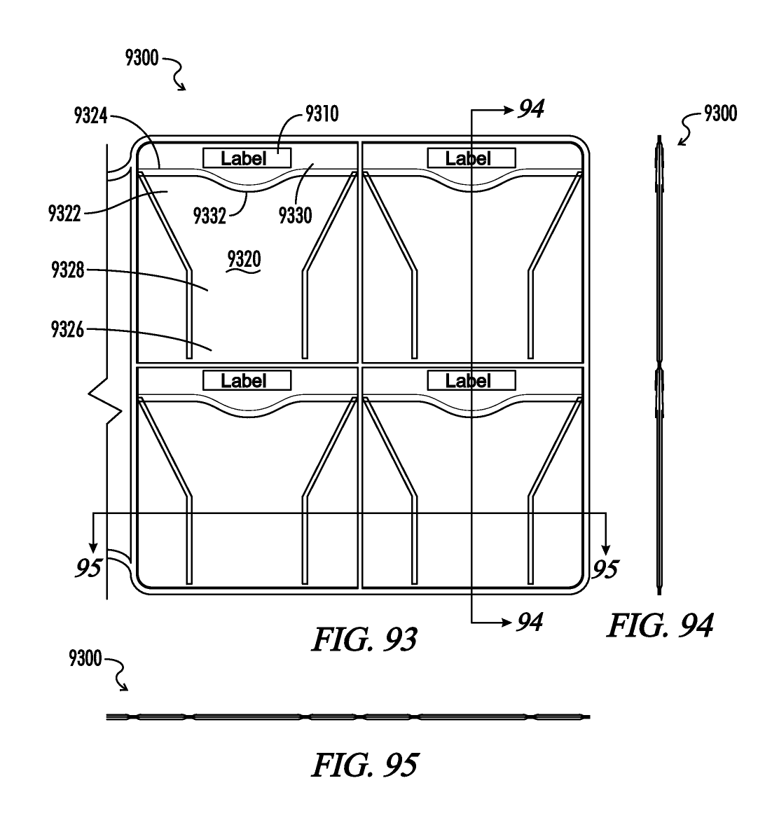

FIG. 93 is a front view of one embodiment of a digital media storage page 9300 for digital media such as SD/XD/MMC/MS memory cards or any other media, with a place for identifying the media such as a label 9310, which label 9310 can be located anywhere on the page 9300. FIG. 94 is a cross-section taken along line 94-94 of FIG. 93, while FIG. 95 is a cross-section taken along line 95-95 of FIG. 93. The page 9300 shown in the current embodiment comprises four Y-shaped pouches 9320 each having a top section 9322 that terminates in an opening 9324 and that is wider than the bottom section 9326. Overlapping the top section 9322 and the opening 9324 is a flap 9330 or the like that functions to cover the opening 9324 and prevent media (not shown) stored within the pouch 9320 from falling out. The flap 9330 can have a round extended portion 9332 that sticks out further that the user can grab easily, or it may not have this feature. The body 9328 of the pouch 9320 is slightly elongated to the bottom section 9326 to accommodate card-sized media that is not as long as stick-sized media such as USB flash drives. Thus, the body 9328 is not as elongated, for example, as the body 8728 of FIG. 87, or the body 9028 of FIG. 90. The pouch design can be designed custom for any type of media or memory card known now or developed in the future. The storage page 9300 can be any size or shape and can be the size of a CD page or double, triple or any size. For example, if the pages where the size of CD pages, it can contain 4 pouches for SD/XD/MMC/MS memory cards and they could be divided into 4 sections and each section can have a Y shaped pouch as shown where the bottom part 9326 is the width of these type memory cards and as it goes towards the top 9322 then it flares out to a Y-shape where the top section 9322 is wider than the bottom section 9326. The pages can be made of plastic and can be have a fabric type material in the back that help hold the media in place. The outside design, or the shape of the storage pouch can be any type known now or developed in the future, that still functions to secure a memory card in place, so it's convenient for the user to insert and withdraw a memory card from the pouch.

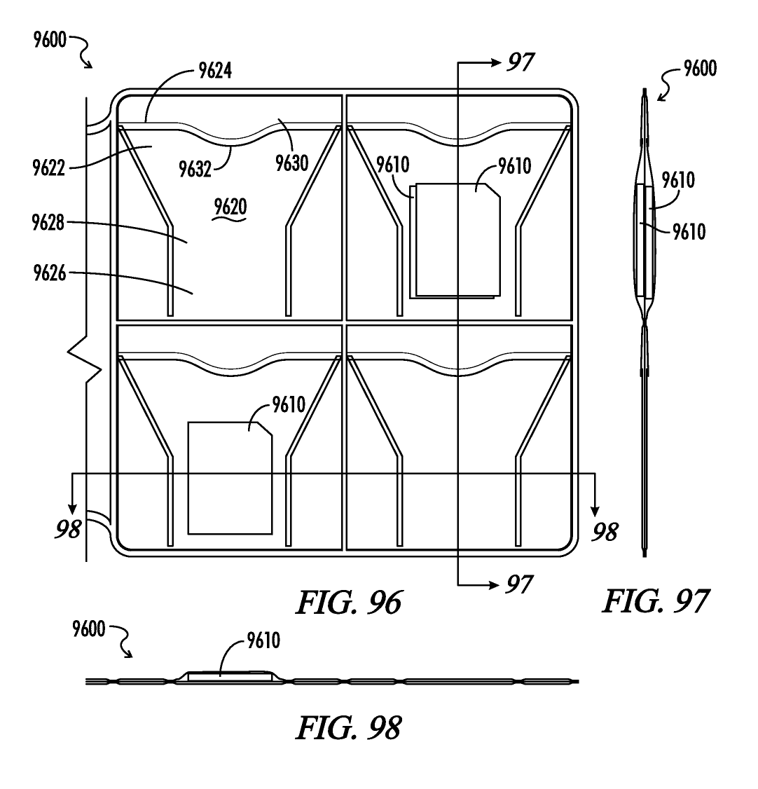

FIG. 96 is a front view of one embodiment of a digital media storage page 9600 for digital media 9610 such as SD/XD/MMC/MS memory cards or any other media. FIG. 97 is a cross-section taken along line 97-97 of FIG. 96, while FIG. 98 is a cross-section taken along line 98-98 of FIG. 96. The page 9600 shown in the current embodiment comprises four Y-shaped pouches 9620 on the front and back of the page 9600, each having a top section 9622 that terminates in an opening 9624 and that is wider than the bottom section 9626. In the embodiment shown, two digital media 9610 is shown in pouches 9620 on one side of the page 9600, while one digital media 9610 is shown in a pouch 9620 on the other side of the page. Overlapping the top section 9622 and the opening 9624 is a flap 9630 or the like that functions to cover the opening 9624 and prevent the media 9610 stored within the pouch 9620 from falling out. The flap 9630 can have a round extended portion 9632 that sticks out further that the user can grab easily, or it may not have this feature. The body 9628 of the pouch 9620 is slightly elongated to the bottom section 9626 to accommodate card-sized media 9610 that is not as long as stick-sized media such as USB flash drives. The pouch design can be designed custom for any type of media or memory card known now or developed in the future. The storage page 9600 can be any size or shape. The pages can be made of plastic and can be have a fabric type material in the back that help hold the media in place. The outside design, or the shape of the storage pouch can be any type known now or developed in the future, that still functions to secure a memory card in place, so it's convenient for the user to insert and withdraw a memory card from the pouch.

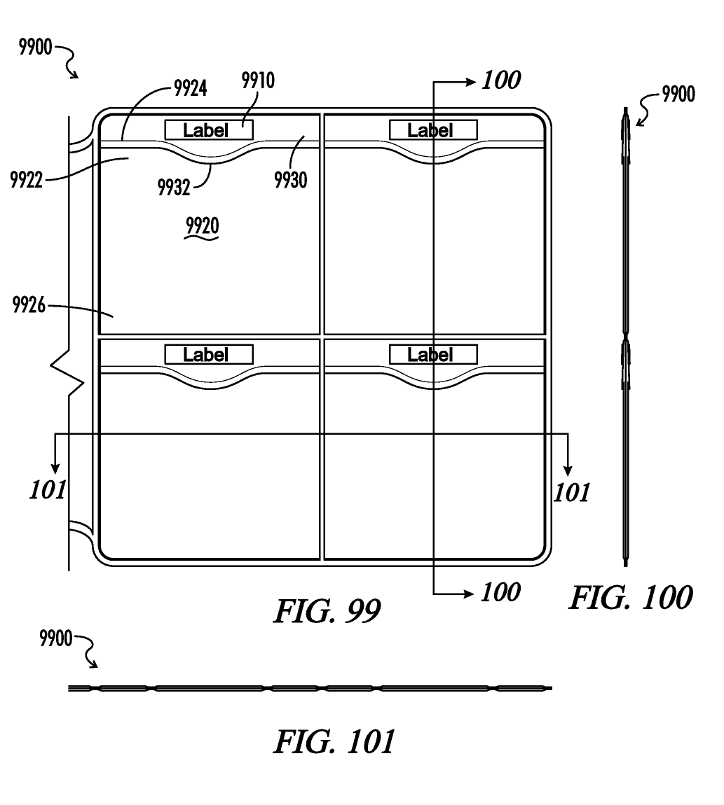

FIG. 99 is a front view of one embodiment of a digital media storage page 9900 for digital media such as CF memory cards, or SD/XD/MMC/MS memory cards or any other media, with a place for identifying the media such as a label 9910, which label 9910 can be located anywhere on the page 9900. FIG. 100 is a cross-section taken along line 100-100 of FIG. 99, while FIG. 101 is a cross-section taken along line 101-101 of FIG. 99. The page 9900 differs from previous page embodiments in the shape of the square-shaped pouches 9920, which shape is more suited for holding CF memory cards and the like, otherwise the page structure is generally comparable to previous embodiments. Each pouch 9920 has a top section 9922 that terminates in an opening 9924 and a bottom section 9926. Overlapping the top section 9922 and the opening 9924 is a flap 9930 or the like that functions to cover the opening 9924 and prevent media (not shown) stored within the pouch 9920 from falling out. The flap 9930 can have a round extended portion 9932 that sticks out further that the user can grab easily, or it may not have this feature. The pouch design can be designed custom for any type of media or memory card known now or developed in the future. The storage page 9900 can be any size or shape and can be the size of a CD page or double, triple or any size. For example, if the pages where the size of CD pages, it can contain 4 pouches for CF memory cards or other memory cards and they could be divided into 4 sections and each section can have a square-shaped pouch 9920 as shown. The pages can be made of plastic and can be have a fabric type material in the back that help hold the media in place. The outside design, or the shape of the storage pouch can be any type known now or developed in the future, that still functions to secure a memory card in place, so it's convenient for the user to insert and withdraw a memory card from the pouch.

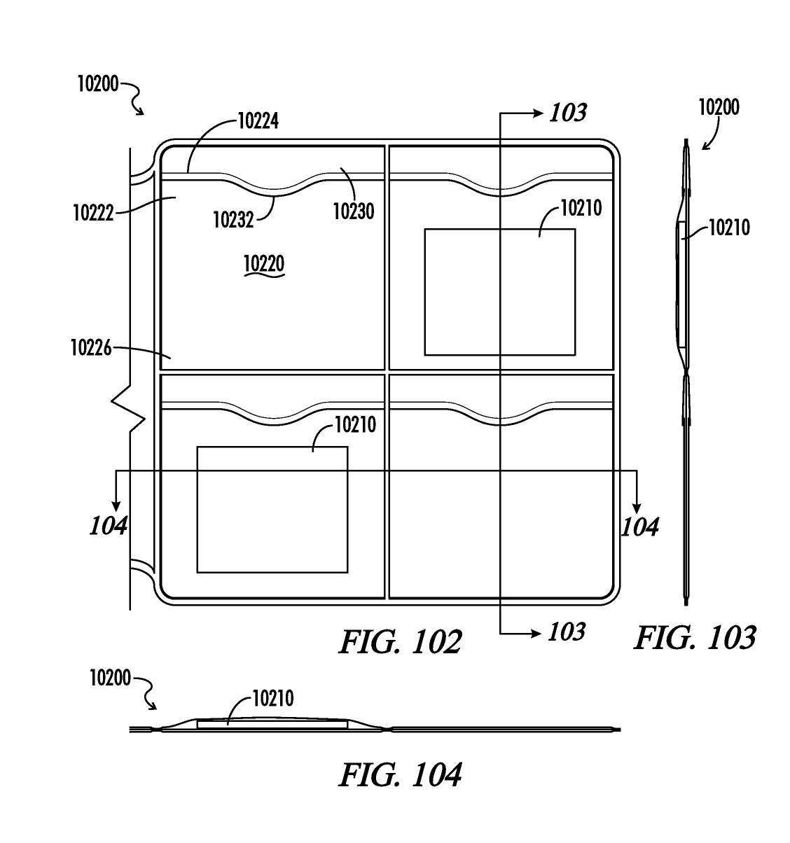

FIG. 102 is a front view of one embodiment of a digital media storage page 10200 for digital media 10210 such as CF memory cards or any other media. FIG. 103 is a cross-section taken along line 103-103 of FIG. 102, while FIG. 104 is a cross-section taken along line 104-104 of FIG. 102. The page 10200 shown in the current embodiment comprises four square-shaped pouches 10220 on the front and back of the page 10200, each having a top section 10222 that terminates in an opening 10224 and a bottom section 10226. In the embodiment shown, two digital media 10210 are shown in pouches 10220 on the page 10200. Overlapping the top section 10222 and the opening 10224 is a flap 10230 or the like that functions to cover the opening 10224 and prevent the media 10210 stored within the pouch 10220 from falling out. The flap 10230 can have a round extended portion 10232 that sticks out further that the user can grab easily, or it may not have this feature. The pouch design can be designed custom for any type of media or memory card known now or developed in the future. The storage page 10200 can be any size or shape. The pages can be made of plastic and can be have a fabric type material in the back that help hold the media in place. The outside design, or the shape of the storage pouch can be any type known now or developed in the future, that still functions to secure a memory card in place, so it's convenient for the user to insert and withdraw a memory card from the pouch.

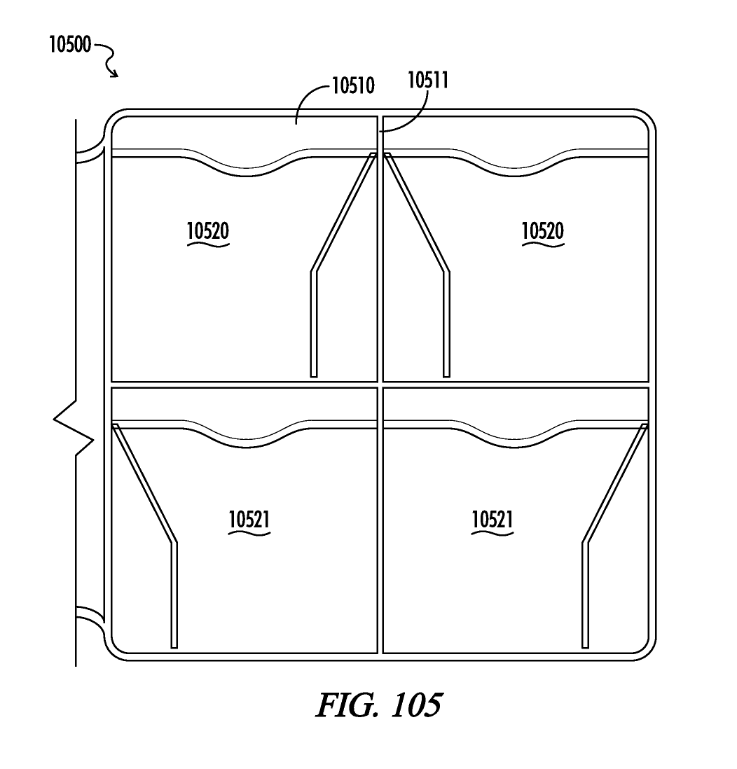

FIG. 105 is a front view of one embodiment of a digital media storage page 10500 for digital media such as CF memory cards, or SD/XD/MMC/MS memory cards or USB or any other media, with a place for identifying the media such as a blank space 10510, for example, which blank space 10510 can be located anywhere on the page 10500. Page 10500 further comprises two pouches 10520 having a first shape on the top of the page 10500, and two pouches 10521 having a second shape on the bottom of the page 10500, where the first and second shapes are reversed relative to the center line 10511 of the page 10500. The page 10500 differs from previous page embodiments in the shape of the pouches, otherwise the page structure is generally comparable to previous embodiments, where each pouch has an opening covered by a flap and is adapted to accommodate digital media therein. The pouch design can be designed custom for any type of media or memory card known now or developed in the future. The storage page 10500 can be any size or shape or design and can be the size of a CD page or double, triple or any size. The pages can be made of plastic and can be have a fabric type material in the back that help hold the media in place. The outside design, or the shape of the storage pouch can be any type known now or developed in the future, that still functions to secure a memory card in place, so it's convenient for the user to insert and withdraw a memory card from the pouch.

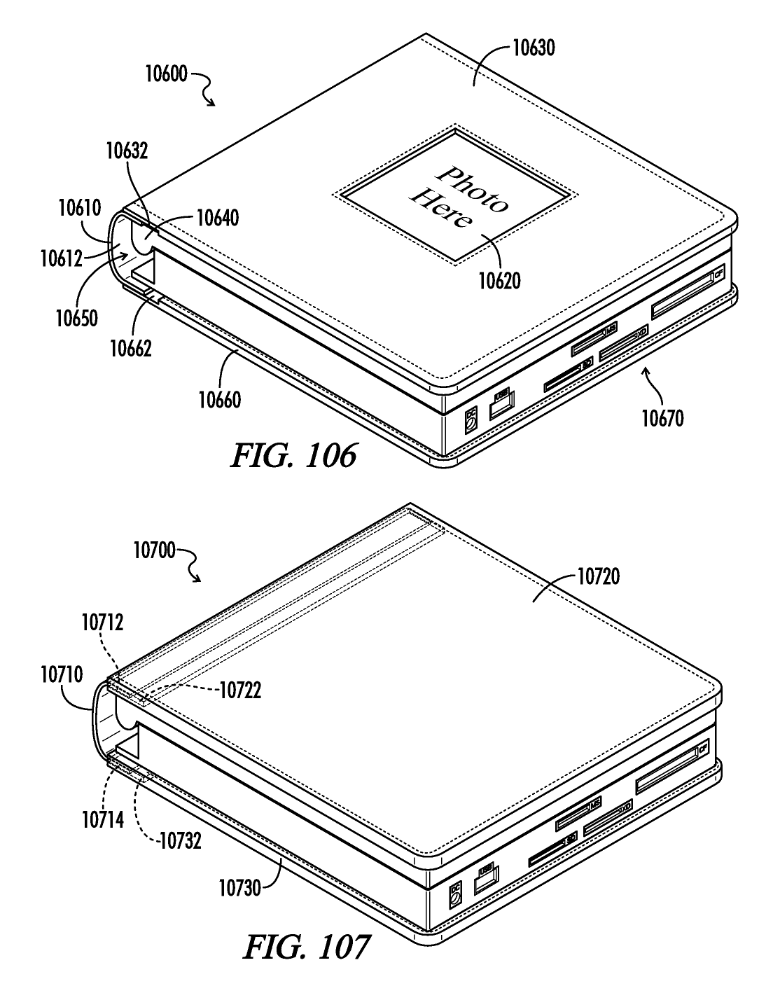

FIG. 106 shows one embodiment of a digital photo album, e-book, or digital book 10600 (hereinafter collectively referred to, in a non-limiting manner solely for purposes of convenience, as a “DPA”) in the closed position with a scrapbook type binding 10610 and a window 10620 on the front cover 10630. The window 10620 can be digital, LED or non-electronic and simply consist of a physical feature or place to contain a photo or title. The DPA 10600 can also have storage area or no storage area for digital media or other items as described herein, and the sides can look like pages or be smooth and can have any design that looks like a book or the like. This embodiment shows a binding area similar to a scrapbook, which binding material can be stiff, flexible, or any type of binding material. A portion of the hinge structure 10640 and front cover 10630 goes inside the gap section 10650 as described above when the DPA is opened, it being understood that the hinge configuration can be reoriented or positioned other than as shown in FIG. 106 and as generally described herein. A portion of the binding 10610 is also able to go inside the gap section 10650. In this embodiment, the binding 10610 is preferably attached to an inside section or surface 10632, 10662 of the front cover 10630 and back cover 10660 respectively, instead of on the outside as shown, for example, in FIG. 75, which is generally indicative of how scrapbook bindings are attached. This type binding 10610 can have a pocket or any type of enclosure 10612 where the ends or a portion of the binding is inside, on top, or any location. In the drawing it shows the pocket section 10612 open on the end or bottom view and top (not shown). This area 10612 can be opened or enclosed or any way known now or developed in the future. The binding 10610 can be flexible, stiff or made of any type of material, and can in and out of this pocket or enclosure 10612, or slide back and forth as the DPA is opened and closed. As the DPA is opened and closed the binding 10610 needs to be flexible because it needs to move during opening and closing. The binding 10610 can be attached anywhere or located anywhere besides the outside surface of the DPA. The DPA covers 10630, 10660 can be permanent or not and can be replaceable as desired, so the user can make it a cook book to an e-book or from a baby album to a wedding album, or a photo album, or any type of book, album etc. These changeable covers can be designed any way known now or developed in the future so that the covers can come off easy and install easily, where the term covers is described in a non-limiting fashion and can include digital or non-digital device covers. The shape of the hinge 10610 can be rounded, square or any shape that is known now or developed in the future. The port openings or interfaces 10670 can be located anywhere or be any size and shape and be any known now or developed in the future. As noted herein, the DPA can be an e-book or electronic book and can incorporate any technology known now or developed in the future.

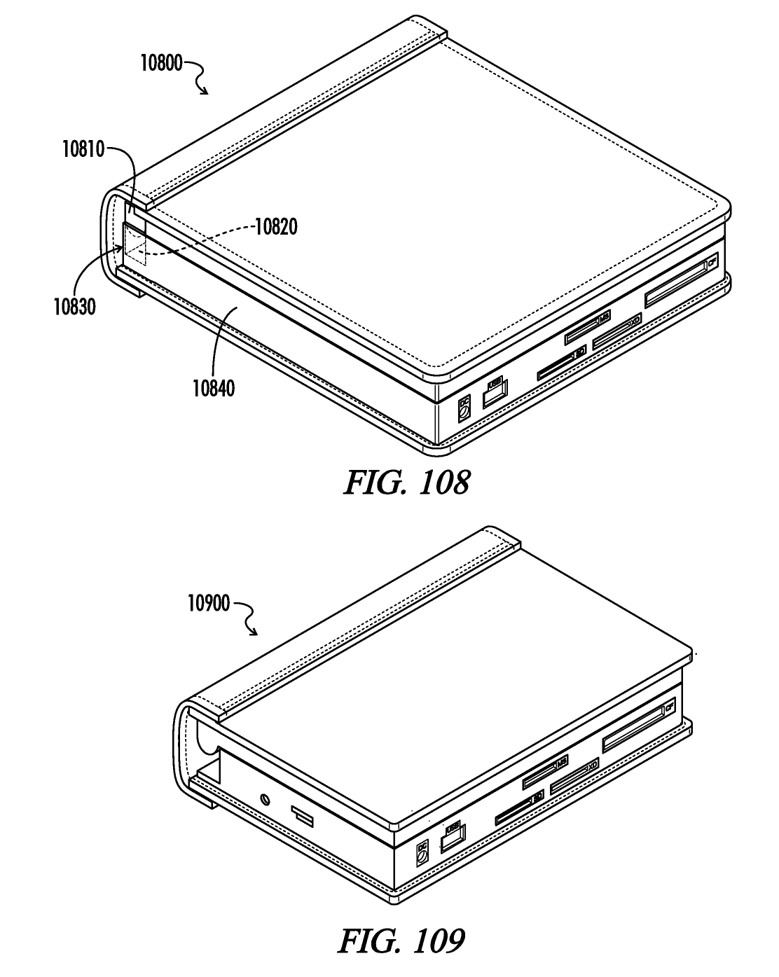

FIG. 107 shows one embodiment of a DPA 10700 in the closed position with a scrapbook type binding 10710 defined between a front cover 10720 and a back cover 10730, where portions 10712, 10714 of the binding 10710 extend into and are secured within pockets 10722, 10732 on the front and back covers 10720, 10730 respectively. The binding portions 10712, 10714 can move within the pockets 10722, 10732 as the DPA 10700 is opened and closed, and the free ends of the binding portions can have stops (not shown) that prevent the binding portions from becoming completely extracted from the pockets. Other means of preventing the binding 10710 from separating from the covers 10720, 10730 are contemplated. As the DPA 10700 is opened and closed, the binding 10710 needs to be flexible because the binding needs to move and the binding will get smaller or bigger when opening and closing especially when the binding is not attached on the outside of the covers as shown, for example, in FIG. 79 herein. The binding 10710 can also be attached anywhere or located anywhere besides that as shown in FIG. 107, for example. The pockets 10722, 10732 can be any design or shape and function any way known now or developed in the future, so the DPA 10700 can open and close properly. As discussed herein, the DPA 10700 can have media storage and/or be designed to have the appearance of book pages from the side or not.

FIG. 108 shows one embodiment of a DPA 10800 similar in configuration to that shown in FIG. 79, having a hinge 10810 and a hinge opening area 10820 that is partially hidden by a wall extension 10830 of an aspect 10840 of the DPA 10800. A portion of the hinge 10810 and front cover 10850 extend into the opening 10820 when the DPA 10800 is opened, but such portion is now hidden from view by the wall extension 10830. This way the hinge opening area or gap 10820 is not present from the top and bottom view when the DPA 10800 is closed. Alternative ways of hiding the gap area 10820 are also contemplated. A portion of the cover and hinge at the top and bottom section can also be inset or smaller from top to bottom. The hinge section and cover section being smaller than the rest can allow these sections to be able to go behind the wall extension 10830. In one embodiment, the DPA 10800 can be opened only partial way and the hinge area can have no gap section in the hinge area and when the hinge opens up the hinge portions on each side will touch each other and then it will allow the structure not to open all the way. Other structural configurations that allow for partial or complete opening of the DPA are contemplated. As also discussed herein, the DPA 10800 can have media storage and/or be designed to have the appearance of book pages from the side or not.

FIG. 109 shows one embodiment of a single screen DPA, e-book or digital book 10900 in a closed position. The shape can be any shape know now or developed in the future and can be any size or thickness. It can have a leather cover that is permanent or not, it can have storage areas or not, as described herein. It can have replaceable batteries, any number of ports and control features known today or developed in the future. The sides of the book 10900 can look like pages or be smooth and can have any design that looks like a book. It can include any other functional or aesthetic feature or aspect mentioned herein.

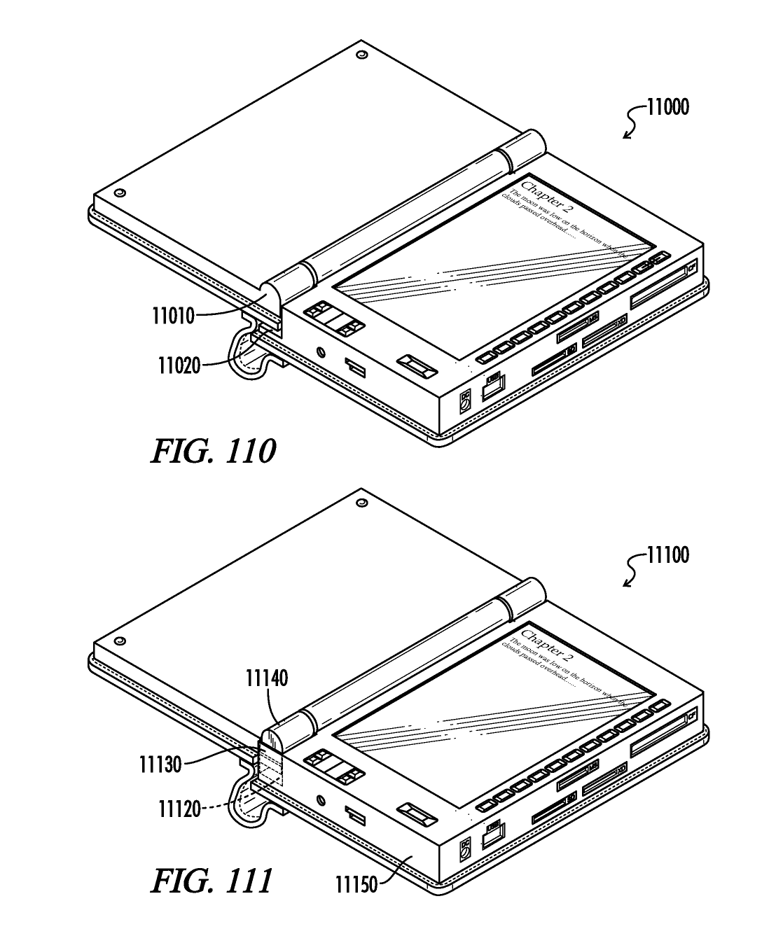

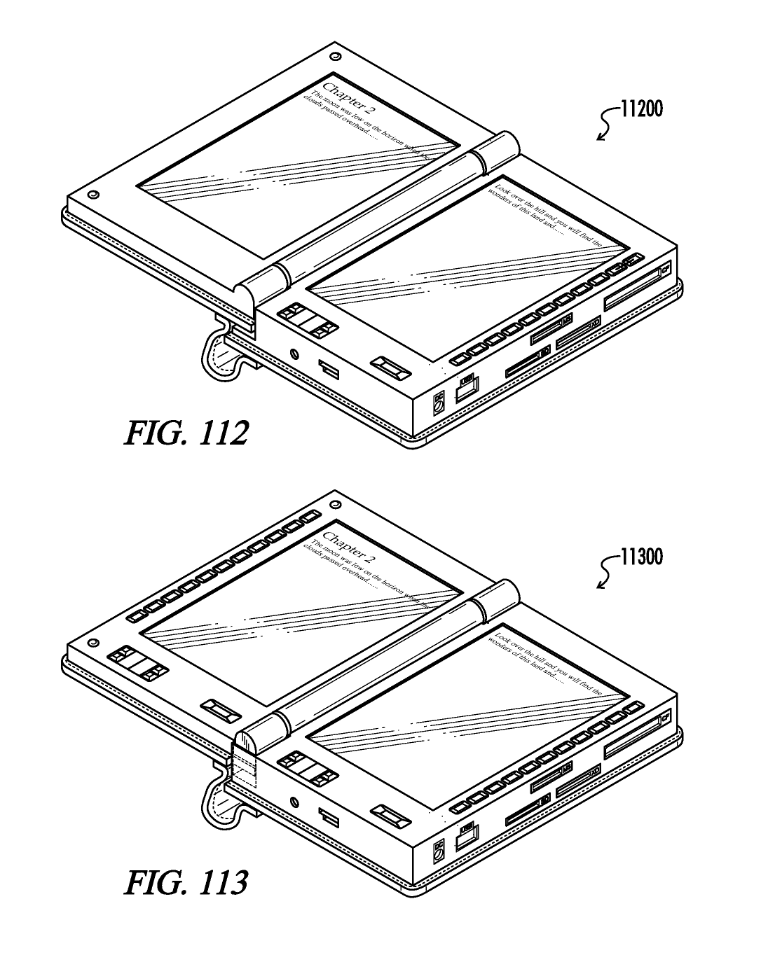

FIG. 110 shows one embodiment of an alternative design of a single screen DPA, e-book or digital book design 11000 having a hinge 11010 and gap area 11020 that is visible, while FIG. 111 shows a DPA, e-book or digital book embodiment 11100 having a gap area 11120 that is partially hidden by a plug, cap, cover or wall extension 11130 as described, for example, in FIG. 108 herein. The gap area 11120 and related hinge 11140 is preferably inset to allow for the wall extension 11130 to maintain a flush configuration with the housing 11150 and cover the gap area 11120. FIGS. 112 and 113 show dual-screen DPA and e book embodiments 11200 and 11300 respectively having similar features to those described in connection with FIGS. 110 and 111. The DPA described herein can be used to read books, magazines, any kind reading material, graphics, videos, home videos, online demonstration videos, sales presentations, store books, make notes, access books thru the internet, access web sites, create and organize libraries, receive and send books and magazines, and the like. It can be used by kids and have educational and reading software to help kids read. It can be provided with a microphone and speakers and can have voice recognition and also read back to the user and teach them to read or do any help with any kind of problems in any subject. It can be used as a personal journal, and have a plethora of other uses as well.

Math, reading, social studies, foreign language or any type of learning aid, educational tool, or a universal book to do it all. A user can access all books from libraries, from encyclopedia sites, magazines companies, newspapers from all over the world, any news articles worldwide. A user can retrieve and send any kind of item that is being sent by email or the internet currently or that will be sent in the future. A user can send text and/or image files, graphic files, movies, emails, music files, etc. The DPA can have internet capacity or not. The DPA can have “app” or application capability similar to “apps” currently operable on the iPhone, iPod and other smartphone devices and advanced communication devices, and the DPA can receive and play “apps” similar to the manner in which an iPhone obtains “apps” through the iTunes store. The DPA can have features, functions and special software that can save where a user left of reading and come to the exact spot where the user left off and it can have special software to take the user to the spot of interest. Software can be integrated into the DPA to tell the user how many pages or chapters are read in a minute, hour, day, week etc. It can have software to help a user to speed read and it can highlight key words for the user to read faster and comprehend more. The user can make notes or can highlight your favorite spots or important points to refresh the user's memory about articles or books for easy references, organize all your favorites books, magazine, newspaper articles, send and retrieve a user's favorite storage sites, personal hard drives, internal or external, or hard drive and storage areas. The hinge shown can be any shape or design, and the side gap near the hinge can be any size or shape or have no gap. The DPA can have any type of e ink technology known now or developed in the future or any type of screen known now or developed in the future. The buttons or other control features can be located anywhere on the DPA, and can be any number of buttons of controls, being any size or shape and can have any type of function. The DPA can have custom designed book marks can create on the e-book or on computers or other places.

The DPA can have a single screen (see FIGS. 110 and 111, for example) or a dual screen (see FIGS. 112 and 113, for example) or be any size or shape. The sides can look like pages or be smooth and can have any design that looks like a book. There can be a built-in light feature that is permanent or is a separate accessory. The light can be stiff or flexible to where the user can move it into a variety of locations and positions. The light can be built-in like a light box. A variety of ports or interfaces can be any type known now or developed in the future. Buttons can be located anywhere on the left or right side or screen or on both. The dual screen version (FIGS. 112 and 113, for example) can have one or more than one PCBA board, CPU, Battery, software, transmitting board, solution, or hardware. It can have any type of software known now or developed in the future. The DPA embodiments can be like computer books that are provided with mouse pads built-in or connect to the unit. The digital album cover, e-book cover, or electronic book cover can be designed to look like, or be constructed like a paperback book, kid's book or any kind of book. The cover can be made of any material and glued to the e-book, album, or electronic book. The outside cover can be constructed of type of material known. The hinge or shape of the hinge or structure can be designed, or altered, so the DPA can open up and the unit will be flush or even and the unit can lay flat on a surface. Both sides can be flush with each other or raised one higher than the other. The housing on each side can have male or female sections that can mate with each other to allow both sides to close and open properly. The surfaces on both sides can have shallow areas or be flush or be any shape or design.

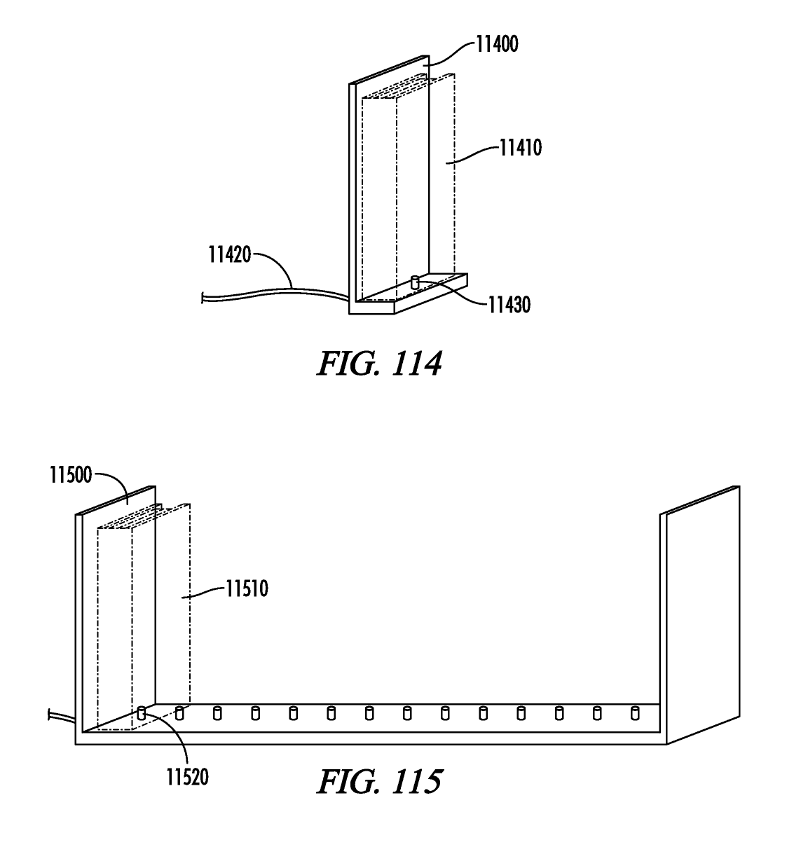

FIG. 114 shows one embodiment of a single DPA charging port, charging station or communication port 11400 with a generic DPA 11410 shown in dotted lines for purposes of illustration, the DPA 11410 being any DPA mentioned herein or later developed. The port or station 11400 can have a variety of features if desired including, but not limited to, a router, Wi-Fi, calendar clock, light, music station, telephone or any other feature known now or developed in the future for music port charging station or digital media included in this port station. A user can also charge any cell phone and have any port to charge any type of electronic device. If a DPA has a rechargeable battery or any kind of battery, the DPA can be portable or be used by plugging an AC adapter or other charging device known now or developed in the future. The charging port or station 11400 can have special software to interact with the DPA unit so it can monitor the charging and help discharge power or increase power and help to keep battery to have long life and last a long time. Any battery technology, any battery life technology or power source technology known now or developed in the future can be used. The station or port 11400 can be designed to look like a book holder that holds books in place on a shelf. The design can have any shape, design size, color, and material known now or developed in the future. It can have a power cord 11420 that is removable or permanent or can be connected to a server, hard drive, storage area, computer, external hard drive or any electronic device known now or developed in the future. The units can send or receive information to the CPU or servers or computers, websites, networks and other. All the memory can be stored in a storage area hard drive, built-in memory or any known or developed in the future. All memory can be stored on the shelf, station or storage area or be connected to any type of storage area for files or memory storage. The unit can have its own PCBA board, computer board, central processing unit, built-in memory, memory card for memory, or other memory known now or developed in the future. Through an interface 11430, information can be communicated between the DPA 11410 and another device (memory, processor, network, another DPA, or the like). The stations or ports 11400 can charge and send and receive information files, pictures or anything mentioned herein. The units stored and charging can send information, pictures to computers, and information to TVs, documents to TVs, or any type of information to any electronic device. The interface connection 11430 can have any shape or design for mating together and holding the DPA 11410 in place.

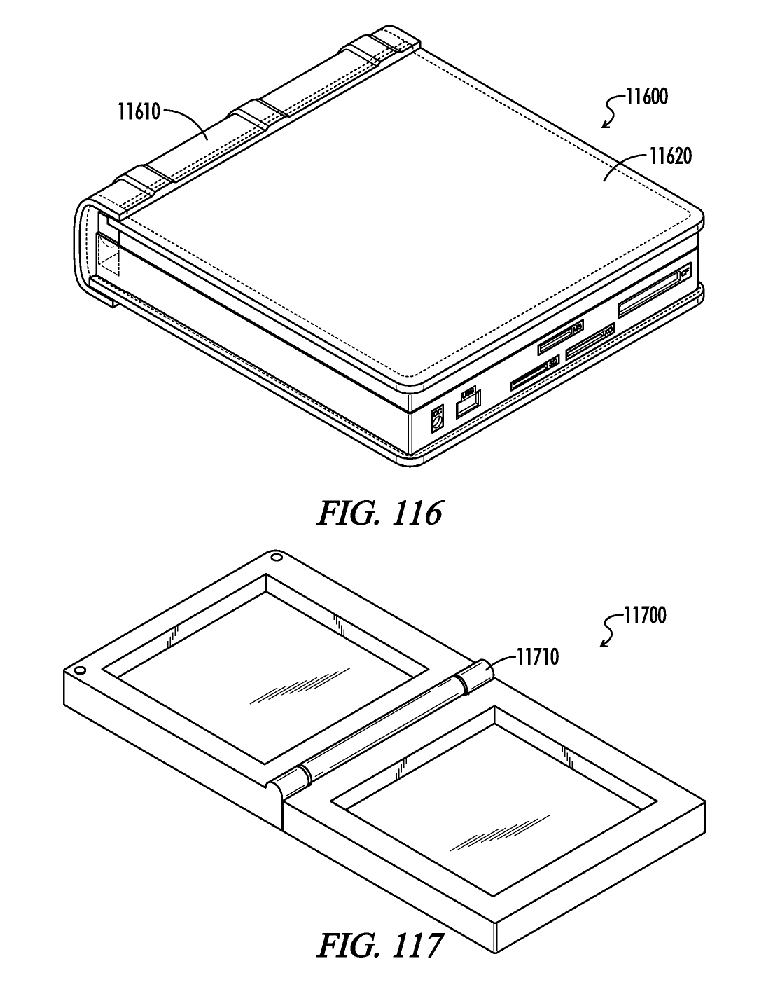

FIG. 115 shows one embodiment of a shelf-type port or station 11500 that can accommodate a plurality of DPA devices 11510. Each interface 11520 can allow for independent communication between a single DPA and another device in communication with the station 11500. The book shelf port or station 11500 can have a router and server attached, to update books and files attached thereto. The station, port, router and or server can be permanent or not permanent and can be any type known now or developed in the future. The shelf, station or port can be any size shape, any type of material, wood, plastic steel or other known now or developed in the future. The shelf, storage station or port can have a built-in computer, hard drive, memory, software or any type of electronic device that can be used for storing digital media. Websites, hard drives external or built-in to the unit, routers and computers built-in or not can send new books, new titles, update information, update magazine articles, newspaper articles and other known now or developed in the future. The units can send information to the CPU or servers or computers, networks, websites and other. All the memory can be stored in a storage area hard drive, built-in memory or any known or developed in the future. All memory can be stored on the shelf station 11500 or storage area or be connected to any type of storage area for file or memory storage. The unit can have its own PCBA board, computer board, central processing unit, built-in memory, memory card for memory, or other memory known now or developed in the future. One or any number of e- books, digital book, and/or digital photo albums can be placed on these shelf units 11500.

FIG. 116 shows one embodiment of a DPA 11600 with a special binding 11610 representative of an older style books. It can be any book design that has been done in the past future or present, it can be any color any shape raised or not, it can be any material used to raise any part of the binding. The cover 11620 can be of any type of material used to create the cover 11620 or binding 11610 known now or developed in the future. The material of the cover 11620 can have layers of one to many layers of materials. The cover 11620 can have embroidery, rhinestones, embroidery designs, names, pictures, graphics, printed copy or graphics, scrapbook designs, name windows, ribbons, bows, sport memorabilia, any type of hobby item for album and scrap books that are sold in a craft or hobby store, and the like. It can have wedding articles, baby items, graduation items, Valentine's Day items, Easter items, St. Patrick's Day items, Mother's Day items, Father's Day items, Fourth of July items, Halloween items, Thanksgiving items, Christmas items, and the like. Any kind of holiday or any items of any kind can be applied to the cover, binding or unit. The cover can be made of fabric, paper, camouflage, crocodile, any material, fur, any kind of fabric or pattern developed now or developed in the future or any type of material. Marketing videos, graphics, charts, music, copy can be playing in any of the units while open or closed to help sell or market the unit in stores, or for demonstrating the user's products etc. The cover 11620 or binding 11610 can be stamped designs for logos, for creative designs.

FIG. 117 shows one embodiment of a housing 11700 incorporating an alternative hinge 11710 and structure design for a DPA or non electronic structure for use with games, portfolios, board games, or any type of purpose known today or developed in the future. No screens, ports, covers, bindings, storage areas, windows, touch keys, buttons, etc. are shown. However, any feature or function previously described can be incorporated into the housing 11700. This hinge 11710 can be used, for example, for board games, non-electronic and electronic games, for playing and storage of game pieces or the like, and for communication between the halves of the housing 11700 if desired. FIG. 117 shows no cover, but one can be included, and can have a binding or not, the gap section can be like shown or altered, so both sides of the unit 11700 can have the same thickness and the hinge 11710 can be lowered if desired, where the hinge 11710 or shape of the hinge or structure can be designed, or altered, so the housing 11700 can open up and the unit will be flush or even and the unit can lay flat on a surface. Both sides can be flush with each other or raised one higher than the other. The housing 11700 on each side can have male or female sections that can mate with each other to allow both sides to close and open properly. The surfaces on both sides can have shallow areas or be flush or be any shape or design. FIG. 117 can also be a unit that digital photo frames, or LCD screens, any screen, or E-books or any type of electronics, or digital electronics or digital imaging can be placed inside and once connected to the unit then it can be used for that function. It can have male or female ports that allow the units to connect together and act as one unit. The unit shown in FIG. 117 can have sections that are open to allow for ports or other type operating functions to be accessible that are already on the unit, so when its connected the ports.

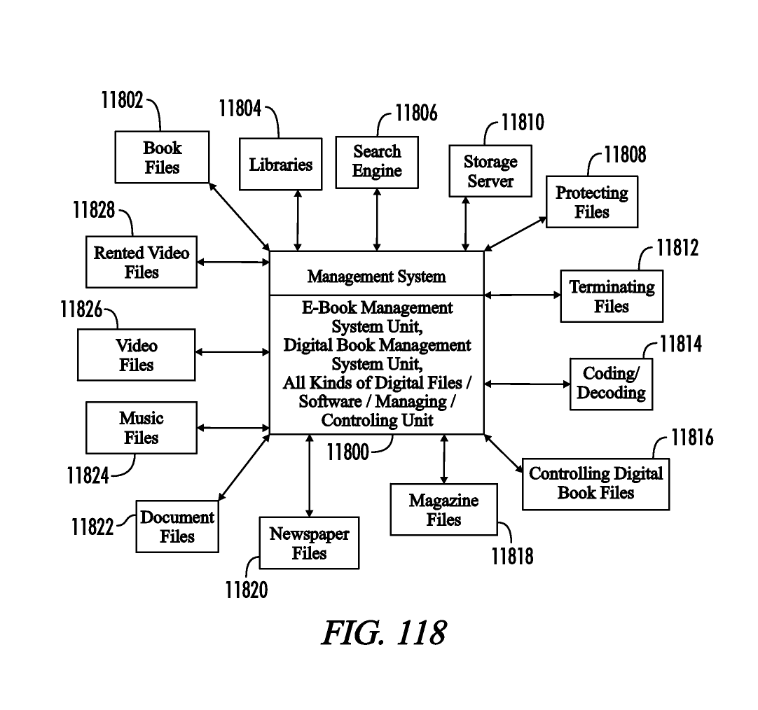

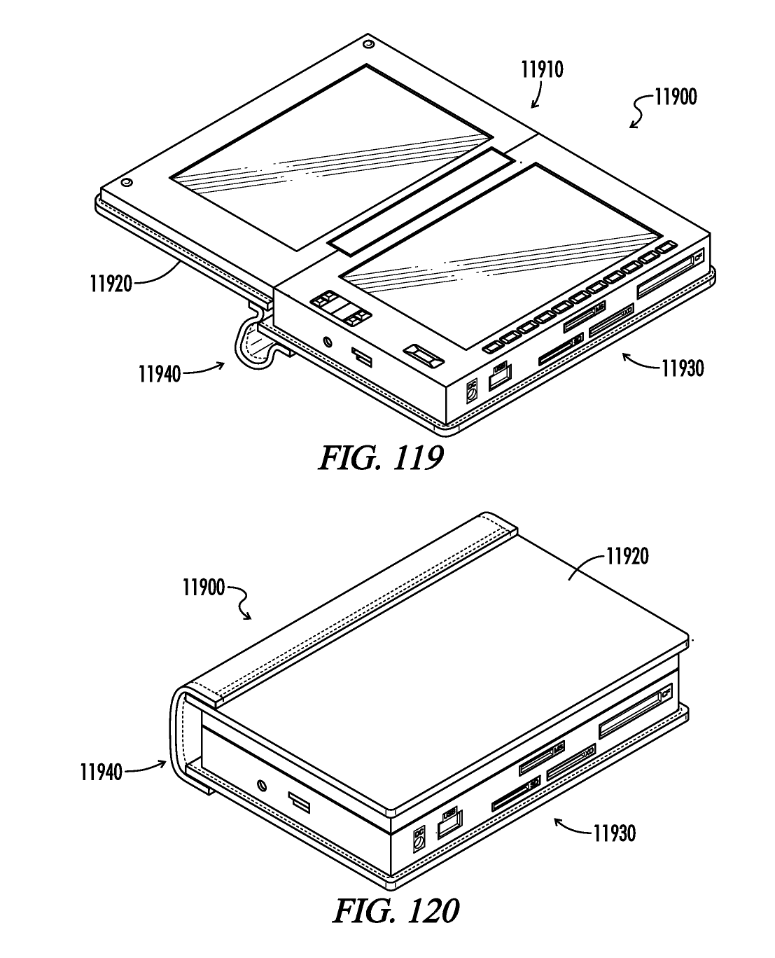

FIG. 118 shows one embodiment of a management system 11800 capable of interfacing with a variety of devices, systems, media, files, and information including, but not limited to book files 11802, libraries 11804, a search engine system or feature 11806, a storage or storage service 11810, a file protection function or feature 11808, a file termination function or feature 11812, a coding/decoding function or feature 11814, controlling digital book files 11816, magazine files 11818, newspaper files 11820, document files 11822, music files 11824, video files 11826, rented video files 11828, or other devices, systems, media, files, etc., now known or hereinafter developed. All books in libraries, music, videos, newspapers, articles, newly published books, magazines, etc. can be accessed from a user's home to a user's DPA, iPod®, iPhone®, etc. or anywhere a user listens, watches or uses these type of files etc. A user can check out library books from all over the world or magazine subscriptions from all over the world, newspapers from all over the world, any type of article or newly published book can be accessed from a DPA. The user's DPA will have special software and features to be able to access this thru the web, interne or other way known now or developed in the future. The user can have the option to purchase the files, books, music, videos, articles, newspapers and other files or rent the information for a certain length of time, and there can be different prices for each option. The management system 11800 can be implemented by user systems or by third party systems contracted by the user. In the present embodiment, the management system 11800 also includes, but is not limited to, a search engine, storage server, and management, licensing management, music licensing and management to send and retrieve and manage everything described herein. From anywhere in the world a user can send and retrieve the files described herein similar to the computer or laptop but it will now be in a DPA format or related or unrelated product. In the music industry it's a problem for people downloading and using music without paying for it. Aspects of this invention and server, search engine, management system, and terminating files for music may be particularly suited for the music industry and video industry. For example, every music file can have a code that is sent wireless, cable, or other that can terminate files, through a window that can be accessed only through the person, or company that sent it. The process can be the same that wireless interne is accomplished and wireless monitoring devices can monitor, block and prevent sending unauthorized items or files. Every listening device, every video watching device, every electronic device can have this feature built-in, so no person can send, copy or download information, music, videos, or anything without permission or without first paying. Once entering the window the file can be terminated. Any music or video that can be downloaded can have password or keys attached to all digital files for books, music, videos, or any described herein or other. Once the digital files have password activation, serial number, or product key is inserted a user can download to one place and one time, if they pay for more downloads then they can access it again. The downloaded software or files, music, or videos will not let a user send to friends or download without permission. If all files, music, videos, books and software had these features attached, then it will be hard for people to send to friends, family and download it for free. The user will not be able to send copy or download without special designed codes that the user cannot break and decode.

FIG. 119 shows one embodiment of an E-Book, digital book, digital photo album or digital book (again, collectively referred to as “DPA”) 11900 in an open position with a middle section 11910 where the assembly is located. FIG. 120 shows the DPA 11900 in the closed position. The DPA 11900 can have any type of hinge known now or developed in the future. It can have a binding sewn or attached to the cover 11920 or not, or it can have a permanent or removable cover. It can have a window or LCD screen on the cover 11920 or not. It can have ports 11930 or not. It can have built-in memory or not. It can have any type of software known now or developed in the future. In the embodiment of FIG. 119, there is no gap near the hinge 11940 from the side position like other drawings shown in this application. The middle section 11910 shows another way to connect two sides of a DPA with a middle hinge The hinge assembly 11940 can be any type of hinge assembly known know or developed in the future, can be any shape or design, and can be located at the top and bottom of the unit, the sides or any location. This overall structure design can be any shape or size; the corners can be rounded or square. The sides can be smooth or have lines like pages. The hinge can have wires or have electronics going thru it or not, or it can have buttons, controls, lights, speakers, or any type of function disclosed herein. The DPA 11900 can have any type of screen or ink screen or any type know now or developed in the future. The hinge can have compartments inside for the hinge assembly. The hinge 11940 can have a hinge structure or hinge assembly or hinge pin that is part of the hinge or a separate piece. Part of the structure or unit that connects to the hinge on the right or left side can have a hinge structure or hinge assembly or hinge pin that is part of the structure or a separate piece.

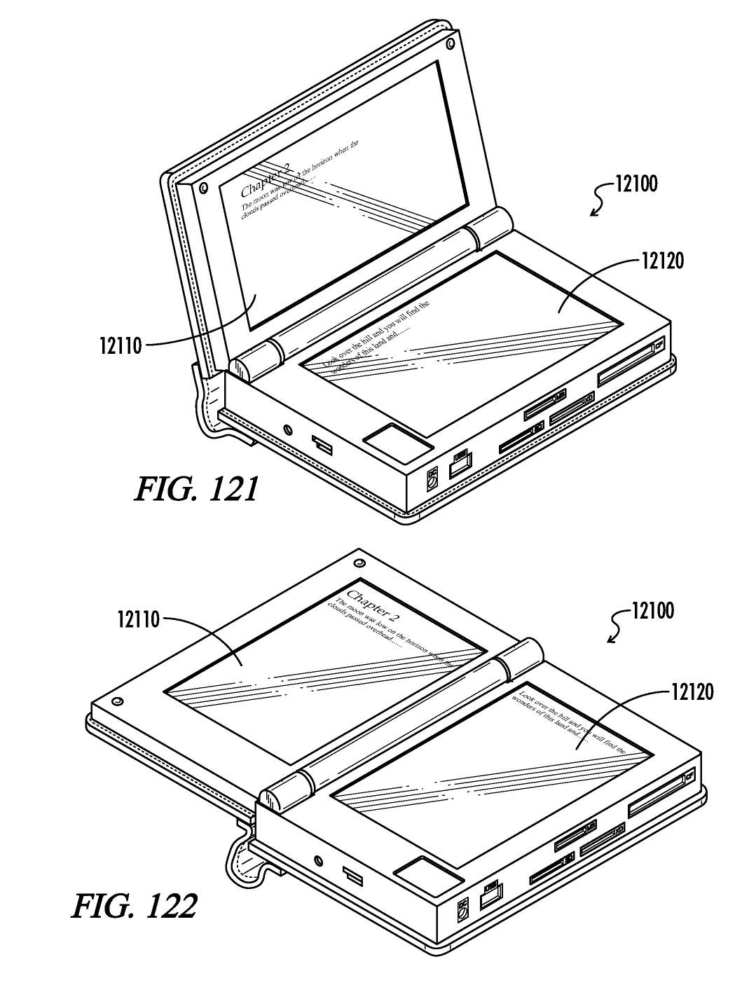

FIG. 121 shows one embodiment of a DPA 12100 in a landscape, or horizontal position. This unit 12100 can have one screen like a laptop or two screens 12110 and 12120 as shown. FIG. 121 shows the DPA 12100 in a laptop position, and if the user turns it around it can be used as book, electronic book, and electronic reader, for example. It gives a laptop a different look and use. Most laptops look like an electronic device and feels like one. The DPA 12100 can help change the looks of a laptop by offering covers that are more personal than what laptop makers offer. The cover 12110 can have permanent or removable covers that are leather book covers or any type of material. It makes the laptop top and bottom surface have a leather feel than a metal feel and can help the bottom of the surface of the laptop not scratch surfaces. The cover can cover all or part of the unit. The back cover or any part of the front and back of the cover can have vent holes or areas without the cover to allow the heat of the unit 12100 to dissipate. The unit 12100 can still look like a laptop or feel like one except there would be two screens or it can have one. If an ordinary laptop screen is at the top and the keyboard at the bottom, the user can still turn it clockwise and hold it like a book and the software and screen, menu, all components of the laptop, etc, will recognize the new position and function like a laptop or like a book. For example, if the user was tired of using the laptop and keeping it on a table or flat surface and the user had a lot of documents to read, the user can turn the unit clockwise so the screen is to the right, and the DPA 12100 will recognize the new vertical position and then the menu, software, and all functions can be switched to a vertical position. The user can start to read the documents like reading a book in both hands on a sofa or anywhere. It gives the user a versatile laptop that can be changed at different angles and still be used. A keyboard (not shown) can be positioned in key areas where the user can still use it/them in any position, and it can swivel and move to a new position or any position or place on the unit 12100. This DPA 12100 gives a user a laptop that can be held like a book or used like a laptop. The curser and keypad or keyboard (not shown) can be touch screen, or be like a normal keypad and curser, or the curser and key pad can pivoted, turned or rotated to any desired position of the user or for that position. The key pad numbers, letters and symbols on the laptop can be lit with a light showing on the top of the keys, just like a laptop or keyboard is now, and then the when the user changes positions the keys could change and so would the newly lighted keys with new symbols. When the unit 12100 is turned one way the keys would be lighted one way and then when turned to the new position then the keys would be changed to new keys. Some keys can remain the same or some keys can change. The type of keys or controls or any type of control type will depend on what kind of keys or controls are needed for that position. In the reading position or vertical position only certain keys or controls might be needed and might be closer to the left side fingers or there can be keys or controls near the right fingers that are holding the unit. The areas where the user holds the unit in a reading position, the hand and fingers positions are important to the user, so it's comfortable for them. The keys, buttons or controls need to be in positions that people can easily and comfortably touch the keys or button or control the unit. For purposes of discussion, use of the terms “keys” or key pad, keyboard, etc., can be any type of control method or buttons known now or developed in the future. The buttons keys or controls can be located anywhere and can be flush with the unit, raised separate or together and be located anywhere. When the unit is turned, the special position activated software will activate all functions, software features, controls of the unit to that new position. The DPA can have a screen that adjusts positions as well. This can be done manually or automatically and the surrounding sides around the unit can adjust manually or automatically. Any visible surface or part of the unit can change positions automatically or manually and can be done by the software or done manually as the orientation of the unit changes. The screen can change to an E-ink type screen when turned to the vertical position or reading position. When turning and switching user positions of the DPA, there could be a delay or there can be no delay before it changes position modes. If a user was wanting to read a document and it was in a horizontal position and when the user grabbed the DPA and switched positions and sat on the sofa and held it in the vertical or reading position, there could be no change in the software or document, it can stay the same place except the position of the unit 12100 would change and the screen would adjust the text to fit that screen position. There can be many ways of doing this known now or developed in the future. The screen types can be any type of screen that is good for reading and good for the eyes. It can be any type of screen know now or developed in the future.

FIG. 122 shows DPA 12100 of FIG. 121 in the vertical or portrait position. It shows two screens 12110 and 12120 but can have only one screen as well and the screens can have different viewing ratios. The screens can be any size or shape. The software and screen position and use can be like described in FIG. 121, for example. A user can watch videos on one screen and text on the other, and vice versa, for example. Special software can have the first page on the left screen 12110 and second page on the right screen 12120 and then the pages switch, then the third page on the left and fourth page on the right, and so on. It can be like we described photos being changed in this application or previous applications. A keyboard (not shown) can appear on any surface, or it can be slid out from under the unit 12100 and be oriented at any angle relative to the unit 12100. The keyboard can be wired or wireless and can have a curser or mouse attached or not. The keyboard can be flat or raised and have buttons or keys, controls on it and can be made of any material and can have sensors and wires that connect with the DPA 12100 or wireless sensors that interact with the DPA. The keyboard could be made of plastic for example and have semi raised surfaces that act as keys and the sensors are inside and interact with the DPA and other devices. This allows the keypad to be at a flatter surface and to be more comfortable for the user and prevent carpal tunnel syndrome and the like, and makes it portable so the user can place it any where. This type of keypad can be used with any electronic device. The keys, controls or buttons can be any type shape or size. The portable unit can be any size or shape and it can also be attached as well to the DPA 12100 or another unit. FIG. 121 and FIG. 122 show one embodiment of a versatile DPA 12100 that allows the user to use it at different angles, different viewing and using positions, which allows the unit to be more versatile and have more added features and uses, compared to using a laptop at the same position and orientation. The DPA can be used as a computer, digital photo album, digital book, yellow pages, white pages, reading book, library book, school book, law book, genealogy book, encyclopedia, magazine, newspaper, kids book, and many more. The user can type like they normally would to work on it, play etc. and then rotate it and read it like a book. The unit can also be used without AC adapter or with one. The unit can have touch key controls, touch screen, remote, key pad, curser or any other way known now or developed in the future. This unit can have built-in memory or memory mentioned in this application. This unit can be backed up by servers and other ways of saving data and information mentioned herein or developed in the future. It can have a battery that can be replaceable or permanent and there can be battery storage compartment that can be removed and replaced through a battery compartment located though the back cover, side or any location. The battery and removable feature can be any known or developed in the future. The unit can have a curser that can be used in the landscape/horizontal position and then by turning it to the portrait/vertical position the curser can be used the same way. The software in the unit can recognize the change of position and switch the curser to be used in the new switched position. When the unit is turned back to the other position it will revert back to the curser/position relationship. This can happen with a menu, wherein when the unit is in a landscape/horizontal position, it can have a laptop/computer menu and or software in use and when the user rotates the unit it can automatically switch to a reading/book menu and software and be used at that position. The computer/software menu can stay the same when switched from the horizontal to vertical position except that the menu/software will adjust positions as the user turns the unit. It can happen with action, movement recognized technology known now or developed in the future or it can happen with a switch or have this as an option. A computer menu can be used in the landscape/horizontal position and then by turning it to the portrait/vertical position the curser can be used the same way. If the unit is on and the user switches from a landscape to a portrait position, the unit can have a delay sensor and will not work until the unit stays in the new position for a certain period of time, like 3-5 seconds for an example. It can have this feature or not. The special adjustment software can recognize a switch from left to right or right to left. The user can have a switch to turn the unit to each position, so they can manually do it or it can do it automatically.

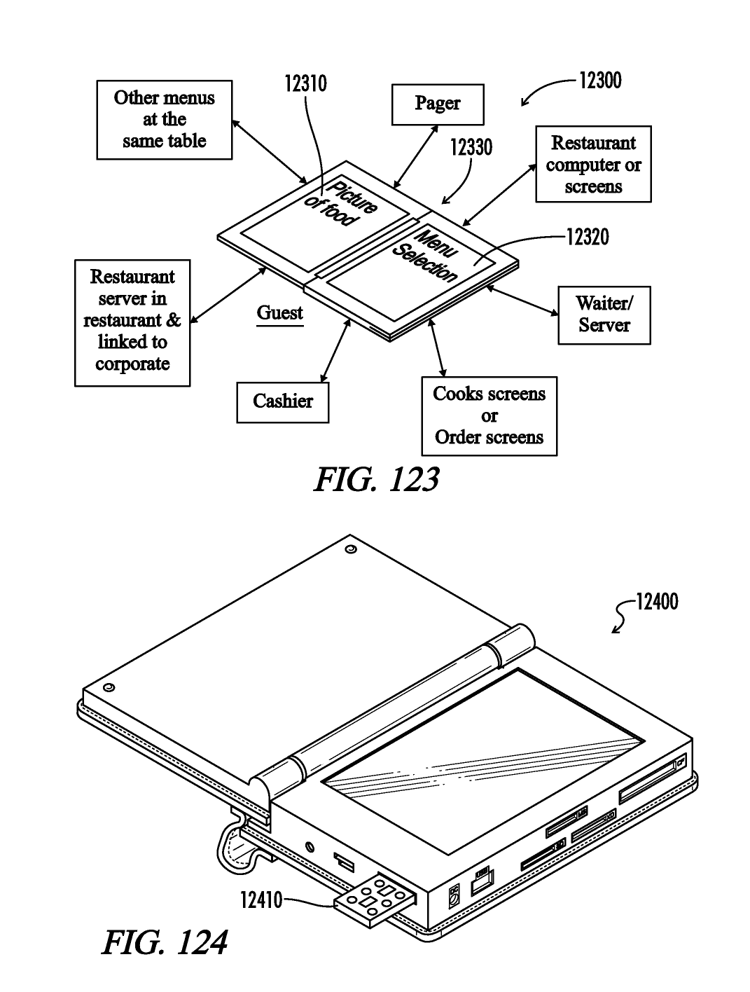

FIG. 123 shows one embodiment of a digital menu 12300 for use in a restaurant or the like, which can have a single screen (not shown) or a dual screen 12310 and 12320 and can have a variety of hinges 12330 as described herein or developed in the future. This menu 12300 is a slim design, can have buttons, key, controls or not, it can have touch key controls or not, it can have touch screen or not, as well as all of the features and functions described herein in connection with the various digital devices described herein. The table of a restaurant (not shown) can have a charging port or station (not shown) to charge all the menus at the table, and can be arranged to hold the menu open or closed and to be charging at the same time. The charging port or station can be arranged or designed to have one menu open and the rest closed. It can hold any number of menus, and can be located at the table or in the back or from anywhere. The menu that is open can be an advertising screen for the restaurant listing prices, new specials, or anything a restaurant might want to promote or sell more of. Similarly, the pagers that restaurants use for patrons that are waiting for a table can also have a screen to show the menus, prices or advertising displays. A consumer can activate the screen on the menu 12300 and control it, so they can view it or not. This will give the consumer a faster idea on what they want to order and save on deciding time and help advertise the food that the restaurant wants to promote. The menu features and descriptions mentioned in this application can be part of a pager (not shown) that is given to the consumer when they are waiting to be seated. The menu can give the consumer prices, videos of how the food is made or what the food or drinks look like. The menu 12300 could also be a futuristic menu that gives the consumer a way to see food, videos, advertisement, desserts, appetizer, entrees, and specials, see coupons thru their menu, etc. The consumer can walk up to their table and see the menu 12300 open or closed. If the menu was open, the unit software can show the welcome screen from the restaurant, or touch the screen or button to activate. The unit can be displaying specials and can be already playing an advertising message by the restaurant. The user can hold it and look at each section like drinks; it can select the drinks they want immediately without having to wait for severs to get to them. It can be linked to the servers pager or hand held device, a central server in the restaurant, waiter, or an order screen that anyone can see in the back room. The charging station can also have controls or buttons or a touch screen to notify the server to come to the table or if they need the server, pay the bill, want more drinks, or even have a credit card swipe to pay their bill. The charging station or port can also have a built in machine to take cash and give back change similar to attendant-free registers or self-serve registers or machines used in retail establishments. The unit can be small or located under the table and be a nice decorated unit outside, so it does not look like a machine. The receipts can also be printed. The screen can show the bill and if they have questions, they can call the server or manager. The station or menu 12300 can be linked to the manager, an iPhone or hand held device, any wireless or non wireless type device or hand held device, the screen in the back room, the computer of the restaurant or linked to the corporate office, etc. This menu can have a credit device or port, so the user can swipe their credit card and pay their bill without waiting for the server to come to the table. This happens all the time in restaurants especially when they are busy and the consumers have to sit and wait for their bill; this way it will move consumers in and out of restaurants quicker with a more pleasant stay and it will allow restaurants to get more people in their restaurant and have more volume, so it benefits the consumer and the restaurant. The credit card swipe can be liked to the restaurants main cashier or register so they can monitor the unit, it can be linked to the credit card authorities. The credit card swipe can be located anywhere on the unit and can be any kind or any type. If the user has a problem with the bill, the consumer can notify the server or manger, or not pay this way and pay like they normally would. A consumer can choose to use some of the features and functions of the menu 12300 or charging port or station or none at all. The charging station can have this feature as well and have its own screen, which can play advertising message or displays, there can be a light attached for the table, so it all one unit, and it can have other typical table amenities like a salt and pepper shaker attached or not. The station or port can have menu-like features as well. It can have a flower, candle or plants attached or designs to make it attractive. The menu 12300 can have special software to show a drink menu, specials, entrees, and the consumer can switch and navigate page to page or section or from appetizer to entree, to desserts easily and they can actually see the food and order it. Or it can be shown all on one page. Once the user choose everything they can see what they ordered at any time and see their bill as they order it along with the pricing and taxes. This is a huge benefit to the consumer, so they are not surprised on what they are ordering and they will know what their meal is costing while they order. This is beneficial software that can show the consumer what they are ordering and what their total cost is. Many people are on a budget and have a certain amount to spend and don't want to go over it. The charging port or station can have this showing up on the screen as well or place to show it and is located anywhere. The menus can be placed in the table, so it hidden after use or under the table or located any where. The charging ports or station can be designed to hide the menus after use and charge them at the same time. Most menus after use need to be out of the way. Tables and the charging port or station can be designed to hide the menus when not in use. It can be placed anywhere near the table, on the table any position or anywhere on the screen, It can be placed in a hole in the table or slot and then when the user pushes a button or control, the menus appears and you can push them and button and the menu is hidden with in the table. The table could also function as one big touch screen, where the menu is visible as part of the table surface. The server can still help the consumer but the server can serve more tables efficiently and this will save the restaurant money and give the consumer an opportunity, to let the consumer have a pleasant experience, without having to wait to order. The servers can have pagers or hand held devices or any now known or developed in the future that let them look at the table and what they want to order easily, like what drinks they want and then bring them and bring the drinks at the same time. The menu or charging port or menu station can have a speaker to talk to the manger, or server or the back room, which can be linked to hand held device/or pager that the manger or sever has or to the main cash register or main computer in the back room or to the server. All menus at the same table can be linked together can have special software that recognizes that certain menus belong to certain tables, and new added menus can be set to add to extend the table with ,ore guest. These menus that are linked together can have special location recognition software that can locate which place at the table the guest is sitting, that way the servers can bring the food or drinks to the appropriate guest.

The restaurant server, computer, hard drive can be any type known now or developed in the future. It can be linked to the corporate office, menus, charging station pr port, the server hand held device or pager. The restaurants operating system, servers or computers can have timing device software to let the manager, corporate office or management know how long it took the servers to respond or the cooks to respond to the cook order, this will allow the restaurant to see what improvements that are needed and so they will know what will be needed to improve the efficiency of the restaurant cooks, servers, consumer wait time. The charging station or port can have a speaker or microphone to allow the consumer to set the mood of their dinner or meal, it can only allow the music to be as loud as people are talking, without annoying and being too loud to disturb guests around them. The charging port or station can be by itself and have no menus associated with it and can have all the features and functions mentioned herein, and can also act as a menu as well. The pager or hand held device can have long battery life and can have a screen to see each table's order and what has been delivered and what is left, it can have controls and software to communicate with the chef, manger and guest efficiently. There can be special software on the hand held device or pager, when the the consumer pages the server it will show him what table they are at, or what message the consumer had for the server, the server then can send a messages to the consumer to their menu or the charging station or port by voice or both text and voice or only by one or the other. The server can also just go to the table and discuss what they need. The menus can have a section of special software that gives the user the opportunity, with many choices of special options, so they can have a hamburger their way and if the software did not carry the option of the consumer then they can choose sever, then the server will take their order. The user can opt out of using the digital menu 12300 or just use the menu to look at the option and then choose to order from server and this will be sent to the server so they know how the consumer want to order. The user can use the menu to look at the option and order through the server and use the charging station or menu to get a copy of the bill, or use the menu or charging port or station to alert the waiter, like a call button, to come to the table and order or take care of their requests. The menus can come with an LCD or any type of screen and the brightness can be controlled so it's not too bright, or have e-ink technology like e-books so the user will not hurt their eyes looking at it for along period of time. The lighting can be real beneficial especially in restaurants where there is less lighting. The cooks can benefit from seeing what the consumer is ordering, so it can make it more efficient. The charging station or port or menu can have a microphone or speaker so the guest can order their food drinks etc. to the back room, so they have more of a human experience ordering. Instead of touching the screen or pushing buttons to order, the menu or charging station or port can act as a communication device for the consumer with the server, manager, cook and restaurant. The user can use the menu to look at what they want then order though the voice microphone and speaker, so they never lose the human communication and there will be less chance of wrong orders and confusion.

If the restaurant has people to respond to all inquires or orders on time, then this will speed up the ordering process and achieve a good consumer experience. The menu can have a power button and the station or charging port as well. The menus can be activated and turned on when the user picks it up from the charging station or port and then it can be charging every time they put it back on the charging station. The charging station or port or menus can have their own software own poser supply, it can rechargeable batteries or not and the charging station or port can have direct power or not.

FIG. 124 shows one embodiment of DPA 12400 with a slide out part 12410, which can be a button, control or slide out keypad tray, or removable battery, etc. FIG. 124 shows a pull in and out tray 12410 for a control button, keypad, buttons, curser, battery, or any type of electronic device or function or feature mentioned herein that is useful for operation with a DPA. This slide out tray 12410 can operate and engage with the DPA 12400 using any method now known or hereinafter developed, and can lock if desired. The buttons or controls for operation of the part 12410 can be any type known or developed in the future. This could be a storage tray as well, for storing a variety of items, and it can be located anywhere on the unit 12410 in the front, back, top side, through the cover or any location is possible.

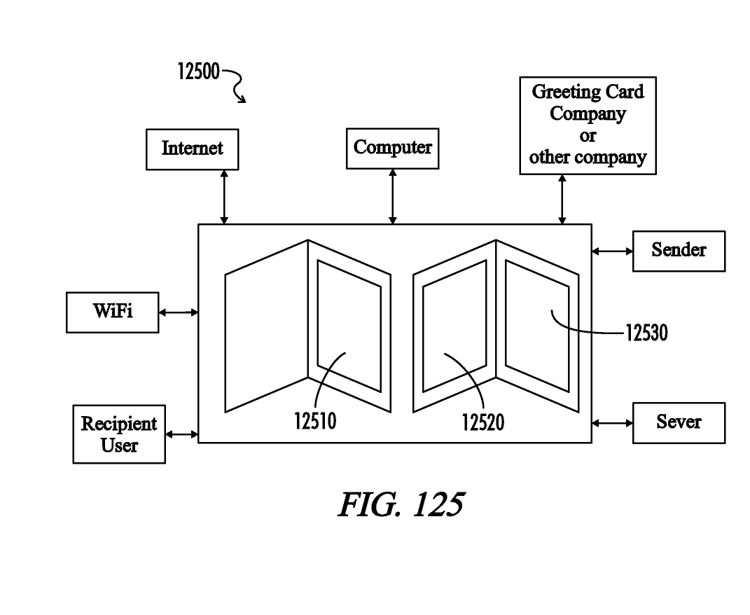

FIG. 125 shows one embodiment of an electronic digital greeting card or greeting video card 12500 with a single screen 12510 or a dual screen 12520 and 12530, which can include any type of hinge known now or developed in the future. These greeting cards can be any shape or size, have separate or permanent covers or replaceable covers, and/or can be decorated like greeting cards or have logos, printed images, embroidered or any type or messages on them and can be digital screens on the cover as well or any type to light up. It can play videos, messages or home videos, it can show digital greeting with personal voice and or video message. The device is a great way to share and keep all your typical greeting cards for example. Consumers spend lots of money each year on beautiful cards and personal messages are often misplaced or thrown away. It would be nice to have a greeting card, or video card journal or keepsake or video book or album that you can keep all your precious memories all in one place and look at them at anytime. A user can, for example, go online to a greeting card company website for example and chose a card and send the recipient a digital greeting card. The greeting cards can be WiFi enabled, can have an inbox and outbox to send and receive greeting cards, and it can have functionality for organizing greeting cards and greeting videos. Let's say you want to send your mom a birthday card, you can go on line from the unit or any computer or phone, WiFi unit or any location and choose a beautiful card and add your special comments to the card and have a way to sign your name and family members name and send this card. This card can go to their special greeting card and video unit 12500. When the user sends the card or video greeting a special message can go to the unit and go to their email address. The unit can also be used as a greeting card that you buy at the store and gives the buyer an opportunity to customize greeting and add voice and video to the card. They can take this unit and connect to the computer and add a video, pictures or text through the computer, through their camcorder, through a company's website or greeting card or video company, or through their camera or cell phone. The greeting card 12500 can interact with greeting card companies or other companies. It can interact with senders and receivers of the digital greeting or video message. It can interact with stores, the Internet, it can have WiFi or not. This device can be a place to view a greeting card and the user can get the digital greeting card or greeting video from the web and then transfer it to the greeting card storage area. If the user wanted to scan old cards and transfer them to this device they can do this as well. This way all old greeting cards can be preserved in one place and not take up as much room. And it will be convenient for the consumer to view all their greeting cards and videos in one place, the device can have one per home or have several. The greeting card companies can charge a fee for the downloaded images, greeting cards or styles of showing videos, templates, or downloaded videos for more than one. A greeting card or greeting video can have any number of people added to it. The greeting cards or greeting videos can have special software to communicate with the internet or the greeting card company. It would be a real special message if everyone or the whole family can put a message to their family member to express their feeling to the individual. One way this can be done is, let's say you had a grandma turning 100 and everyone wanted to give a message as a family. They can go to the web site of the company or greeting card or greeting video company and there can be a link and ID number for the greeting card and or video and then the people that want to say something, can add a video or text or personal message to the grandma, so there could be 20 family member in 20 different states and 10 family member outside the USA and they can give grandma a special birthday video and greeting. Then someone can give grandma the digital greeting card/digital video journal or album and set it on the sofa and push play and see a wonderful memorable greeting and personal greeting and video greetings from all her family members all over the world. This unit can be a keepsake for everyone, and everyone can pay for copy of the video and keepsake or greeting. This unit can be a great way to journal or keep as a greeting card, greeting video album, where you can have thousand of video and greeting cards old and new in one place. This can have built in memory or not have it and can be stored on backup servers. Greeting card or video greeting card companies can have a server to help people store their memories and videos and send them to you at any time and there can be charge for this or not. It can be sent to any type of device mentioned in the, drawings, specifications of this applications or previous applications.

The embodiment of an electronic greeting card 12500 shown in FIG. 125 can have a small video or picture screen, LCD or any type located anywhere on the inside or outside of the digital greeting video or digital greeting card. The unit can come with a USB cable and can have ports so the user can connect to a camera, cell phone, computer, laptop, web cam, digital frame, digital book, digital photo album and video album, internet, website and transfer photos, or videos to the digital greeting card or digital greeting video. The unit can have type and print like a conventional paper-based greeting card and can have a place for the user to sign the greeting. It can be made of any type of material or be made of normal material that greeting cards are made of. The units can have one to many layers. It can have compartments or a place for built in memory or PCBA board, computer board or software chip, or battery, or SD card for memory and all of this can be removable or permanent. It can be any size or shape or have any type ports or have speakers. The user can do all this through the greeting or video company website.

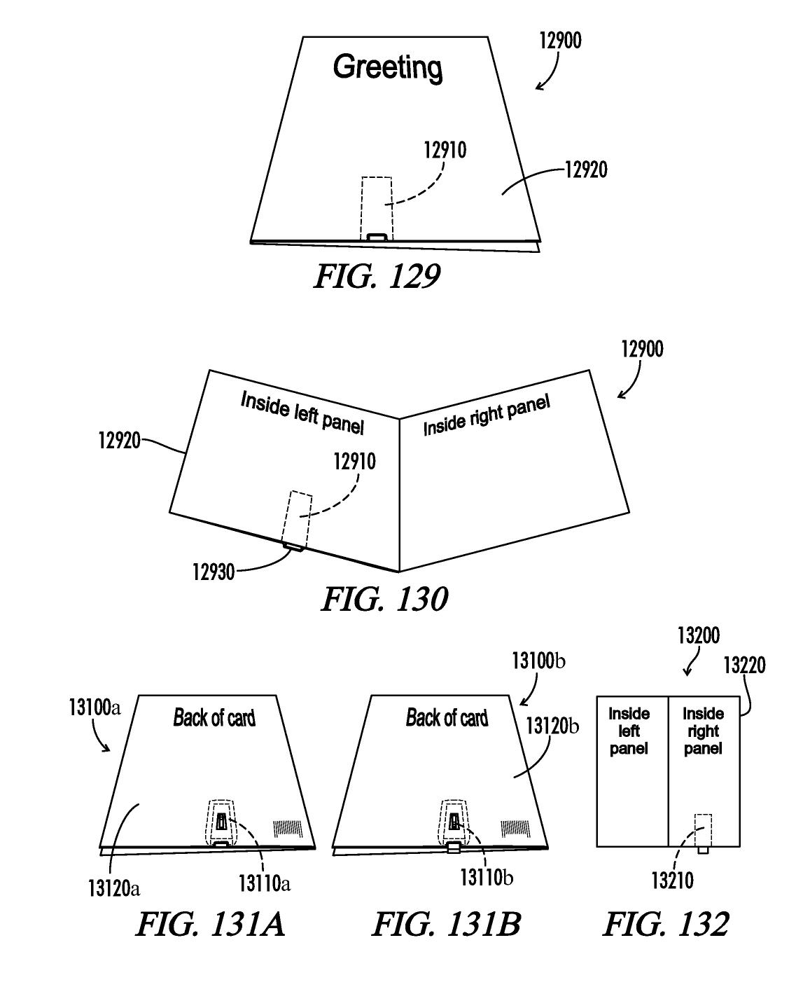

The embodiment of the card shown in FIG. 125 can also have no LCD screen on any side. It can look like a real greeting card. It can be any type of material. The units can have one to many layers. It can have compartments or a place for built in memory or PCBA board, computer board or software chip, or battery, or SD card for memory and all of this can be removable or permanent. It can be any size or shape or have any type ports or have speakers. The digital greeting card or digital video card can have a pocket or have an area that contains a SD card or other memory card or any type of memory or built-in memory; this can be removable or enclosed. It can be enclosed any way possible and be located anywhere. The user or sender can connect a USB cable which can be provided when you buy it or not, and the user can connect to a camera, cell phone, computer, laptop, web cam, digital frame, digital book, digital photo album and video album, interne, website and transfer photos, or videos to the digital greeting card or digital greeting video. The greeting video or card can have a place to store a USB cable on the back in the middle or anywhere, so the card will have way to connect to the computer when the user sends it to the recipient, in case they don't have one. The USB cable can be any type or size and have mini on one end or regular USB on the other. The USB port on the device can be mini or any type of port for electronic connection. The recipient can connect the USB cable which the user sent to them along with the card and they can connect to a camera, cell phone, computer, laptop, web cam, digital frame, digital book, digital photo album or video album to view their digital greeting card or digital greeting video or digital photo sent to them. There can be a small digital viewing display unit with any type of LCD screen and be any size or shape for viewing digital photos or video. This can be sold together and sent to people that don't have computer knowledge or don't have computers and it can have batteries built in or AAA batteries or any type. It can also have any type of ports software memory, chips etc. The digital greeting card or digital video card can have a pocket or have an area that contains a flash drive or cruzer. For example; a very thin design that a flash drive can fit anywhere inside the card or outside the card. If it was inside the card it can be permanent or removable. One example would be to have a flash drive enclosed in a real greeting card at the bottom of the card in between the back page and the back cover. The bottom of the card you would see an opening where the flash drive is inside, like shown in FIGS. 129-132, for example. On the back of the card is an opening where the user can extend the flash drive USB section outward and be long enough to extend and connect to any computer or USB port. The section open on the back cover can have a strip of open area that allows the part of the USB where there's is a grab or finger grasp to push the flash drive one way to extend outward and push the other way to extend back inward, like shown in FIG. 131, for example. It can be any type of memory to hold voice, photos and videos that can work like a flash drive. The user would buy these types of cards at the store take them home or where ever and sign the cards and add personal messages like many people do, then connect to the computer/laptop or any electronic device and add a personal video or video greeting or photos. Can also connect to cameras, cell phones, camcorders, etc. Then the user would send the card in the mail or give it to the recipient and the recipient would open the card read the messages and somewhere on the card it can have text or print that explains to the recipient, “for your special personal video message or greeting or pictures turn to the back cover.” On the back the user can see directions to push the finger grasp that extend the USB flash drive and connect to their computer/laptop or any electronic device for their special video greeting or video message. Accordingly, greeting cards can have a video message, or pictures associated with the greeting card with out having the expense of a LCD screen or computer parts. It is easy for both the sender and the recipient and it's cost effective and very affordable. Another easy way for this to be done is to have the greeting card flash drive or any type of memory be sold as a separate unit. The unit would, for example, have one side be sticky label or any way to attach it to a greeting card with a peel paper; you peel it off and stick to the back of any greeting card or anywhere. It would have instructions on it or with it to explain where to position it so the USB section can be extended outward enough to connect to a computer, laptop or any electronic device. The other side can have paper material or any type of material and can be any shape or size or any color. This area can also have a section that has a strip of open area that allows the part of the USB where there's is a grab or finger grasp to push the flash drive one way to extend outward and push the other way to extend back inward. There are many ways to attach a portable device like this, this is just one way and any way known now or developed in the future is possible. Instead of a finger grasp, it can be any way to achieve this where the part of memory device attaches or connects to the computer/laptop or any device. Any of the finger grasps mentioned can be enclosed within the greeting card flash drive that it does not extend out past the card, but allow the user to still grasp it, so the card will still be somewhat flat. The finger grasp or push/pull area can have a lock when it extends out and the user would have to push in or down on the grasp for it to release and extend back into the card or unit. By having a portable unit a user can place it on any card they really like. Some of the buyers favorite cards can have this video and photo greeting flash built-in or not. The digital greeting card can have the ability for the user to connect to the computer or interne and download their favorite e card to be sent with the special photos or videos sent with the card. So e-cards can be included along with any type of letter documents and contents that is stored in memory or your computer or laptop can be included with their greeting card being sent.

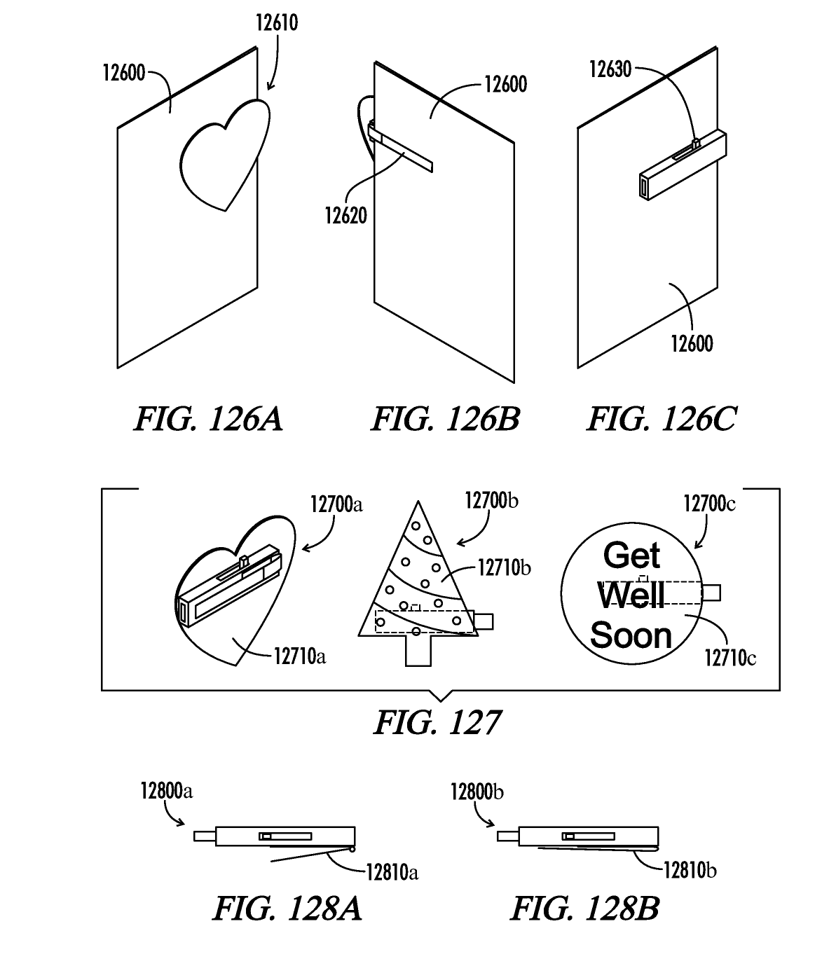

FIG. 126A, FIG. 126B, and FIG. 126C show one embodiment of a portable digital greeting, or digital media USB flash drive 12610 with a slide on clip 12620, hinge clip or any type of attachment mechanism connected to a greeting card 12600. The portable greeting card flash 12610 can have any type of paper material or any type of material and can be any shape or size or any color. This area can also have a section that has a strip of open area that allows the part of the USB where there's is a grab or finger grasp 12630 to push the flash drive 12610 one way to extend outward and push the other way to extend back inward. This finger push/pull mechanism 12630 can be located anywhere on the unit 12610. This portable unit can also have no fabric type of material or any label or sticky surface. It can be a unit that clips or slides on and off. The sender can attach it to any card they buy, the recipient slides or pulls it off, connects it to the computer and see their flash greeting or greeting with memory. This unit can be reusable unit or can be only used once. This unit can have decoration or no decoration. The unit can have a cap that covers the USB or port that transfers files.

FIG. 127 shows various embodiments of a portable digital greeting, USB flash drive 12700a, 12700b, 12700c with a slide on clip, hinge clip or any type of attachment mechanism, with a decorative, or festive heart body 12710a attached, Christmas tree 12710b, and Get Well Soon body part 12710c of the USB flash drive. Other decorative images and features are possible. The designs can be real slim and can be decorated or shaped any way possible like hearts for Valentines, Christmas, birthdays items, Easter, or an season or time or reason to give a greeting to someone. This can slide on like a paper clip or any way known know or developed in the future. This greeting card flash can have a built-in clip, or paper clip type of function, spring loaded clip or any type of attachment mechanism to cards, letters, papers, envelopes or any surface. The clip or attachment mechanism can be permanent or be removable to the flash. The decorative part or designs that can have shapes, designs, or text can be removable or permanent. Usually flash drives are small and have a choke hazard, so to avoid this, the decorative structure, or body can be big enough that is not a choke hazard. A flash outer shell, or body can also be the decorative part or it can be a separate unit that can attach to any size flash drive and snap on for example, so it does not come off and the user can take it off and put back on or put another type on. It can be designed to snap together or slide in and not out or any way known now or developed in the future. It also can be designed so, the decorative features can be taken on and off and the user can change them when they want and add one for Mother's Day and then change it and add one for Christmas. The sender would send the greeting flash, the receiver can see their greeting and save the flash memory and take the decorative section off and add a new one and send it to someone else, so this reusable or it can be use one time. This is an example of one way it can be done, but other ways are possible. The memory can be any type known now or developed in the future. The user can erase the memory after viewing, add to it and send or just add a fresh new greeting or message or documents. Or it can be a read only memory or file, or document. The shape or design on the flash unit or body can be permanent or it can change position, swivel, or be located anywhere on the unit.

For example, the user purchases a card and a greeting flash. The user signed their name and added the greeting to the flash. They clipped the unit to the middle of the card, which can act as a card clip as well. The clip can be placed anywhere on the card, but for this example it is placed in the middle of the open side with the decoration, body, or shaped unit facing outward. This way when the user puts it inside an envelope it will close easier. If the decoration design had a swivel, or a turntable, or a movable feature, the user can turn the decoration to any angle that will look good. Then the user would seal the envelope and send the card. The receiver would receive the card open it and they would see the front of the card with the decorated or, body, shaped or normal flash drive. There could be text on it that says “Smile you have a digital greeting attached” The user would open the card, see the greeting then plug in the flash and see the digital greeting. The flash can have no designs as well and have a special feature, or clip to attach it to any type surface, and this feature, or clip can be permanent or removable. The section of the flash that has the USB port can have a cover that is permanent or removable and the cover can be part of the decorated body, or body, or flash unit, flash design, or text unit or part of the flash drive. The unit can have a clip or hang tab or a hole where someone can put a key ring through it. The cover or cap that covers the USB could be the whole decorative unit where the cap is decorated and has a female or male section that connects with the female or male section of the flash unit. The cap can slide onto the flash unit and when is connected, some or all of the flash unit could be covered with decoration or design shape, or text. This part of the unit that has shape or design, or decoration can be on one side only, for example, like the side that is showing when it is clipped or attached on. It can be opposite the clip or attachment or anywhere. The unit can have a speaker and make sounds. The decorated or special designed units can have a battery (replaceable or permanent) inside where, for example, a flashing light blinks when you touch it or is on when you turn it on. Another example is a user buys a greeting card and a greeting flash drive and goes to the Internet. There are then companies that help the user download their pictures or video and add them to the companies' special software. The special software can have special digital designs or pictures, frames, or outlines, digital images, cropping, crops with designs, windows with areas for pictures, or videos ,or documents, or decorate window or frames that the user can choose from and then place their photos document or images, videos to the these areas. Then the user can download their custom greeting and/or videos, pictures, images, text, or documents to their flash drive. There can be any type of custom digital software for every occasion that greeting cards make now, known now or developed in the future, like, Anniversary, Birthday, Get Well, Valentine, Christmas, Thank You, etc. The greeting flash can have a finger grasp our push pull lever or pin, or it can not include this feature. The cap can cover the USB section or it can come within the unit. The push pull feature and come out and in with any kind of device to make this happen. The cap can also have advertising unit or printed on the unit and have a connection like a hinge, cord or any other way to attach the pieces together. The portable digital greeting can have any type of memory to hold digital or electronic files that are known now or developed in the future. The unit can have print silk screen, fabric, or any material in or on the unit. There can be case of plastic or any other type of material enclosing the digital unit.

FIG. 128A and FIG. 128B shows embodiments of a portable digital greeting USB Flash Drive 12800a and 12800b with a hinge clip 12810a, slide on clip 12810b, or any type of attachment mechanism attached to a greeting card, or any type of card.

The digital greeting card or digital greeting can be made of any type of material, and can be made of paper or plastic material as well. Any type of sealing or enclosing method can be used to keep the digital port, digital media, digital card reader with memory, or digital memory in the digital greeting card, or card. For example: a mini USB port with memory can be sealed in between two parts of a greeting card. The sealed areas can be the outer perimeter or anywhere to keep the mini USB port and memory inside the greeting card. The area that holds the port, digital media, memory card, card reader, or internal memory area and port can have reinforced material, or extra protective and security materials to keep it inside the unit and also keep it secure so the consumer cannot take it out. The digital greeting card can have one to any number of layers. A digital port can be located anywhere on the digital greeting and digital greeting card. The digital greeting card can have a card reader containing and SD card or any type of memory card or any type of memory. The digital greeting can have a flash drive built-in the unit.

FIG. 129 shows a digital, electronic greeting card/greeting video book 12900 with a built-in flash drive 12910, built-in memory, memory card, memory card reader with memory card, port enclosed inside the digital, electronic greeting card/greeting video book 12900 front cover 12920 and in a closed position. The USB is contained inside or outside or located anywhere on or in the digital greeting card 12900. The USB flash drive 12910 can have a finger push and this finger push can be exposed so the user can move the USB port or any type to extend out of the card or greeting card and then the user can push the finger push back inwards to bring the USB or other type back into the card. The finger push can be located anywhere and can have a lock mechanism that the user would, for example, have to push the finger push down to release to be able to push to extend and push back to retract. Any way to accomplish this known today or developed in the future can be used. There can be any type of port known now or developed in the future can be used. Any type of memory, permanent or removable can be used that is known now or developed in the future. The digital greeting card or digital greeting can have any number of pages, any type of text, print graphics, sound or video known now or developed in the future.

FIG. 130 shows embodiment of the card 12900 of FIG. 129 in the open position with the digital area inside the left front cover 12920, with the port 12930 visible to the outside, but can be hidden.

FIG. 131A and FIG. 131B show the back of a digital, electronic greeting card/greeting video book 13100a and 13100b with a built-in flash drive 13110a (retracted) and 13110b (extended), built-in memory, memory card, memory card reader with memory card, port enclosed inside the digital, electronic greeting card/greeting video book and in a closed position. In FIG. 131A there is shown a section open on the back cover 13120a, 13120b can have a strip of open area that allows the part of the drive where there's is a grab or finger push or finger grasp to push the flash drive one way to extend outward and push the other way to extend back in ward. This finger push/pull mechanism can be located anywhere on the unit. The finger grasp or push or pull area can have a lock when it extends out and the user would have to push in or down on the grasp for it to release and extend back into the card or unit. The flash drive can rotate out, rotate in, hinge, or extend in and out of the casing, body or decorative body.

FIG. 132 shows one embodiment of the back of a digital, electronic greeting card/greeting video book 13200 with a built-in flash drive 13210, built-in memory, memory card, memory card reader with memory card, port enclosed inside the digital, electronic greeting card/greeting video book 13200 and in a open position with the digital area inside the right back cover 13220 and with the flash drive 13210 extended outward.

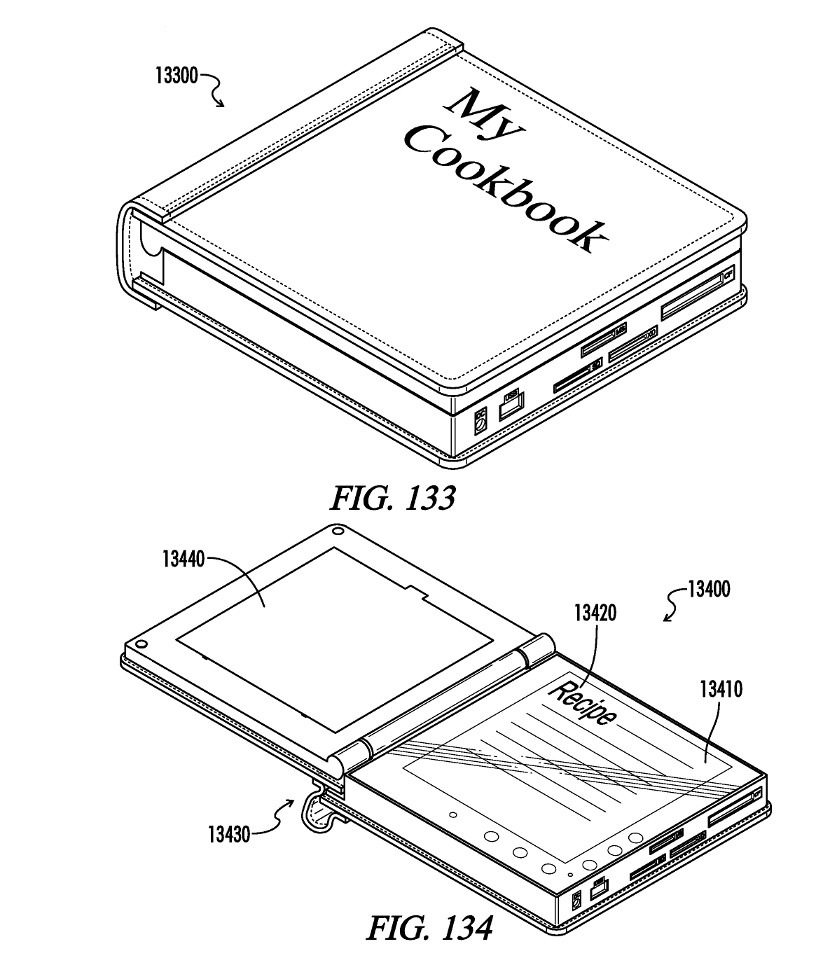

FIG. 133 shows one embodiment of a digital cookbook 13300 in a closed position and FIG. 134 shows a cookbook 13400 in the open position. The functionality and features described herein with respect to various embodiments discussed herein can be incorporated into the cookbook 13300 shown and described hereinafter. The digital cookbook 13300 is a convenient way for a person to store all their recipes. Many people have recipes on papers or in books, on the interne and are stored everywhere and sometimes when the consumer wants to find a recipe its not where they can find it when they need it. By having a digital cookbook it is a very convenient system, so the consumer can keep all their favorite recipes and favorite cookbooks in one location. The digital cookbook can have thousand of recipes in one location; it can contain hundreds of their favorite cookbooks in one digital cookbook. The materials used can have PV coating or any type of coating so it will be easy to clean in case food gets on it while cooking The screens or viewing area where the user views their recipes, cook books or video demonstration or pictures can have a screen protector shown, for example, as 13410 (FIG. 134). The screen protector for this digital cook book unit or ebook, or digital album or digital book can be made of clear plastic or any material, which make it nice so the consumer can clean it in case food or dirty fingers touch the screen. The screen protector for this digital cookbook unit or ebook, or digital album or digital book can have the bottom side painted or not clear so it can frame the screen. If the unit color was black then the painted frame described can be black as well. There can be painted icons identifying the touch key controls that are right above the touch key control sensors. The icons for touch key controls can be one color like a light silver for example, then the frame color black can be on top. Then when it's placed over the screen the user would see the black frame around the screen or viewing area with the touch key control icons. The screen protector can be permanent or removable and can be applied any way possible even using double sided tape, one side connecting to the screen and the other side connecting to the unit. The digital cookbook can have a rechargeable battery, so the user can place it on the counter, or view recipes that they want to cook for the week on the sofa or anywhere. The battery can be any type known now or developed in the future. The battery can be permanent or removable or it can have even AA or any type of battery, or rechargeable battery. The unit can come with AC power adapter. It can have any type of port or power function. It can contain internal memory, or built-in memory. The digital cookbook, digital photo album, digital e book reader or digital book can have a memory card slot and have a memory card slot compartment used as the memory for the unit. For example, there can be a memory door, compartment or slot that is use for the memory of the unit. It can hold SD memory cards or any type of memory card. If the unit had a memory door, it can have a snap closure mechanism, or molded plastic bump that can hold the door in place and when they open it, the plastic bump is released from the bump female counterpart. The opposite happens when the unit is closed. The door can slide in and out or have a hinge or not. It can have engraving or print to identify the memory. It can have engraving or print or silkscreen to identify ports or and operating parts. Many consumers are worried about losing their memory in electronic devices. Using this kind of memory allows the consumer to get to their memory at any time and they can upgrade their memory at any time, like from 1 GB SD card to a 16 GB SD card. This makes the unit have an upgradeable and removable memory. The user can have a SD card in the memory card slot and have then plug in another SD card to another SD port on the unit and view contents and send to the SD card memory as well. There can be any kind of port for memory cards, any type of card reader, USB port and mini USB port. The unit can operate by remote control or touch key or any type of function. The user can watch home videos, cooking demonstrations, view pictures of food preparation, ingredients, recipes, photos, word documents, pdf files, and kind of file. The cover of the digital cook book can be permanent or removable, the screen and viewing unit, LCD screen, viewing screen, or digital cook book can be attached to a cover or sleeve by any way mentioned in this application or known now or developed in the future. The cover can have a binding like shown in the various drawings presented herein. The cover can be made of cookbook covers that are in the market, they can have print on the cover, it can embroidery, silk screen, graphics. The cover can have a window on the front for photos or text or an LCD screen.

FIG. 134 shows one embodiment of a digital cookbook 13400 having a single screen 13420. FIG. 134 shows a screen 13420 to the right of the hinge 13430 and a storage area or memory card storage area 13440 to the left. The digital cook book screen 13420 or viewing area screen can be any type, like LCD, Plasma, e-ink or any type known now or developed in the future. The digital cook book can have one or multiple screens or viewing areas. The screen can have a video cooking demonstration in a box or a specific area and also have text like recipes, ingredients directions on the rest of the screen or viewing area.

FIG. 135 shows one embodiment of a digital cookbook 13500 having two screens 13510 and 13520. This dual screen version is very unique because the user can have two sides like a real book. The two screens can operate like any of the screens described in other embodiments herein. One screen can play videos demonstrations of cooking, mixing ingredients, pictures and have text on the same screen, one side can play video or have pictures and the other side text, so the text, pictures or videos can be one or multiple and be located anywhere on the screen. The storage area or memory card storage area can be on the back cover of the dual screen or it can be located anywhere. The cookbook 13500 can also incorporate various other features and aspects described in other embodiments herein.

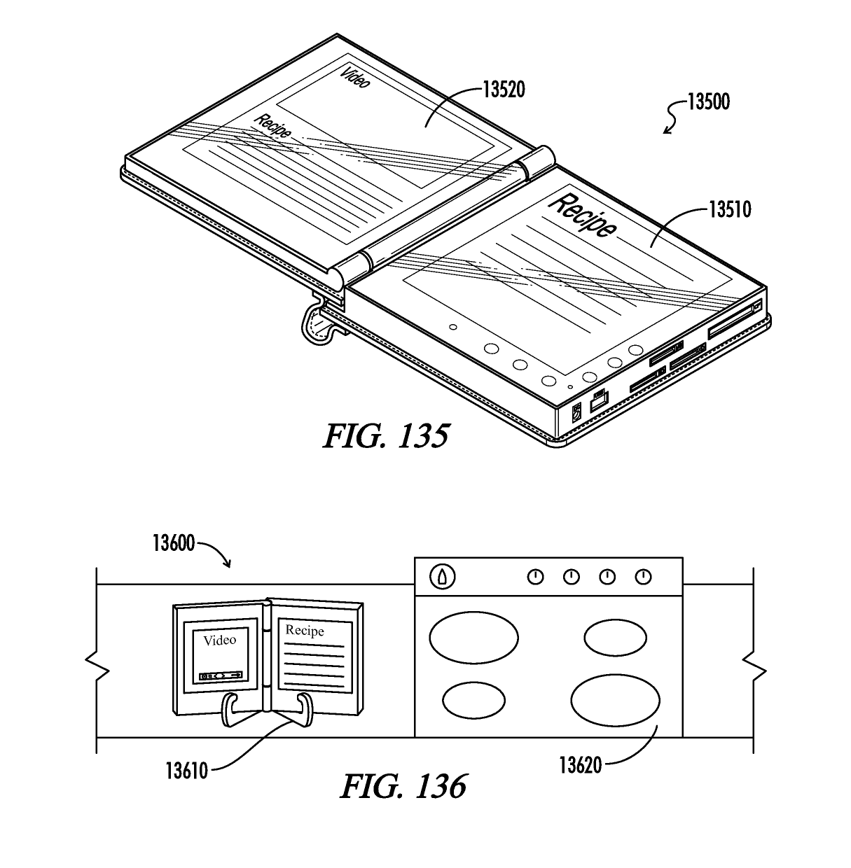

FIG. 136 shows one embodiment of a digital cookbook 13600 on a counter with an easel 13610 next to a stove top 13620, for example. This shows a real view that the user can place a digital cook book on an easel 13610 similar to the easel 7410 of FIG. 74. The easel 13610 can be any type like shown or any type know now or developed in the future. It can have soft material so it will protect the cookbook 13600 also keep it place better and keep it from sliding and keep it in one desired position. The easel can be adjusted to give the user a convenient angle to view to their convenience. The digital cookbook 13600 can have WiFi, a web browser and any type of internet and communication capabilities. The unit can be placed anywhere on the counter, charging station or port mentioned herein, and can be small enough that the user can take it with them to the store, so they will have all the recipes, so they can look up the ingredients to buy at the store. The digital cookbook can have a feature to send recipes to computers, cell phones, text messages, recipes and ingredients to their phone or any electronic device, so they can have the recipe or ingredients when they are at the store, so they can buy it, or send recipes or ingredients, or books to friend's family. There can be a way to share recipes with others. The digital cookbook can send recipes, ingredients to another digital cookbook or any type of electronic device that can send and receive. The digital cookbook can have any hinge described herein or known now or developed in the future. The digital cookbook, etc., can have a welcome screen, screen saver, background or loading screen that shows a photo or the logo of the brand of the product like “TruView” for an example.

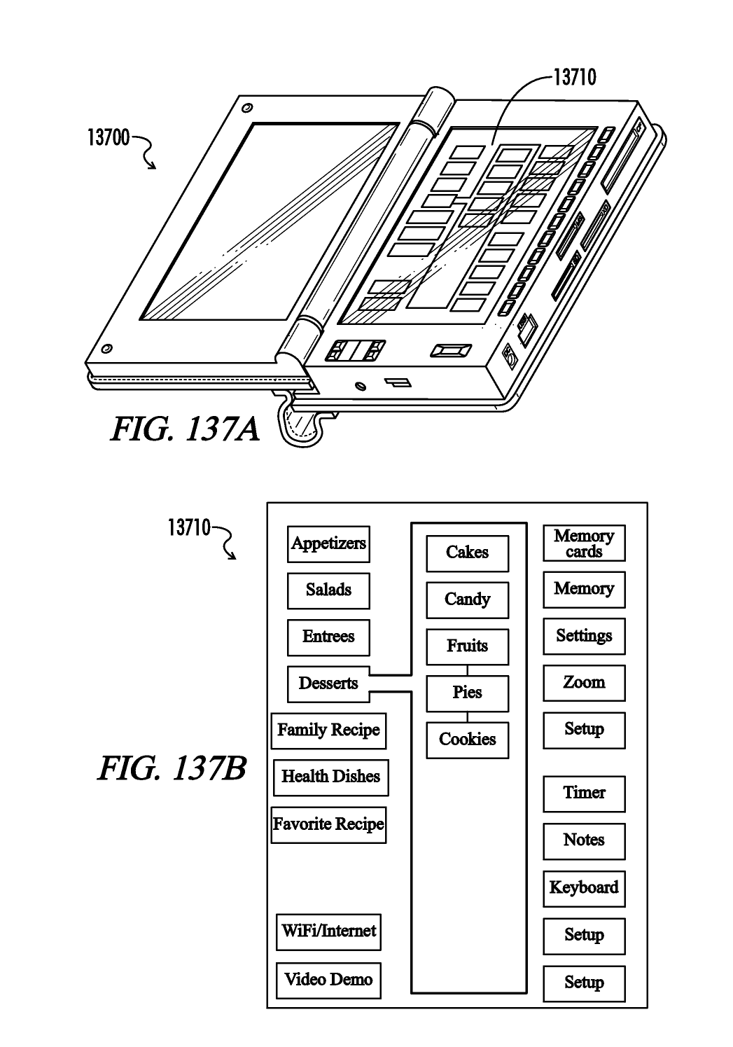

FIG. 137A shows one embodiment of a digital cookbook 13700 dual screen with one example of feature icons/software/functions 13710 on the right side and shown in close-up in FIG. 137B. The digital cookbook software can be any type known now or developed in the future. It can have a key pad, curser, built-in or attachable. The screen or viewing area can be touch screen. There can be a pull out key pad, or key pad tray or section. The user can use a remote or touch key to operate a key pad, with letters symbols, numbers that would show up on the software or screen or viewing area. One embodiment of a typical operation might be as follows. When the user down loads a recipe, picture, ingredient, book or other, it can down load it to the unit 13700 and then the user can choose where to file it, like cook books, appetizers, salads, entrees, desserts, family recipes, video demonstrations, favorite recipes, or notes. The user can name the file by keyboard, remote touch key, audio or voice and save it to the desired location for quick viewing when they need it. A voice activation unit can be installed to read the recipe out load, and read the ingredients and set the timer. The digital cookbook can have a speaker as well. It can be any type known now or developed in the future. One way the software and the digital cookbook can work is this. When the unit is turned on, a favorite food photo shows up with a title that says “My Digital Cook Book”. It can have this feature or not. When the unit is turned on it can also have a background photo that the user picks as the background and then the icons would show up like a computer. If the user does not want to choose a background, it can have a background color as a normal background. The user can have choices as well just like when they do it on the computer. The icons showing up can include, but are not limited to: Appetizers, Salads, Entrees, Desserts, Family Recipes, Cook books, Video Demonstrations, Quick Meals, Healthy Dishes, WiFi/internet, Timer, Notes, Favorite Recipes, Key Board, Send and Receive, Memory, SD/MMC/MS, File, Setup, calendar, zoom, settings and any known now or developed in the future for software. The user can use the up and down arrows or left and right arrows or remote to navigate to any desired icon and enter into that area. The user can take all their copies of recipes to a copy shop or copy center, office store and have them scan all their documents for them and save them to USB, SC etc. and then enter them into the computer. Photos of the dishes can be added as well.

The user can have a SD card in the Memory card slot for the memory of the unit. The user can scan recipes that are on paper to a scanner and save them to the computer, and can save them and name them and as JPG files, for example, and send the recipes to a SD card in the unit's SD card port or to a card reader connected to a USB port and the card reader would have an SD card inside. The user can insert the SD card into the unit, the user would select the SD, MMC/MS port and select enter. All the files would then appear on the screen and the user can scroll down with arrow button, touch key or remote to select the file. As the user scrolls down, highlighted files will be highlighted as they scroll up and down. The user can then choose the remote function or touch key like the right arrow button, left arrow button for example and it will give the user the option to all the icons, so the user can send the file to their favorite locations by pushing or entering enter for example. If the user clicks the enter button when the highlighted file is highlighted, then the user can view that file or recipe or cookbook, video demonstration. etc. If the user entered Appetizers, then all the appetizer recipes would appear. If the user entered Salads, then all the salad recipes would appear. If the user entered Entrees, then the entrees recipes would appear, if the user entered Desserts, then the Desserts recipes would appear, and so on. If the user entered keyboard then the key board would appear on the screen, and the user can use the touch key control, buttons or remote to navigate up down, side to side and enter the desired names numbers to name recipes etc. If the user entered timer, then the timer would appear and the user can enter a time so an alarm can go off to remind them when a meal is done. Or by helping the cook is reminded to check on the food or to help follow the recipe exactly. If the user entered Appetizers, for example, then if the user entered the left arrow button or right arrow, then the send and receive option comes up and the user can send their recipe to their phone, so they will have at the grocery store, computer, friend or any internet capacity unit. If the user entered Download, then the download section would appear. This is where the downloads from WiFi or the internet come from, the user can highlight the file they wish and use the right or left arrow and push enter and the icon choices would appear come to recipes would appear and you can push enter to send them to the user desired location.

The unit can have built-in memory and can have recipes, cooking demonstrations, videos, pictures and cooks books already installed in the unit when the user buys it. The digital cook book can have a feature when the SD card or any memory card is placed in the memory section or memory port of the unit and when inserted the SD card will have a format of all icons mentioned and when the user sends to the desired location it will be saved in that icon area of the memory card. The digital cookbook can have all the recipes and cookbooks in these sections when they buy it. The memory can be internal, built-in or removable. Other icons can be customized and name your own like Italian Food, French Food, Spanish Food, Mexican Food, American Food, Chinese Food, Japanese Food, Korean Food, etc. More icon or selections can include Poultry Entrees, Eggs, Hor S'Doeuveres, beef entrée, Chocolate, grilling, Fish/seafood, healthy eating, pasta dishes. The digital cookbook can have digital recipe cards and can have it own software to make custom digital recipe card. The digital cookbook can have footnotes, ingredients, directions, prep time, cook, time, ready time, nutritional information, amount per serving, total fat, cholesterol.

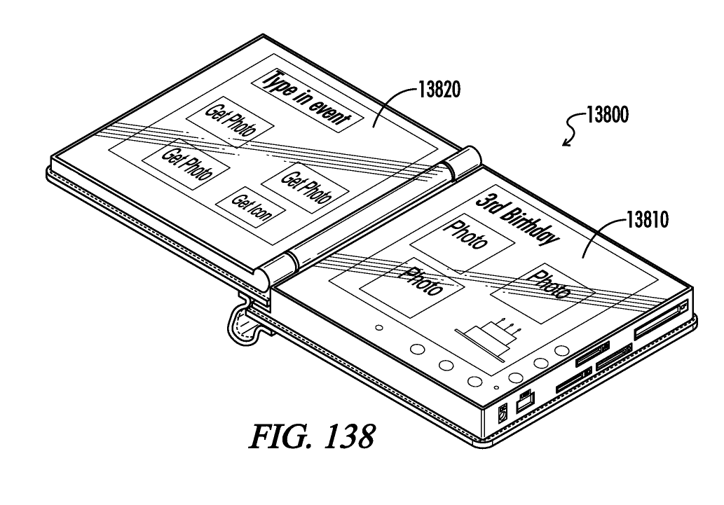

FIG. 138 shows one embodiment of a digital scrapbook 13800 with two screens 13810 and 13820. It can have one screen or two screens. The digital scrapbook can have custom software built-in so the user can place photos, in many different custom designed scrapbook backgrounds. Videos can be added as well. The user can add text backgrounds words, photos, designs to their choice. There are many types of scrapbooks in the market today by a having a digital scrapbook the user can have hundreds of scrap books in one digital scrapbook. There are many companies trying to create digital scrapbooks and they are doing digital images of scrapbook pages and then the user prints them. This embodiment allows the consumer to view the digital images on their own digital scrapbook without printing and it allows them to store them all in one location. The scrapbook software with digital images, editing, photo editing, backgrounds fonts, decorative themes and any kind of scrapbook article, or anything that scrapbooks contain today or any scrapbook feature known today or developed in the future can be in the special software in the unit or a CD can be included when the user buys the digital scrapbook. If the user gets a CD of the digital scrapbooking software of any kind known now or developed in the future, then the user can make and organize scrapbooks on their computer and save them to memory cards to be used in the unit or send them to the unit via interne. The user can name the scrapbook and organize all their scrapbooks on memory cards, the computer or the unit and view them in one location. A 16 GB card could contain hundreds of scrapbooks and then the user can scroll down the file to choose which scrapbook they want to view. The user could store many photos, home videos, scrapbooks and in one digital photo album, digital scrap book and digital book. The convenient storage area for memory cards makes it convenient to stores hundreds of scrapbooks, hundreds of photo albums, hundreds of books in one location. This unit can be a multi purpose unit, where it can be digital photo album, digital book, digital scrapbook, and digital e book all in one. The digital scrapbook can have many designs and can have more than one photo, image or design, or theme. Another embodiment is to have a SD card that cannot be erased. It can record but can't be erased. The digital photo album, digital book, digital e book, digital scrapbook or digital cookbook can have a feature that can make a regular SD card or any type of memory card, or memory to save the data, so it can't be erased. The SD card or any type of memory card can have this feature built-in to the card, so when the user plugs into an electronic card reader or device, it can give the option to the user to make it recordable or non recordable, erasable or non erasable. The digital scrapbook can have any drawing, specification or feature that is described herein. The digital cookbook can have any hinge or cover just like scrapbook, with a window for pictures or names. It can be decorated with bows, items printed or themes and articles designs placed on the cover. The digital photo album can be decorated like a wedding album or baby album, or decorated any way regular photo albums or scrapbooks are decorated, except now it will be a digital photo album or digital scrapbook. Digital scrapbooks or digital photo albums or digital books, or digital e books can have protective cover that covers the exterior cover of the unit. It can be made of any material or plastic see through material or can include graphics. It can be fastened any way possible, stretch elastic material or any way known now or developed in the future. The cover of the digital scrapbook can be permanent or removable, the screen and viewing unit, LCD screen, viewing screen, or digital scrapbook can be attached to a cover or sleeve by any way mentioned in this application or known now or developed in the future. The cover can have a binding like shown in the drawing or drawings in this application or previous applications. The cover can be made of scrapbook covers that are in the market, they can have print on the cover, it can embroidery, silk screen, graphics. The cover can have a window on the front for photos or text or an LCD screen. The text, photos or any item can be inserted from any location on the unit. It can be permanent or removable, so the user can customize their outside cover.

With respect to any digital photo album described herein, the software used can be any type known now for digital photo frames or developed in the future, any type of software for viewing digital photos and videos known now or developed in the future. For example, most digital photo frames and software do not have dual screens or the ability to display photos like a typical photo album on one screen and two screens connected together like a typical photo album without pages. For example, the digital photo album of a one and a two screen model can have typical digital photo frame software, that just allows the user to view full size images and whatever else digital photo frame software is capable of.

Alternatively, a new software solution can be developed and added to any digital photo frame software that includes, any content described in this application, for viewing digital photos and videos. Most digital photo frames are designed for single-screen photo frames, but not for a digital photo album of the likes described herein where a consumer can view photos on one or two screens and view them with the option to view full size images, four photos or any number or size photos on one screen or two or multiple screens. Photos can appear at the same time or be delayed and operate like described in connection with FIGS. 67-69, for example. Or photos can appear at random, any order sequence or any way possible. A menu can appear on the right or left screen in a dual screen digital photo album, which menu can describe the display mode any way possible, but can be like, “Full Size”, and “4 Photos”, any number of photos, or have Thumbnails or any other name or way to describe the items in the menu. Additional features include the ability to rotate photos, adjust contrast and color of photos, and the screen brightness and adjust anything relating to viewing and editing photos, video, music and movies. In addition, most consumers edit, crop, delete, and change color of photos on their computer. Software can be provided to the user, so they can edit photos, arrange photos, add captions, add Multi-Transitional Effects, Zoom-In Detail and Zoom-Out Detail, or create slide shows of the album on their computer. Or the digital photo album can have this software embedded. After consumers edit, arrange photos, add captions, Multi-Transitional Effects, Zoom In Detail and Zoom Out Detail, create slide shows of their digital photos, they save them to a CD, flash drive or memory card or other device.

In one embodiment, a user can view videos or watch movies on this digital photo album any where any place because it's portable. It can have WiFi and other wireless capabilities as described above. The album can also include the ability for a user to check stocks, weather, Internet, web sites, have a calendar, time and date, etc.

The areas where the user touches to operate the unit can be any icon or design known now or developed in the future. The screens can be LCD or any type known or developed in the future. The areas where the inside of the album closes and touches can have rubber or plastic pads molded or snapped together, so the two surfaces don't scratch each other. In addition, it is contemplated to have a built in light for the storage area or for the display screens.

### Typical Operation

The digital photo album is like a book. In one embodiment, the user opens it up, turns the power on. Once the unit is on, then the right screen in a dual-screen embodiment would be the primary screen to view the options for the user. This would be the navigation screen or the desk top like a computer. The user can download pictures to the built-in memory or memory expansion cards via cell phone, computer, laptop, camera or any electronic device. The user can also download pictures to the built-in memory or memory expansion cards via inserting a memory card. The album can have windows that appear on the screen to help the user navigate to make their choices. Once a device or memory card is connected, then an indicator would appear on the screen showing a device is connected, then it can give the user options to download pictures or to view them only. There can be a status bar showing images being transferred, just like a computer does. Most of this process is just like when a user connects a memory card to a computer or laptop, the laptop or computer identifies a connection and gives you options of what you want to do with the pictures. There would be more options like 3″×5″ or 4″×6″, full size, slide show, where it automatically shows photos, but the user would have the option to push previous or the back button or forward etc. In another embodiment as described above, the digital photo album would have one LCD screen on the right inside area, a storage area on the left inside with a possible picture insert area.

The user can connect a device mentioned above or insert a memory card to download images. After the images are downloaded, then the user could be given the option to delete them off the card, camera or any electronic device. Then the user can view images off the device. The user would be given the option to view images without downloading them. The user can open the back cover or where ever the storage area is located and, get a memory card out of the storage area, close the storage door, and insert the memory card into the port opening. Then the unit would sense that there is a memory card attached, then the unit would give the user options to choose. If the device is plugged in like a camera and another memory card is inside a port or all ports are filled with a memory card or cord, then the unit must be capable of showing them on screen, so the user can decide which one to view.

After viewing the user can have the option to close out of those images and once the user closes out, then the user could see what is still available for viewing and what ports are attached and have photos, along with the built in memory choices. After the user doesn't want to view the current photos, there can be an easy way for the user to close out and get back to the main desktop to see what else is available for viewing. The main desktop can contain icons that are generated every time a user downloads images, so the user will see what they can view. There can be a system to identify in number, name or letter sequence the images that are in the built-in memory. Every time the user downloads images, there should be a way that the new images are identified separately. Otherwise every time the user goes to view images they would have to view all images until they get to what they wanted to view. One option is every time they download images, they can identify them using a keypad on the main desktop and scroll up down and select etc. The user can shut the unit off by on screen selection like a computer has, touch screen, touch border or just push the on and off button.

In one embodiment, a unit is designed for viewing digital photos only on a hand held portable device. The user would have more options than a computer or laptop. The album can rotate photos to the right or the left. There can be a smaller version and a bigger version. The smaller version can have 1 or 2-5″×7″ LCD screens and the larger version can have 1 or 2-8″×10″ or 1 or 2-8 1/12″×11″ LCD screens. Other dimensional variations are possible. There is a systematic way for images to fit on the LCD screen; it all depends on the main size of the LCD and the size photos the user wants to view. If the user selects full screen, then the CPU would process the full screen images on the LCD screen provided. The user can decide to choose 3″×5″ or 4″×6″ or the right size that can fit onto the LCD screen appropriately. If the user decides to choose 3×5 or 4×6 then the CPU would generate photos in that size and in the order they are on the built-in memory or memory card. It all depends on the size of the LCD screen. Another factor is whether it is a vertical or horizontal picture, the size of the LCD screen. Horizontal and vertical pictures all determine how many pictures can fit onto the screen. Most people will probably view pictures in full screen because it's a fast and easy and you can see full size pictures which are easy to view everyone and everything in the picture. However when you blow up images to big then it can distort the photos and this is why some people will not like to view all photos bigger than 5×7 all the time. The resolution will play a big factor; if the resolution is good then many big photos still look good. If the user decides to use full size 5×7 or 8×10 and a vertical picture is present, then the sides would crop and show black to compensate for the vertical size. While viewing photos the user can push the previous button, back button or forward button to advance photos. If the user selects slideshow, then it automatically does it for them.

After viewing all photos then the image would go to the beginning of the photos until they exit the photos. Just like viewing pictures on a laptop. There would also be speakers built in (5718; FIG. 57, for example). There would also be a place to plug in a speaker and head phones.

In one embodiment, when photos are generated and arranged by the CPU and if the user chooses full screen, then the 1st photo would appear to the left and the 2nd photo would appear to the right and after they push next, then the 3rd photo would appear to the left and the 4th photo to the right and so forth. If the user picks 4×6 for example and the LCD screen can hold 6-4×6 photos horizontal, then photos 1-6 appear on the left and 7-12 on the right and if the user hit's the next button then the next 6 photos would appear left and the right. If there are vertical pictures, the LCD screen would show vertical and horizontal pictures and it might add up to be 4 photos on the page, then the next images in order would appear on the LCD screen. It's possible to have a LCD screen that can hold 5×7 horizontally and vertically only and an 8×10 horizontally and vertically. Or an LCD screen that holds 5×7 vertically and crops when there's a horizontal picture or a LCD screen that holds a 8×10 vertically and crops when there's a horizontal picture. In another embodiment there would be one LCD screen on the inside right or left and a storage area with possible picture insert on the left or right inside area. In this embodiment, it would work as mentioned in an embodiment described herein, but the images and video would appear on one LCD screen. So, for example, if the user clicks full screen images, then the first image would appear on the screen and when they click next, then the next image would appear. If the user clicks 3×5 or 4×6, then the first 3×5 or 4×6 images would appear on the screen and when they click next then the next images would appear on the same screen and so forth.

### Alternative Typical Operation

In one non-limiting example, for a dual-screen digital photo album embodiment, a user will power on the unit and then the album will play a slide show of pictures, etc., resident in a built-in flash or inserted memory card in full-screen or four-picture mode. This mode can be changed in the preferences or options menu. During the slide show viewing, if it is desired to switch picture modes, then a user simply needs to press the Enter key and will toggle between full-screen and four-picture mode, for example. The Left and Right keys can be used to advance photos forward or backward, and the Up key may be used to pause the slide show and then re-start the slide show out of a pause operation. By pressing a Menu button, a user is able to select options such as Copy, Delete, Rotate, Enlarge, Display Properties, etc., and then pressing Menu again will resume the slide show. If it is desired to listen to music, then the user needs to select Music from a Menu operation or select a Music icon as the case may be, wherein a submenu may pop up with the options of Playing, Album, PlayList, Volume, Folder, etc. Also provided could be a Video menu for selecting and playing videos. The Menu feature also provides the ability to set preferences and settings such as Language, Date/Time, Contrast, Color, Slideshow, etc.

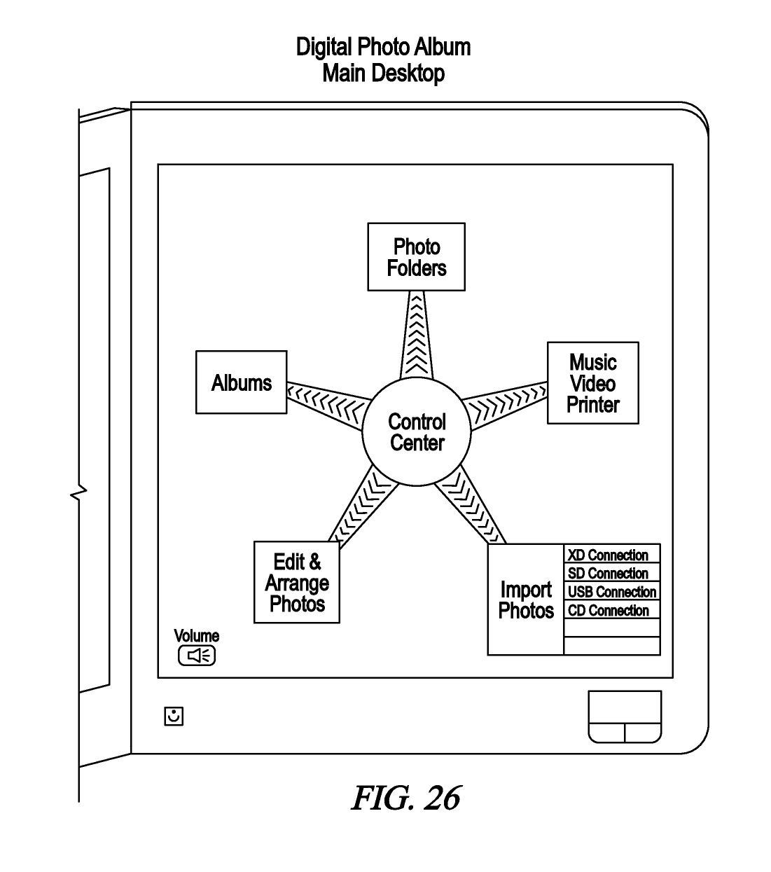

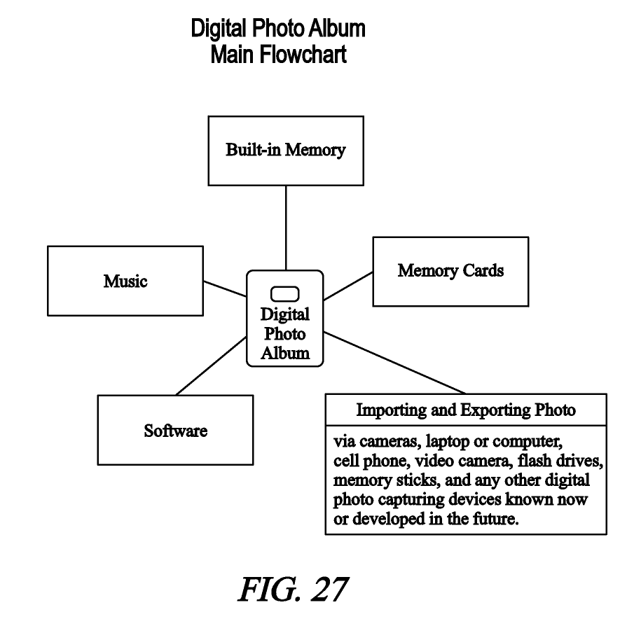

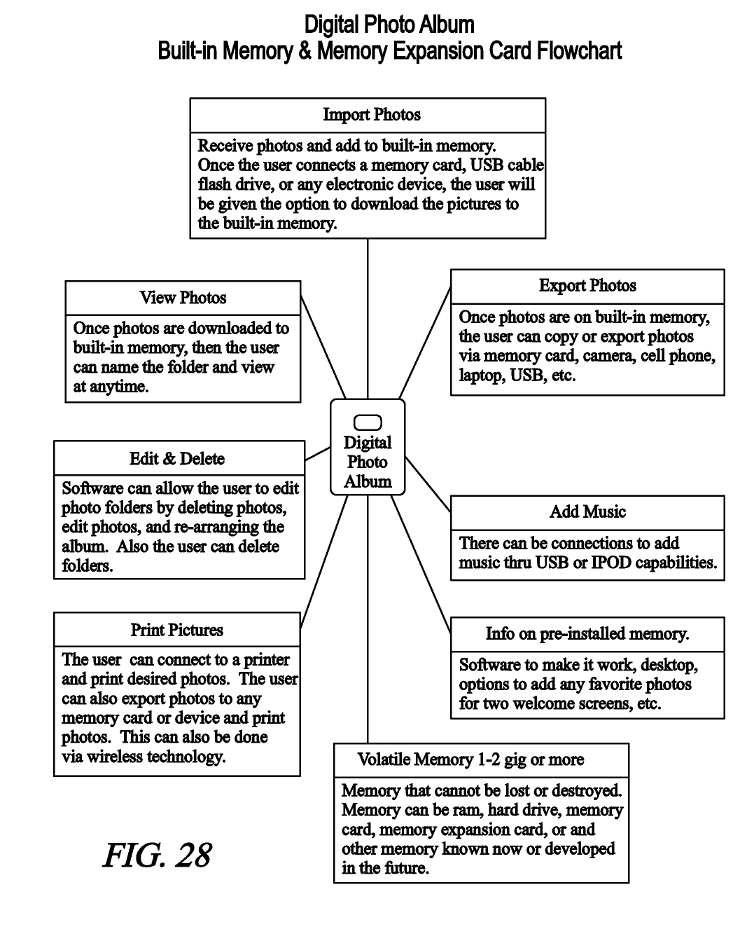

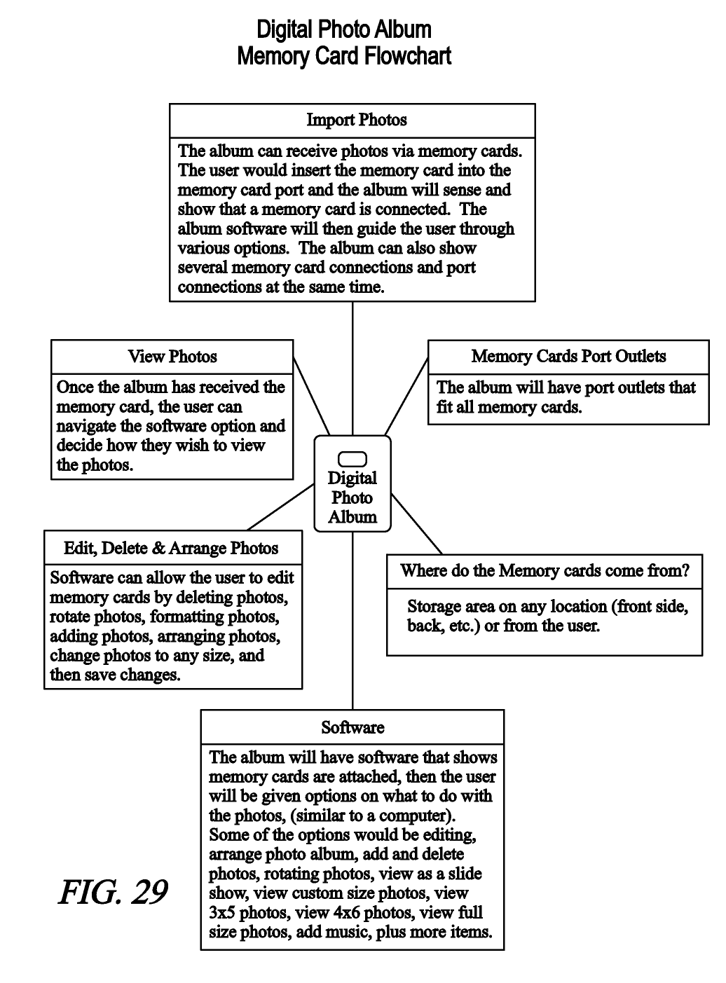

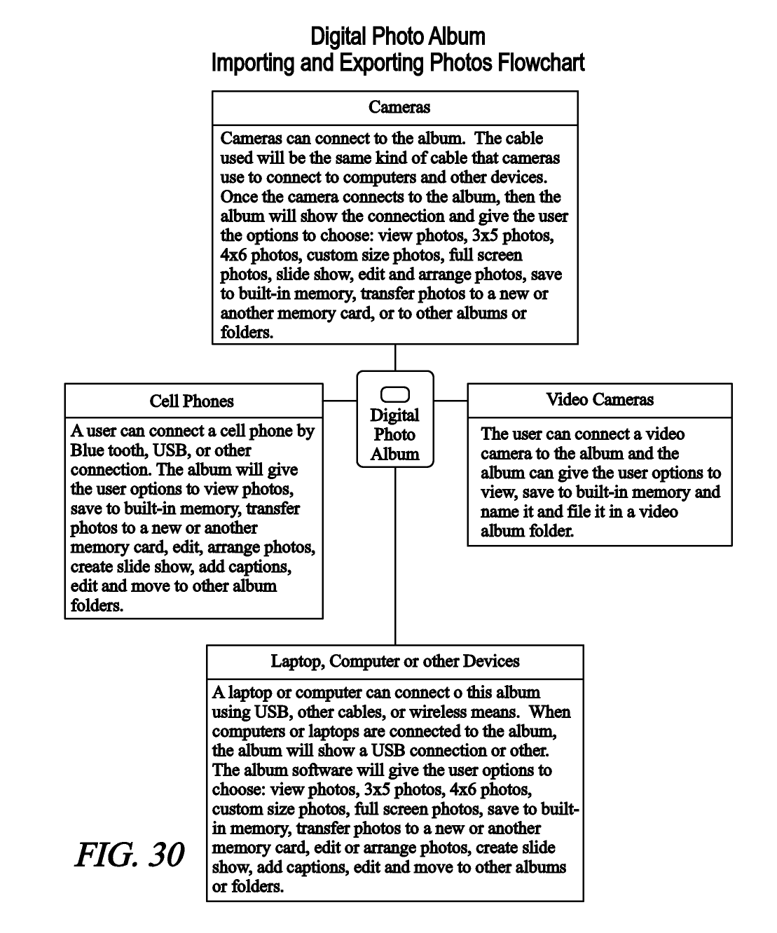

### Possible Screen Window and Functions (FIGS. 26-30)

Any type of window function is available, but the following represents some non-limiting examples.

A main desktop or main screen can be on the left or right LCD screen or just on one screen for the one screen digital photo album version and can have icons, folders or other, any where on the page. For example, as shown in FIG. 26, there can be icons like control panel, Albums, Photo Folders, Edit and Arrange Photos, Import Photos, Music, video, and printer. On the import photo icon, bars could pop up or light up that show port connections, like XD, SD, CD and USB connections. They would light up when there was a connection to these ports. The operation can be made through buttons, touch screen, touch border technology or any way known now or in the future.

One embodiment of a simple version of a digital photo album can be developed where the photo album can view photos when memory cards, USB, or any other port is connected with digital photos. It can have no music capabilities, no video capabilities, and no wireless capabilities. It can have a storage area for memory cards and other digital photo saving devices. The storage area can be located anywhere on the cover or anywhere within the digital photo album. The storage area can be like any way mentioned in this application or what is known today or developed in the future. There can be easy software to view photos. Windows can show view photos and if the user clicks it then the options like view 3×5, view 4×6, view full screen, view slide show. If the user clicks the bar or window of choice, then the CPU will generate these photos as the user requested. The first set of photos would appear on the left LCD screen and the second set of photos would appear on the right LCD screen. Then if the user clicks the next button the third set of photos would appear on the left LCD screen and the fourth set of photos would appear on the right LCD screen and so forth. The user can click previous buttons or forward buttons to move the pages if desired. At the end of the photos, it can return to the beginning photos and the user click the exit button to exit. In another embodiment, a one screen version can be used and the user would be viewing all images and video on one screen. When the user chooses full screen, 3×5, 4×6 or other, then the images would appear on the one screen and when the user clicks next the next set op images would appear on the same screen. The user can click previous buttons or forward buttons to move the pages if desired.

One embodiment of a control center window can have non-limiting folders or icons and their function as follows: Background or set Picture—user can select photo, custom or color backgrounds; Screensaver—user can select screensaver photo or other; Music—if the user clicks this, then it gives the user options to listen or download music; Videos—if the user clicks this it will take them to the video area; Date and Time—the user can select current date and time zones; Memory—if the user clicks this, it can give them how much memory is used and what is available in the built in memory and memory expansion areas. Once the built-in memory area is full and the user wants to download more photos to the expansion ports, then the system will automatically tell the user which port the photos are going to. Every photo album once downloaded will have indicators where they are located. The digital photo album can have memory card or other devices for backing up the built-in memory. In the storage area, there can be a place where these can be placed. The digital photo album software can be designed to remind the user to back-up any time they make changes or any time. This feature is very important, because with any electronic device there is always a chance of failure. And if the user backs up when they should, then the user will have peace of mind knowing all their photos, videos will not be lost.

Other non-limiting control functions can include: Album—takes the user back to the album window or page; Photo Folder—takes the user back to the photo folder window or page; Edit and Arrange—takes the user back to the edit and arrange window or folder; Import Photos—takes the user back to the import photos window or folder, which can have icons, or bars or other like video connection, SD connection, XD connection, USB connection, CD connection, or any known now or developed in the future. When there's a connection to the port, then the bar or icon can light up, flash or any other notifying way. The user can click the icon or bar type connection and then window can give the user options like.

Other non-limiting control functions can include: Home—takes the user back to the home page; View Photos—takes the user to view photos window and it give the user choices on how they would like to view the photos; Save to Album—gives the user options to save and keep photos on built-in memory or make changes and keep all new changes and or photos on a memory card, so it's ready to view later; Save to Photo Folder—takes the user to the photo folder window; Memory—takes the user to the memory window where the user can view how much memory is used and what is available in built-in memory and memory expansion ports.

In addition, when a user clicks the Album window, then it takes the user the album page where all the album folders appear. At the top or anywhere, it can give the user instructions like; Click folder once for options or the user could for example, right click the folder and bars would appear like; Create Album—View as a slide show—View album. Underneath the folders it can have captions explaining what's in the photo folder. Where ever it says right click, left click or double click in this application, there can be any possible way of doing this known now or developed in the future.

When the user clicks or chooses the view or view as a slide show, then the screen changes and all photos that are in the album appear. The first page of photos appears on the left LCD screen and the second page of photos appears on the right LCD screen. When the user clicks next, the third page of photos appears on the left LCD screen and the fourth page of photos appears on the right LCD screen. If the user clicks the back or previous button, then the previous pages appear on the left and right LCD screens. If the user clicks slide show, transitional effects or any type of digital photo viewing, then the photos will automatically start appearing and changes pages every 10 seconds or at a time established by the user in the settings or preferences section of the setup. If the user clicks previous or forward during slide show viewing or other, then the pages will go back or forward. In another embodiment, a one LCD screen version can be used where photos and video would appear on one LCD screen. The next pages and previous and back buttons would allow these pages to appear on the same screen instead of the left and right screen described above.

If the user right clicks any folder, then in one embodiment the user will have the option to see and click the following non-limiting options; Create Album, Edit and Arrange, Import Photos, Export Photos, Send To, Add Photos from Photo Folders, Multi-Transitional Effects, Zoom in Detail and Zoom out Detail, or other. If the user clicks the Create Album, then all pictures appear on the screen and instructions at the top can say, for example, first step arrange photos, second step edit photos, third step save photos, and fourth step finish. A user can also click a music icon or in the tool bar for easy access to music.

If the user clicks albums or photo folders, then either all album folders would appear or all photo folders would appear below. With respect to the Folders option, the digital photo album software can allow the user to name the folders, so the user can identify what's inside the folder, like “2008 Vacation.” Then if the user clicks the album or photo folder, it would open up and all photos would appear at the top of the screen. If the user right clicks any folder options like arrange photos, create slide show, send to my photos, any location or export photo, a particular folder, delete, create album etc. If the user clicks the folder once or twice all photos would appear on the page or screen. Above the photos or anywhere, there can be options like arrange photos, edit photos, create slide show Multi-Transitional Effects, Zoom in Detail and Zoom out Detail. If the user clicks the arrange photos, the user could move photos by click and drag to the desired locations. If the user right clicks any photo, the user will have the option to delete photo, rotate left, rotate right, make custom size photos, make 3×5 photos, make 4×6 photos, add or delete captions, make full size photo, Multi-Transitional Effects, Zoom In Detail and Zoom Out Detail. Send To; my photos, any location or export photo, to a particular folder.

If the user selects or clicks create album, the all photos would appear on the page or screen. The primary screen can be the right or left screen, or one screen in the one screen version. The first step would show arrange photos and click and drag photos to arrange in desired locations. Second step, right click photo to delete photo, rotate left, rotate right, make custom size photos, make 3×5 photo, make 4×6 photo, add or delete captions, make full size photo, Multi-Transitional Effects, Zoom In Detail and Zoom Out Detail, Send To; my photos, any location or export photo, to a particular folder, third step click finish, create or done.

The user can click View Photos or View as a Slide Show and the user view photos or view as a slide show and the first set of photos would appear on the left LCD screen and the second set of photos would appear on the right LCD. If the user double clicks the photo folder or the album folder it can automatically open all photos in the folder. If the user right clicks any folder it will give the user options like arrange photos, create slide show, send to my photos, any location or export photo, to a particular folder, delete, create album, Multi-Transitional Effects, Zoom In Detail and Zoom Out Detail, etc. In a one LCD screen version, the first set of photos would appear on the one screen and when they click next, and then the second set would appear on the same screen and so forth. If the user wants to send a photo folder to a particular place like an album, the user can have a screen or window pop up. When the user clicks the bar it can say, “Look In:” and then the user can seek a particular album that they would like to send the photos to. If the user selects Send To, then a bar can show up and the user can have an option to send it SD port, XD port, USB, or other. A screen can show that pictures are ready for export and if the user clicks it, then the user can have instructions to transfer the photo or folders to the port of their choosing. Every window can have icons or just spelling of the window pages and if the user clicks it, then it will take them to that page, just like web site pages operate.

There can be a video memory card, or any type of video capturing device known now or developed in the future that is permanent or removable in the digital photo album. The videos can be saved in the built-in memory or just view only and can be transferred in and out of the photo album or on to memory cards, devices or video cameras. When there's a video connection a bar or icon can, for example, light up NEW VIDEO CONNECTION. Once the user clicks on this bar then the option or bars might appear like; SAVE TO VIDEO FOLDER (If the user clicks this folder, it will give the option to name it), OR OPEN AND VIEW VIDEO ONLY (After viewing, it can give the user options to save to the video folder, if not it will not erase the video from the camcorder or any device where it was connected to the album.). Below this area, there can be all the video folders with captions describing the folder. If the user clicks VIEW VIDEO ONLY, then the video will start playing on the right side (Can have options to choose right or left LCD screen). After the video is finished a window will show up asking to save to video folder or to disconnect. The user can have the option to view one photo, slide show, or album on the left LCD screen while viewing a video on the right LCD screen. One display/LCD screen version can have a small window and can play video and have pictures on the bigger window of the screen or vice versus. If the user clicks the video folder, then it will give the option or a bar will pop up or appear that can show View Video or Send To. If the user right clicks the folder then it can show Send To, Export, Add or delete captions.

Music Window. When a device like an iPod is attached a window can appear or a flashing area in the tool bar indicating a new music connection. If the user clicks on this, then the digital photo album can start playing music or a bar or option can appear like Add to Music Folder or Listen Only. If the user clicks on a music folder, then the user can play their favorite songs. The digital photo album can have iPod capabilities like the typical iPod stands or platforms and the user can listen thru the built-in speakers. The user can also listen to music thru an ear piece plugged into the ear piece port. For easy access to music, there can be an icon for music in the tool bar or any where out of the way so the user can control volume and choose their favorite music.

The digital photo album as described herein should be compatible with all type of memory cards like Compact Flash, CF-Type 1, CF-Type II, CF-Ultra II, Microdrive, SD, SD-Ultra, SDHC, SDC, mini SD, MMC, HS-MMC, RS-MMC, Memory Sticks, MS, MS(MG), MS-Pro, HS-MS-Pro, MS DUO, MS-Pro Duo, HS-MS-Pro Duo, SM, XD, T-Flash, any type known now or developed in the future and the like. Furthermore, it should be compatible with JPG, TIF, GIF, AVI, MPEG-1, MPEG-2, MPEG-4, Files and MP3 or WMA music files and any known now or developed in the future. Yet it should also compatible with Apple, Windows 2000, Windows XP, Vista Windows CE, Linux system, and any other operating or window type system or software, computer software, digital photo software, digital photo viewing software known now or developed in the future.

The digital photo album may have pre programmed or pre installed sales pictures, sales video or instructional materials. This would be designed for in store sales and marketing, where the digital photo album would be open and placed on a shelf, counter or anywhere so the viewer or potential customer can see how the digital photo album works. It may also have a digital user agreement which needs to be read and accepted by the user before using.

While the present invention has been described at some length and with some particularity with respect to the several described embodiments, it is not intended that it should be limited to any such particulars or embodiments or any particular embodiment, but it is to be construed so as to provide the broadest possible interpretation in view of the prior art and, therefore, to effectively encompass the intended scope of the invention. Any design can be used along with any type of storage area, any type of screens, any type of function, any type of software having to do with viewing digital photos, known now or developed in the future. Furthermore, the foregoing describes the invention in terms of embodiments foreseen by the inventor for which an enabling description was available, notwithstanding that insubstantial modifications of the invention, not presently foreseen, may nonetheless represent equivalents thereto

I claim:

1. A digital album/book/e book/reader comprising:
a) a first cover attached to a first component having a gap, a second cover attached to a second component, and binding attached to the first and second covers; and
b) a third cover for covering at least a portion of the gap;
c) wherein when the second component is moved from the closed position to the open position, a portion of the second cover engages the gap in the first component.

2. The digital album/book/e book/reader of claim 1, wherein the binding is a scrapbook-type binding.

3. The digital album/book/e book/reader of claim 1, further comprising a pocket in each of the first and second covers for receiving a portion of the binding.

4. The digital album/book/e book/reader of claim 3, wherein the portion of the binding received in each pocket is movable within such pocket.

5. The digital album/book/e book/reader of claim 1, wherein the binding is an old-style binding.

6. The digital album/book/e book/reader of claim 1, wherein the third cover is an extension of the first component.

7. The digital album/book/e book/reader of claim 1, further comprising a charging station.

8. The digital album/book/e book/reader of claim 7, wherein the charging station further comprises a communication feature.

9. The digital album/book/e book/reader of claim 7, wherein the charging station further comprises a plurality of interfaces for interfacing with a plurality of digital album/book/e book/readers.

10. A charging station for a digital album/book/e book/reader comprising a power system, a communication system and at least one interface for connecting to a digital album/book/e book/reader.

11. The charging station for a digital album/book/e book/reader of claim 10, further comprising a plurality of interfaces.

12. The charging station for a digital album/book/e book/reader of claim 11, further comprising a plurality of boundaries for forming a shelf-type charging station.

13. A digital device comprising a display, a communication system, one or more inputs, a storage and a cover.

14. The digital device of claim 13, wherein the digital device is an electronic menu.

15. The digital device of claim 13, wherein the digital device is an electronic greeting card.

16. The digital device of claim 13, wherein the digital device is an electronic scrapbook.

17. The digital device of claim 13, wherein the digital device is an electronic cookbook.

18. The digital device of claim 13, wherein the storage is a removable flash drive.

19. The digital device of claim 18, wherein the removable flash drive includes a decorative cover.

20. The digital device of claim 13, further comprising at least one display and a protective covering for the display.
